(19) United States
(12) Patent Application Publication
(10) Pub. No.: US 2015/0209679 A1
(43) Pub. Date: Jul. 30, 2015

(54) SYSTEMS AND METHODS FOR CONDUCTING FANTASY SPORTS TOURNAMENTS

(71) Applicant: Philip Paul Givant, Carmichael, CA (US)

(72) Inventor: Philip Paul Givant, Carmichael, CA (US)

(21) Appl. No.: 14/684,160

(22) Filed: Apr. 10, 2015

Related U.S. Application Data
(63) Continuation-in-part of application No. 13/945,628, filed on Jul. 18, 2013.
(60) Provisional application No. 61/741,463, filed on Jul. 19, 2012.

(51) Int. Cl. A63F 13/828; A63F 13/75; A63F 13/792

(52) U.S. Cl. CPC A63F 13/828; A63F 13/792; A63F 13/75

(57) ABSTRACT

Systems and methods for conducting fantasy sports tournaments are disclosed. A particular embodiment includes at least four key features that should be in the same tournament structure to produce an effective tournament. These features include the following: 1) entry fees must be a nominal (e.g., low cost, low risk for the consumer) cost to the consumer so the masses can afford to play; 2) the grand prize must be a multi-million dollar offering so the masses will enthusiastically desire to play; 3) participants must not be subjected to playing the entire field at the same time to discourage the masses (i.e., the tournament must be skill based); and 4) there must be a re-entry component that allows fantasy players an option to continue getting back into the tournament for as long as possible.

### REFERENCE TO PRIORITY PATENT APPLICATIONS

The present application is a non-provisional continuation-in-part patent application of pending application Ser. No. 13/945,628, filed on Jul. 18, 2013; which is a non-provisional patent application of Ser. No. 61/741,463, filed on Jul. 19, 2012. The present non-provisional continuation-in-part patent application claims priority to the referenced patent applications, which are hereby incorporated by reference herein in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2012-2015, Philip Paul Givant, All Rights Reserved.

### TECHNICAL FIELD

This patent application relates to computer-implemented software, networked systems, and gaming systems according to one embodiment, and more specifically to systems and methods for conducting fantasy sports tournaments.

### BACKGROUND

As popular as fantasy sports has been over the last decade, there has been a huge void that nobody has been able to fill. Fantasy sports tournaments have never been able to create a process where an unlimited number of people can play without creating a lottery type of effect. A lottery effect is the very undesirable result of having so many fantasy players entered in a tournament that there is no longer enough room to have them play each other in head-to-head matchups. Unfortunately, the solution for tournaments with these types of spacing issues has always been to force the entire field to compete against each other simultaneously. This is never a good thing and is very discouraging for the competitors.

There are only two general formats available on the market for participating in fantasy tournaments. Within each tournament structure there are often different variables, but when they are stripped down to their bare essence, it comes down to two options. One of them creates the aforementioned lottery effect while the other does everything possible to avoid it. The one that avoids the lottery effect creates its own set of problems unique to itself. As far as tournament play is concerned, neither is a viable way for an unlimited number of players to enter without having to play the entire field at the same time. Some of the features of these two tournament paradigms along with some of their limitations are described below.

### Format #1—Head-to-Head

Fantasy players are matched up against a single opponent to compete against for a given round. The fantasy player whose athletes score more combined fantasy points are declared the winner and their opponent is declared the loser. The won/lost records of these fantasy players are recorded. The better records receive special recognition. Duplication of athletes is not permitted in these tournaments. Often, leagues are actually built within the tournament structure. Fantasy players are allowed to remain in the tournament for quite some time even if they happen to be performing poorly. There is a selection process in place where fantasy players either bid on or draft athletes. Lineups are submitted from a very limited and well defined pool of athletes. They consist of athletes that a fantasy player has on their roster that they either drafted or bid on.

### Head-to-Head Format Limitations

There are limits to the number of fantasy players that can play in these types of tournaments because of spacing issues. In other words, there are a finite number of slots available to allow people to consistently play head-to-head with each other over a relatively short season. When limits are placed on the number of people that can play, it triggers a very bad combination of events if the intent is to offer a monetary prize. The head-to-head format limits the amount of prize money that can be given out. This is because there aren't enough people paying an entry fee to support a large prize money pool. Compounding the problem is the high pricing strategy for entry fees which is often used to compensate for the limited number of fantasy players that are able to compete. This is done to create a larger pool for the prize money, but this strategy prices most fantasy sports enthusiasts out of participating.

### Format #2—Lottery Effect

Some tournament formats operate as a lottery style tournament because the format mirrors what a lottery does. For example, millions of people can select the number “3” in a lottery and share that number. But, the number is meaningless unless that number is selected as one of the winning numbers and the other five or six numbers that the lottery player has are also selected as winning numbers. The same thing happens with fantasy sports lottery tournaments. Three million people might have the highest scoring athlete for a given day, week or month, but how many of them have that in combination with the next five or six highest scoring athletes? This is a very unlikely combination to have and is why this style of play mimics a lottery. The lottery effect format requires hundreds, thousands or even an unlimited number of entries to play each other simultaneously. Duplication of athletes is permitted because there aren't enough athletes to go around. This is the only way millions can play each other simultaneously. Tournaments are usually structured so that running point totals of fantasy players are compared on an ongoing basis. The goal is to have the highest running point total possible in the event that hundreds to millions of fantasy players are all competing against each other. Tournament structure always forces fantasy players to compete against the entire field. Sometimes it is for one day and sometimes it is for the whole season and sometimes it is something in between. Cumulative running point total separates the fantasy players rather than a won/lost record like with the head-to-head format. The top cumulative point scorers receive special recognition. Lineups are submitted from the entire pool of available athletes with little to no restrictions.

### Lottery Effect Format Limitations

Fantasy players compete against the entire field simultaneously. Tournament format not conducive to charging an entry fee, although some do, because fantasy players are not optimistic they can beat out hundreds to millions of players at the same time for the high score. Generally considered an inferior format to the match play method because it is nothing more than an accumulated points system over a day, week, month or entire season and forces fantasy players to compete against the entire field at the same time.

Not all fantasy tournaments have every feature described in the two formats above. However, all of them though have enough of them in combination with one another to create insurmountable roadblocks for the type of tournament the applicant believes is needed to fill the hole in the industry. The only way around them is to seek non-traditional solutions. Ultimately, the goal is to create a vehicle so that an unlimited number of fantasy players can participate, without having to play the entire field simultaneously. Again, there isn't a single format currently in existence on the market that allows this to happen. The reason for this is that there are several non-obvious features that are required to make this happen.

The primary tournaments that have either been or are currently on the market are described below. In 2004, Payday Sports offered a million dollar prize to the winner of their fantasy football tournament. The entry fee was $3,600. Analysis—The tournament failed because even though the prize money was appropriate and the competitors weren't forced to play the entire field simultaneously, the entry fee was not conducive to attracting the masses.

In 2004, the Million Dollar Fantasy League held a fantasy football tournament that offered a one million dollar grand prize. The entry fee was $2,600. Analysis—This tournament failed for the same reason the Payday sports one did. The prize money was good, they also got it right by not forcing competitors to compete against the entire field, but once again, the entry fee was way too high.

In 2008, Fanball held a million dollar fantasy football tournament where the entry fee was $125. It failed in the second year because they were unable to pay the prize money. This tournament was a much better attempt at creating an entry fee that was conducive to attract the masses, but it still wasn't low enough. Consequently, it fared no better than the others because the price was still way too high for the average player and the tournament format was so structurally flawed they couldn't go any lower. Their primary issue was that they didn't have an understanding of how to create enough space for more fantasy players to enter. This became quite apparent by their use of a league format. Instead of eliminating poor performers to make room for more entries, they allowed them to remain in the tournament. The ramifications for doing it this way (along with some other strategic mistakes) resulted in the fact that they could not go any lower on the entry fee without making all the competitors compete against the entire field simultaneously. The bottom line is that even though Fanball tried entry fees that were significantly lower than previous attempts, their faulty methodology still forced them to keep them too high to attract the masses. More importantly, even if they had been able to attract the masses with their better pricing, they still didn't have a system in place to accommodate that many entries without offering a Lottery Effect format. The Fanball fiasco is one example of why the solutions to create an effective tournament format are not obvious.

FanDuel has been hosting a tournament for two years that they hope will eventually pay the winner one million dollars (in 2012 the winner received $150,000). Their entry fee is either $10 or $109. Analysis—FanDuel is a good illustration of how big money fantasy sports tournaments struggle with trying to avoid the Lottery Effect while at the same time trying to offer a big money grand prize. What they have created is a paradigm that offers two types of qualifying tournaments for a chance to compete in a 24 person tournament that crowns the winner with $150,000. For the $109 qualifier, they limit it to 250 people each week that it is run. For the $10 qualifier they cap it at just over 2,000 entries. The intent is to minimize the Lottery Effect by capping the number of people who can participate, but it is still creates a Lottery Effect when you have to be the best score in a large field to qualify. Moreover, the prize money to the winner is compromised and can never be in the multi-millions of dollars because they are creating caps for the number of people that can enter. The FanDuel format is a good example to illustrate the problem that currently exists. Nobody has been able to figure out how to offer the multi-million dollar grand prize without forcing contestants to simultaneously play millions of people. FanDuel clearly is trying to address the issue, but because of their flawed strategies in creating their format, they offer BOTH the Lottery Effect and a less than desirable grand prize in their offering.

The National Fantasy Football Championship Primetime (NFFCP) is offering a $150,000 grand prize for the 2012 NFL season. Their entry fee is $1,500. Analysis—The prize money is not in the millions and the entry fee is way too high to attract the masses. The format limits the number of entries, because they haven't developed a tournament format that allows a large number of fantasy players to compete.

The National Fantasy Football Championship Classic (NFFCC) is offering a $75,000 grand prize for the 2012 NFL season. Their entry fee is $1,500. Analysis—The prize money is not in the millions and the entry fee is way too high to attract the masses. The format limits the number of entries, because they haven't developed a tournament format that allows a large number of fantasy players to compete.

The Fantasy Football Players Championship (FFPC) is offering a $200,000 grand prize for the 2012 NFL season. Their entry fee is $1,600. Analysis—The prize money is not in the millions and the entry fee is way too high to attract the masses. The format limits the number of entries, because they haven't developed a tournament format that allows a large number of fantasy players to compete.

The World Championship of Fantasy Football (WCFF) is offering a $200,000 grand prize for the 2012 NFL season. Their entry fee is $1,575. Analysis—The prize money is not in the millions and the entry fee is way too high to attract the masses. The format limits the number of entries, because they haven't developed a tournament format that allows a large number of fantasy players to compete.

### SUMMARY

In various embodiments described herein, systems and methods for conducting fantasy sports tournaments via a computer system and/or a data network are disclosed. In general, this patent application relates to computer or network implemented fantasy sports tournaments. Fantasy sports is a competitive gaming structure where participants pick real life professional or amateur athletes to fill out a personalized team. They then use this lineup that they picked to compete against teams selected by other fantasy players by comparing the accumulated statistics earned of their respective athletes. This patent application describes various embodiments of computer and network implemented systems and processes providing a tournament structure for fantasy sports that has never been on the market. One reason it hasn't been available before is because the systems and methods that it uses are counter-intuitive to what fantasy players are accustomed. At the same time, these new strategies address a tremendous need in the industry.

In various example embodiments, the computer or network implemented fantasy sports tournament system as described herein can be in data network communication with a plurality of user platforms. The user platforms can be client computing devices, mobile computing devices, mobile communication devices, or the like operated by tournament contestants or administrators. A host site or server can be used to execute the software and systems implementing the tournament structure as described herein. As such, the host site and the networked system become a special purpose computing platform particularly configured to support the computer or network implemented fantasy sports tournament system as described herein. The host site and the user platforms may communicate and transfer data and information in a data network environment via a wide area data network (e.g., the Internet). Various components of the host site can also communicate internally via a conventional intranet or local area network (LAN).

In the example embodiments, the computer or network implemented fantasy sports tournament system as described herein can be in data network communication with a plurality of contestants and other network resources. Contestants can represent the network locations of clients or client computing systems being managed by contestants, teams, tournament players, or other client users operating an embodiment as described herein. As described in more detail below, contestants or other users at a user platform can interact with a computer-generated user interface provided by the fantasy sports tournament system to participate in and communicate with the fantasy sports tournament system.

### DEFINITION OF TERMS

Athlete—A professional or amateur athlete that is selected from a real life sports team to represent a fantasy player's team for a fantasy game.

Actual Fantasy Points—The fantasy points an athlete accumulates from their real life athletic competition.

Adjusted Fantasy Points—A process for deducting or increasing an athlete's fantasy points based on potential bonuses and deductions.

Blind Submission Process—A process where fantasy players attempt to secure athletes for their fantasy teams by putting in their requests without knowing what their opponents requested.

Bonus Fantasy Points—Additional fantasy points that are awarded up and beyond what an athlete actually scores in their real life athletic competition. This happens when multipliers are introduced for prioritizing a given athlete over others.

Caps—The process of creating an upper bound (it can be extremely high) for the number of fantasy players that can participate in a given qualifying tournament. It is essential to coordinate the upper bounds of all the qualifying tournaments with each other so that the fixed number of seats in the Main Event tournament is not exceeded.

Contingency Lineup—When a fantasy player is required to submit a second lineup (or possibly more) from games later in the day. This second lineup is contingent upon them advancing from proceedings that happened using the first lineup (or prior lineup). The reason a contingency lineup is needed is because there is not enough time to submit a new lineup after the fantasy player advanced to the next round.

Draft Room—Place where fantasy players get together to draft athletes. This concept can be extended to a virtual draft room where fantasy players “meet” via the Internet and select athletes using their computers.

Duplication of Athletes—Occurs when two or more fantasy players select the same athlete via a blind submission process for their respective lineups.

Entry—Refers to a fantasy player that signs up to play in a fantasy sports tournament.

Fantasy Game—A game with rules that is played between two or more fantasy players to see who accumulates the better fantasy score from accumulated statistics of athletes from live sporting events.

Fantasy Player—A person that enjoys playing fantasy sports games.

Fantasy Points—What an athlete accrues based on performing positive actions in their real life athletic competition.

Fantasy Tournament—A tournament format where fantasy players compete against each other to see who emerges as the winner.

Group—Three or more fantasy players placed together to compete against each other at the same time for a given match.

Group Play—This format is used for tournaments with groups of three or more fantasy players competing against each other at the same time. A predetermined number of top finishers advance to the next round for each group involved.

Head-to-Head Method—When two fantasy players are paired against each other in a fantasy match. This is one of the two formats that is currently used in tournament play. The other is the lottery style of play.

Holy Grail Tournament—The applicant's ideal fantasy sports tournament that is currently not on the market. The format has three primary components in it that are required to appeal to the masses. First, the entry fees are nominal to make it affordable to the masses. Secondly, the grand prize is in the millions of dollars to attract the masses. Finally, the tournament format does not require fantasy players to simultaneously play against the entire field. No fantasy sports tournament has ever been introduced to the market with at least these three important features.

League—Where eight (usually no less) to twenty (usually no more) fantasy players form a league and select athletes to compete against each other in head-to head matches. Won/Lost records are recorded and the better records are rewarded at the end of the season by making the playoffs and competing for the championship.

League Format—Fantasy tournaments that run leagues within a tournament structure.

Lineup Submissions—The process where fantasy players submit the names of the athletes that they want to represent them for a fantasy match. This process can either be a one time submission or happen over several rounds of submissions.

Locked In—A term that is used to represent an athlete has been submitted and accepted into the lineup of a fantasy player competing in a head-to-head match.

Lottery Method—Tournament format where fantasy players are required to compete against the entire field simultaneously. This is one of the two formats that is currently used in tournament play. The other is the head-to-head style of play.

Main Tournament—This is the portion of a Holy Grail tournament where the qualifying tournament winners meet to determine an overall champion.

Penalties for Duplication—Point penalties that occur when the same athlete is selected by two or more fantasy players during a blind submission process.

Percentage Multiplier—A number that represents the fraction of fantasy points that a fantasy player receives from their athlete's actual fantasy score based on duplication rules that are in place. This number is multiplied by an athlete's fantasy points to recalibrate their fantasy point total to give them their adjusted fantasy point total.

Qualifying Tournament—A tournament that is held to qualify fantasy players for the Main Event tournament.

Re-entry Format—A type of Holy Grail tournament format that allows fantasy players that are eliminated in a given round to buy back into the tournament. This can be done in four different ways: Players can either 1) immediately advance to the next round as if they weren't eliminated; 2) return back to the round that they were eliminated; 3) start over again in the same round they originally entered; or 4) completely re-enter under a different round structure.

RINGS—RINGS is an acronym for, “Rounds Involving Narrow Group Size”. The term and the related concepts as described herein can be used in fantasy sports tournaments of various embodiments and involve using small groups of fantasy contestants competing over two or more rounds of play.

Seats—The number of fantasy players that can play in the tournament before it is filled up.

Serpentine Draft Format—A drafting format that snakes back up from bottom to top once everyone has drafted. This is used instead of starting back up at the beginning again. For example, if four people are drafting, then the drafting order would be player A, player B, player C, player D, player D (again), player C, player B, player A, player A (again), player B, etc. This is not a new concept to the fantasy sports industry.

Single Round Elimination Tournament—A tournament structure where fantasy players are eliminated once they lose a round.

Slotted position—The ranking or priority a fantasy player gives a given athlete for their lineup. This procedure is used for tournaments where fantasy players are asked to list the athletes they covet in order of preference.

Spacing Problems—Happens when there aren't enough paths that have been created to allow unlimited numbers of fantasy players into a tournament. If the spacing problems are too severe, tournaments are forced to operate using lottery effect rules where all the fantasy players have to compete against each other simultaneously.

Super Wild Card Format—A format for conducting a fantasy sports tournament where more than one round is needed for a given live real world athletic competition or group of competitions that are running concurrently. This is not to be confused with a Wildcard Format where more than one round is needed during the same day.

Weighting Athletes—A process for giving additional or higher fantasy point values to athletes that are slotted higher.

Wildcard Format—A format for conducting a fantasy sports tournament where more than one round is needed for a given day. This is not to be confused with a Super Wildcard Format where more than one round is needed during the same game (or games running concurrently).

There are several reasons why the lottery effect continues to occur for tournaments that don't limit the number of entries. Primarily, it is because of the strong sentiment for keeping with tradition. Fantasy tournament organizers are reluctant to alter the format of the way the game has traditionally been played. This mindset has definitely helped preserve tradition, but it has come at a price. It has stifled creativity.

Tournament organizers have not been able to identify at least four key characteristics required for a Holy Grail type of fantasy sports tournament. The reason for this is because in order to develop this type of tournament, there are several non-obvious solutions for the features that have to be implemented. This is a two-step process that makes it even more non-obvious for someone to figure out. First, it is necessary to minimally identify what these four features are and then, just as importantly, provide solutions so that these features can all appear together in the same tournament—solutions that must incorporate outside-the-box thinking or the task becomes unwieldy. The various embodiments as described herein provide these features and solutions.

There are at least four key features that should be in the same tournament structure to produce an effective tournament. These features include the following: 1) entry fees must be a nominal (e.g., low cost, low risk for the consumer) cost to the consumer so the masses can afford to play; 2) the grand prize must be a multi-million dollar grand prize (it has to be life-changing money where the winner minimally becomes a millionaire after taxes) so the masses will enthusiastically desire to play; 3) participants must not be subjected to playing the entire field or large numbers of contestants at the same time to discourage the masses—skill must always be a factor in the tournament; and 4) there must be a re-entry component that allows fantasy players an option to continue getting back into the tournament for as long as possible.

Low entry fee—A tournament with a large prize pool must attract the masses or it is doomed. Tournament organizers would much rather have 5 million people pay $1 and generate 5 million dollars as opposed to 50,000 people paying $100 and generating 5 million dollars. There is a much higher probability that more people will pay a lower cost buy-in. The key concept here is that a low risk entry point for the consumer, especially for a chance at a high reward like a multi-million dollar prize, is always more successful than a high risk entry point even if the reward is something much higher like 10 million dollars. In an example embodiment, the low risk entry point for the consumer can be considered to be a buy-in of less than or equal to $50 per fantasy player or per entry. In another example embodiment, the low risk entry point for the consumer can be considered to be a buy-in of less than or equal to $5 per fantasy player or per entry.

A Multi-Million dollar Grand Prize—A multi-million dollar grand prize guarantees that the winner will have tremendous incentive to play—especially since the buy-in cost is so low. This type of opportunity creates a frenzied climate where people start believing they have to get into the tournament, especially if the risk is low as provided by the low cost buy-in of the first element of the tournament format described herein.

Group Play—Tournaments that enable fantasy players of a fantasy sports tournament to be partitioned into a plurality of player groups thereby enabling competition in small groups where fantasy players are allowed to advance to the next round create more entries and more value, because contestants have the belief they have a chance to advance to the next round. Conversely, forcing fantasy players to simultaneously beat the entire field (which could be millions of people) is suffocating, because people won't believe they can advance so they won't enter. This is deadly for a tournament that has to cover a multi-million dollar prize pool with low cost (e.g., $5) entries.

Re-Entry Component—The only way that a tournament that charges low cost (e.g., $5) entry fees for a chance to win a multi-million dollar grand prize can be successful is if people continue to circulate back into the tournament if they get knocked out. People are much more willing to spend $200 on tournament entry fees if the fees are paid in increments of $5 and $10 dollars over a two or three month time span as opposed to a one time up-front payment. If there is no re-entry component, a potential $200 customer only gets one chance to spend $5. This is a recipe to render a high stakes fantasy sports tournament insolvent very quickly.

In the various embodiments described herein, a re-entry component only has meaning when a tournament has a progression of rounds so that players can either immediately advance to the next round as if they weren't eliminated, return back to the round that they were eliminated, start over again in the same position they originally entered or completely re-enter under a different round structure. The FanDuel tournament is a good example to illustrate what is NOT a re-entry format. FanDuel has 24 different one round qualifying tournaments that they use for people to get into their Main Event. This would not be considered a re-entry type of tournament because it doesn't have a progression of rounds.

Creating a Spacing Mechanism—The inability to create a spacing mechanism that allows millions of people to play in a fantasy sports tournament while not subjecting them to a Lottery Effect has been a significant roadblock to holding an effective tournament for the fantasy sports industry. The embodiments described herein create a spacing mechanism that now makes it possible to hold fantasy sports tournaments where people can enter for a low cost entry fee (e.g., under $100 or even less than $5) and win a high value (e.g., multi-million dollar) grand prize. There are two important features that the embodiments described herein provide to allow this spacing to happen in a sports fantasy tournament. These features are: 1) group play within a tournament, and 2) advancing instead of winning. These features are described below.

The feature of group play within a tournament—No other fantasy sports tournament in existence uses group play (as a matter of fact, group play doesn't exist for any fantasy sports contests—tournament or no tournament). Yet, group play is the only way to create the spacing that allows a low entry fee while at the same time not forcing fantasy players to compete against the entire field simultaneously. The reason for this is that group play allows tournament organizers to create ratios other than the standard 2:1 ratio where one person advances per two people playing. Nobody has ever introduced a group play format for fantasy tournaments.

The feature of advancing instead of winning—Meeting a minimum threshold to advance (as opposed to having to win to advance) is an important feature that no other tournament format uses to create the right ratios for spacing. Group play allows participants the opportunity to advance without necessarily having to win to move on in a tournament. For example, a group of 12 can permit the top 3 players to advance.

A high stakes fantasy sports tournament involving millions of players cannot operate using a traditional draft. It simply takes too long which is lethal for what is needed to make the tournament successful. Long drawn out drafts means fantasy players won't have the time to purchase multiple entries. Multiple entries are an important element to support this type of tournament format. There is no way a tournament that charges a nominal entry fee and awards a multi-million dollar grand prize can survive unless a large number of players are buying multiple entries. This makes it important to eliminate traditional drafts. The high stakes fantasy sports tournament format described herein can eliminate the need for a traditional draft. There are five features listed below that are employed in various embodiments described herein to eliminate traditional drafts. Each of these features involve a blind submission process where the participants in a group or match play event don't know what their opponents have submitted

Duplication Penalties Feature—In an example embodiment, fantasy players are penalized points (e.g., the players' point totals are reduced) from their athletes' actual fantasy points earned based on how many other fantasy players in their group selected that athlete. For example, if a fantasy player is the only one to select a particular athlete, that fantasy player gets the particular athlete at 100% of the athlete's fantasy point value. However, if three other fantasy players in the group also submit/select that particular athlete, the three other fantasy players in the group would all get that particular athlete for their lineup, but each of the three fantasy players may only get 75% (or some other percentage less that 100%) of the actual fantasy points earned by the particular athlete.

Multipliers Feature—Athletes are selected based on desirability. The higher a fantasy player values the athlete, the higher the multiplier is for their fantasy points. If there are five athletes selected, the first slotted athlete might get five times their fantasy points, the second slotted athlete might get four times their fantasy points, etc.

Feature for Slotting Athletes on a Percentage Continuum—Athletes can be selected and slotted on a scale ranging from any percentages that a tournament organizer decides. For example, the first slot can be for 100%, the second slot can be for 85%, the third slot for 70%, etc. This allows fantasy players to select the same athletes, but the fantasy players might have their athletes valued at different percentages.

Feature for Disqualifying Athletes that are Duplicated—Disqualifying athletes that are duplicated is an especially effective feature in head-to-head matches. If both fantasy players in a match submit the same athlete, that athlete is disqualified and cannot be resubmitted.

Blind Percentage Bid Feature—Fantasy players are required to not only submit an athlete, but also a bid specifying a percentage of their fantasy points they will get for the match. For cases when both fantasy players select the same athlete, the bid is used by the example embodiment to decide who gets the athlete. The fantasy player who bids the lower percentage of fantasy points gets the athlete. For example, if fantasy player A is willing to take a given athlete at 73% of their fantasy points and fantasy player B is only willing to take the given athlete at 98% of their fantasy points, then fantasy player A would receive this athlete, but would only receive 73% percent of the fantasy points that athlete scored in the match. If both fantasy players bid the same percentage, nobody would get that athlete.

Specific Re-entry Strategies of an Example Embodiment—The only way that a high stakes fantasy sports tournament can charge a nominal buy-in fee and offer a high value grand prize is if there is a re-entry component that allows fantasy players an option to continue getting back into the tournament for as long as possible. The various embodiments described herein provide at least two re-entry features that have never been used before. These re-entry features are described below.

Re-entry Feature for Paying More Money to Play Fewer Rounds—When a fantasy player is eliminated and their opponent moves on, it would be inherently unfair to let the loser back in unless a fair accommodation was made. One method for letting somebody back in is to create another qualifying option that has fewer rounds (because there isn't as much time left until the tournament concludes), but charges the person a re-entry fee that is at a higher cost level than their opponent had to pay for their entry. For example, a fantasy player might only pay $5 to play in a 10 round qualifier and another fantasy player might pay $500 to play in a three round qualifier.

Re-entry Feature for Creating New Qualifiers with the Same Number of Rounds—This feature allows a fantasy player to continue playing in a new qualifier, but creates new paths to duplicate the same number of rounds that fantasy players who are still playing are required to play. This process is not as simple as it may sound; but, the capability is highly desirable, because it allows people to re-enter at very low prices and retains the fairness of the tournament. To create the new paths, an example embodiment can hold multiple rounds in the same day or even multiple rounds in the same game. This is because the qualifying tournament sometimes has only one day to duplicate the many rounds that another player took many weeks to complete. The various embodiments create new qualifiers to duplicate the same number of rounds by manipulating a smaller time period to create the same number of rounds thereby enabling the re-entry price to remain fixed.

Creating a Format for Condensed Seasons and Events—Many real life sporting seasons and events are so condensed that the only way to hold a viable high stakes fantasy tournament is to hold two or more rounds on the same day. For example, it is difficult to hold a high stakes fantasy tournament for the Olympics, World Cup of Soccer, or even the NFL playoffs where millions of fantasy players can play for a low entry fee, win a high value prize, and still play in groups. The various embodiments described herein provide a format that supports these condensed seasons and events. At least two features provided by an example embodiment enable these types of tournaments to be feasible. These features are described below.

Feature for Contingency Lineups—Fantasy players must submit two or more lineups during the same day for events that are happening throughout the day. Any lineup other than the initial one is a contingency lineup and only goes into effect if that fantasy player has advanced to the round where the contingency lineup becomes relevant.

Feature for Group Play throughout the tournament—In most cases, it is desirable to hold qualifying tournaments that involve group play to qualify fantasy players for the main tournament. During the main tournament, because there will be a fewer number of players, the tournament format can revert to the more traditional match play where fantasy players compete against a single opponent. Sometimes, it is simply not possibly to have any match play (e.g., head-to-head play), because the time frame is so short (like the Olympic Games). In cases like these, the feature for group play between fantasy players as described herein is used exclusively for these condensed tournaments so that the tournaments still can have the four essential ingredients that a thriving fantasy sports tournament must have as described herein.

The various embodiments as described herein provide the systems and methods (solutions) required for a fantasy sports machine or program that allows an unlimited number of fantasy players to enter a fantasy sports tournament without requiring them to play the entire field at the same time. The various embodiments as described herein are not tied to a particular fantasy sports game. Rather, the various embodiments provide a how-to guide for the features required to create a tournament format that is not currently available on the market. Before going into detail, some background information is helpful to understand some key practices that have created barriers for this new type of format.

Fantasy sports has become a multi-billion dollar industry that continues to grow exponentially. Emerging from this incredible growth has been a culture that has created certain expectations for how a fantasy tournament should look. Unfortunately, these expectations have not always been conducive for progress and have actually hindered the development of new types of formats. Factors that have contributed to this mindset and impeded progress include the common practices, beliefs and expectations that are described below.

Once such common practice is the practice of fantasy players competing against each other in a head-to-head format whenever possible. This is a by-product of how real life sports teams compete. The reasoning seems to be that you don't see three football teams competing against each other in the same game; therefore, you shouldn't have three fantasy players competing against each other in the same fantasy match. The only exception to this rule occurs when lottery type of tournaments are played. During lottery tournaments fantasy players are strictly vying for the high point total often against millions of others over the course of a given time period, which means they are all playing each other at the same time—a very discouraging method of competing.

Other factors impeding progress include the tendency of fantasy tournament organizers to preserve the tradition of league play within the tournament structure. League play is where anywhere from eight to twenty fantasy players form a league to compete head-to-head in order to determine which person has the best overall record. This is an extremely entertaining format; but, it is a disaster for fantasy tournaments that seek to crown an overall champion. The problem is that once leagues are formed, inferior fantasy players are kept in the tournament far too long which creates spacing problems.

Another factor is the reluctance to eliminate fantasy competitors early on in the tournament—even when they are doing poorly. As a general rule, fantasy players consider fantasy sports to be an entertainment outlet for the entire season. Early elimination from a tournament runs counter to this fundamental expectation.

Another factor is the practice of fantasy players exclusively owning their athletes. Once again, this mirrors how the real world of sports works. You don't see more than one team in real life sports share ownership of the same athlete, so the reasoning is that it shouldn't happen in fantasy games either. The only exception in the fantasy arena, once again, is with lottery style tournaments where the sharing of athletes is permitted out of necessity. This is due to the fact that there are not enough athletes to go around when the entire field of competitors are simultaneously playing one another. However, even though lottery tournaments allow sharing, they still don't have a system in place that penalizes fantasy players for duplicating athletes.

Another factor is the limited strategy inherent in submitting lineups in conventional tournament formats. In standard formats, what one fantasy player submits has no bearing on what their opponent submits in terms of potential bonuses or penalties. This creates a relatively stress free process, but may also create inefficiencies.

Another factor is the inability of many fantasy enthusiasts to differentiate between the actual fantasy games that have created a cultural phenomenon (and frankly don't need to be changed) and separate them from the flawed tournament structures that need an overhaul.

The solutions to address these barriers are not obvious. Some of them run counter to deeply entrenched beliefs on how fantasy sports games should be played. If they were obvious, people would be holding Holy Grail tournaments using the format described herein. There would be scores of tournaments where competitors could enter for a $5 entry fee, win a multi-million dollar grand prize, not be subjected to the daunting parameters of having to compete against the entire field at the same time, and also have an opportunity to re-enter the tournament without creating a competitive disadvantage for any of the players. However, in currently used tournament formats, the opposite of this is true. There isn't a single tournament on the market that has all of these features.

It is difficult to quantify how big this void is in the fantasy sports industry by not having a Holy Grail tournament structure. In many respects, the lack of an effective tournament format has been devastating for the industry. There has been so much interest in fantasy sports events, but current structures have not been an effective vehicle for delivering an all-comers tournament.

In the various embodiments described herein, there are at least four features that when combined together create a fantasy sports tournament that can attract the masses. These features include the following: 1) a low entry fee (buy-in); 2) a multi-million dollar grand prize; 3) participants must not be subjected to playing the entire field or large numbers of contestants at the same time to discourage the masses; and 4) a re-entry component.

In the previous section, six common practices were discussed that have impeded the progress for a Holy Grail tournament as described herein. Each of these common practices along with their non-obvious solution(s) is described in more detail below. It is important to note that these solutions don't have to appear in a particular order. Not all of them even need to be present to operate a successful Holy Grail tournament; although, the more solutions that are incorporated into the tournament structure, the more effective the tournament will be.

A first common practice in traditional tournament structures is the practice of fantasy players exclusively competing against each other in either head-to-head or lottery type formats. The various embodiments described herein provide a non-obvious solution or feature to address this common practice. In an example embodiment, fantasy players compete in small player groups of three or more in the same match. This feature of the example embodiment runs counter to what fantasy players think should happen. Fantasy players are used to their sports teams competing head-to-head so they expect the same from their fantasy matchups. As implemented in the example embodiment, a group is not the same as a league. A player group is defined as a small cluster of fantasy players who are put together to compete against one another in a single match. Leagues have groups of fantasy players competing against one another in head-to-head matches. This format only allows two fantasy players to compete against each another at the same time. For the purposes of this patent disclosure, a group is defined as three or more fantasy players who compete against each another at the same time. This format of the example embodiment with groups of three or more creates much needed spacing that allows more fantasy players to enter without subjecting them to the Lottery Effect.

A second common practice in traditional tournament structures is the tendency of fantasy tournament organizers to preserve the tradition of “league play” within the tournament structure. The various embodiments described herein provide a non-obvious solution or feature to address this common practice. In an example embodiment, a solution is implemented to eliminate the under-performing participants in a consistent and timely manner. In an effective tournament structure, it is simply not possible to keep low performing fantasy players in a tournament that looks to crown an overall champion, especially when there are millions of entries in the tournament. It creates a spacing nightmare, because nobody goes away until it is too late. There is no way to whittle millions of fantasy players down to one overall champion if the tournament format doesn't eliminate the participants in a consistent and timely manner. Current formats tend to start their elimination process way too late in the tournament. In one embodiment, a solution paradigm is to create single elimination fantasy sports tournaments. This format requires fantasy players to meet a minimum expectation for every round in which they play or they are immediately eliminated. It doesn't matter if it is the first round, the last round or any round in between. The expectation might be that they have to beat a single opponent in a head-to-head format or the expectation might be that they have to finish in the top four of their player group to advance. Whatever it is, there has to be a minimum expectation to remain in for every round. A single elimination type of format is common in sports and can be found in tennis, the NFL playoffs and the NCAA college basketball playoffs.

A third common practice in traditional tournament structures is the reluctance to eliminate fantasy competitors early on in the tournament, even when they are doing poorly. As a general rule, fantasy players consider fantasy sports to be an entertainment outlet for the entire season. Early elimination from a tournament runs counter to this fundamental expectation. The various embodiments described herein provide a non-obvious solution or feature to address this common practice/problem. As described above, a single elimination tournament structure helps to address the problem of slow elimination of under-performing players. However, this solution does not address the finality of getting eliminated quickly in the tournament. In an example embodiment, a solution is implemented to offset this problem by creating non-lottery effect qualifying tournaments that are staggered throughout the beginning of a given sports season and that provide a re-entry component. This allows the tournament to immediately eliminate or disqualify fantasy players that lose during a given round, but also provides an opportunity for them to opt back into the tournament by paying a new entry fee. The end result of this paradigm is that fantasy players can play in the tournament for quite some time like they traditionally have, but it also creates a format to hold a single round elimination tournament where fantasy players are eliminated if they lose a particular match. Some fantasy tournaments may appear to offer a re-entry component, but they really aren't. Each week they are holding a new lottery with the winner gaining a seat into the main tournament. In contrast, the embodiments described herein provide a system and method enabling fantasy players to have the opportunity to buy their way back into a tournament and still compete in small player groups without penalizing the players who advanced from the previous round(s). There are two ways to do this. First, fantasy players can pay higher fees to replace the rounds that they skipped to buy back into the tournament. Secondly, a method as disclosed herein is provided to allow fantasy players back into the tournament for the same price, yet replicating the same number of rounds that contestants who signed up earlier, and have already advanced at least one round, are required to play. In this manner, re-entry players do not gain an advantage over players who advanced from the previous round(s).

A fourth common practice in traditional tournament structures is the practice of fantasy players exclusively owning their athletes. This is a universal practice in traditional tournaments with the exception of lottery effect tournaments. The various embodiments described herein provide a non-obvious solution or feature to address this common practice. For tournament play, it is not practical to have a draft before every round. Moreover, if group play is a feature of the tournament, there has to be a system in place where athletes are selected quickly. The best way to do this is to permit duplication of athletes similar to what is done in lottery tournaments; but only if duplication of athletes comes at a price. There must be penalties for duplication of athletes. The way to accomplish this is to have a blind submission process where the more a given athlete is duplicated, the fewer fantasy points everyone in the player group that selected that athlete receives.

A fifth common practice in traditional tournament structures is the limited strategy that currently exists with submitting lineups. With current formats, what one fantasy player submits has almost no bearing at all on what their opponent submits in terms of potential bonuses and penalties. The various embodiments described herein provide a non-obvious solution or feature to address this common practice. As mentioned in the previous point, the example embodiment penalizes fantasy players for duplication of athletes. This is not the only way to penalize them though. The example embodiment is also configured to penalize fantasy players for not valuing a given athlete highly enough. This will force fantasy players to evaluate athletes not only on merit, but also on the likelihood that several other competitors in their player group might potentially select the same athletes. Also, the example embodiment is configured to offer bonuses by weighting the athletes. This can be done by requiring fantasy players to submit lineups with a listing of athletes in order of preference. The higher the athlete is ranked or “slotted”, the more potential bonus points the player will receive. This will create strategy where fantasy players really have to think about where their athletes should be placed on the lineup and create a climate where competing fantasy players try to out-think each other.

A sixth common practice in traditional tournament structures is the inability of many fantasy enthusiasts to differentiate between the actual fantasy games that have created a cultural phenomenon (and frankly don't need to be changed) and separate this from the flawed tournament structures that need to be fixed. Fantasy sports games are so compelling that it makes it less likely that people will look to find out-of-the-box solutions for fixing flawed tournaments formats for fear of incurring the wrath of fantasy players. As a result, the status quo remains in place. In contrast, the various embodiments described herein provide a non-obvious set of solutions or features to address the failures of the traditional tournament structures.

### BRIEF DESCRIPTION OF THE DRAWINGS

The various embodiments are illustrated by way of example, and not by way of limitation, in the figures of the accompanying drawings in which:

FIG. 1 is a flowchart showing how player groups are formed one group at a time;

FIG. 2 is a flowchart showing how some fantasy players advance in the group play tournament while some are eliminated or disqualified;

FIG. 3 is a flowchart showing how head-to-head fantasy players submit athletes via a blind submission process over a set number of submission rounds. In this example 3 rounds is used;

FIG. 4 is a flowchart showing how groups submit athletes via a blind submission process;

FIG. 5 is a flowchart showing how group tournaments can also be filled by creating a pre-determined number of groups and then adding one fantasy player to each group before any one group gets bumped higher;

FIG. 6 is a flowchart showing how fantasy players are randomly assigned for a head-to-head Main Event tournament match;

FIG. 7 is a processing flow chart illustrating an example embodiment of systems and methods for conducting fantasy sports tournaments;

FIG. 8 illustrates an example embodiment of a fantasy sports tournament system in a network-enabled environment;

FIG. 9 illustrates another example embodiment of a networked system in which various embodiments may operate;

FIG. 10 shows a diagrammatic representation of a machine in the example form of a stationary or mobile computing and/or communication system within which a set of instructions when executed and/or processing logic when activated may cause the machine to perform any one or more of the methodologies described and/or claimed herein; and

FIGS. 11 through 14 illustrate an example embodiment, implemented as a web application (app), which shows the basic elements of the user interface for implementing a fantasy sports tournament with multi-contestant small group rounds.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

The various embodiments of systems and methods for creating a Holy Grail tournament are described herein. The tournament format in an example embodiment utilizes a two tiered structure. First, qualifying tournaments are used to qualify fantasy players that feed directly into a main event tournament. Secondly, a main tournament is used to determine an overall winner as well as other top finishers. It is important to note that individual features within each of these two tournament formats don't necessarily have to be in the order described. Some are not even required to hold a Holy Grail tournament, but are listed to enhance the quality of the tournament. Finally, the idea of having qualifying tournaments to get into a main event isn't unprecedented. The problem with what is currently available is that all variations fall into the trap of either offering one of the two variations (Head-to-Head or Lottery Effect) that was described earlier. For example, FanDuel offers a Main Event where hundreds or even thousands of people are forced to compete against one another simultaneously to try and qualify for the Main Event. It is extremely discouraging for fantasy players to enter a tournament knowing that the only way to gain entry into the Main Event is if they post the highest score out of several hundred or thousand people.

### Qualifying Tournaments

The goal is to create a predetermined number of qualifying tournaments that feed into a Main Event tournament. In an example embodiment, these qualifying tournaments have the following features. Matches are played in small groups of three or more fantasy players. A predetermined number of “winning” fantasy players advance to the next qualifying round (or qualify directly into the Main Event tournament). For example, if groups are set at 12 members each, it might be determined that the top three scores in each group will advance. The particular scoring system for determining fantasy points for an athlete can be any that is commonly used or one that is completely new to the industry. Fantasy players submit their lineups via a blind submission process. The more duplication that occurs for a given athlete during this blind submission process, the less they will be worth. There is a re-entry component that allows contestants to opt back in either by 1) by allowing them to pay more money for playing less rounds or 2) allowing them to re-enter at the same price by duplicating the number of rounds that advancing contestants have been required to play. If they re-enter by paying more money for less rounds there might be a qualifying tournament where it only takes advancing four rounds to qualify directly into the Main Event tournament and there might be a qualifying tournament that takes nine rounds to advance to the Main Event Tournament. The qualifying tournament that takes more rounds to qualify would be less expensive to enter. There is also an alternative version that can be used instead of the version previously described. If they re-enter by paying the same amount of money, that particular qualifying tournament would have to have the same number of rounds. This format requires creating options to include more and more rounds in a shorter period of time. What ends up happening is that individual rounds are contested in different ways than the earlier rounds (see Explanation #4 below). Portions of some qualifying tournaments can run concurrently with other qualifying tournaments while other portions don't have to run concurrently. Fantasy players can purchase multiple entries for the same qualifying tournament. Fantasy players can enter more than one qualifying tournament at the same time. The Main Event tournament has a predetermined number of seats; therefore, it is critical that the satellite rounds are capped at an appropriate number so that there aren't more fantasy players qualifying for the Main Event tournament than there are seats available. Qualifying rounds can have several different types of formats for weighting athletes depending on where they are slotted (see Explanation #1).

### Main Event Tournament

Main Event consists of fantasy players who advanced via qualifying tournaments or directly buying in. The number of seats available for fantasy players in the Main Event is predetermined before the tournament even started. Main Event can either be a head-to-head format or a continuation of group play. If the Main Event is head-to-head, fantasy players are randomly assigned an opponent. If there is nobody to whom they can be assigned, they receive a bye to the next round. If the Main Event is group play, then a predetermined number of fantasy players advance from each group for a given round. For the final group, during the last round, fantasy players play for final positions. In an example embodiment, the scoring system for the Main Event should be a simple scoring system that fantasy players are familiar with from whatever sport the tournament is featuring. The Main Event should have a predetermined number of seats to ensure that it is possible to crown an overall champion as well as recognize top finishers.

The following description illustrates one example of a step-by-step explanation of how a Holy Grail tournament works in an example embodiment. Again, these steps are interchangeable in many places and some of them aren't even required.

Step #1—Fantasy players are presented with different options for entering a qualifying tournament. They will find that the more rounds a qualifying tournament offers, the less expensive they are to play in (see Explanation #3 and Table 1 in the Appendix below). Table 1 shows a satellite tournament structure for a fantasy sports tournament.

Step #2—Caps are established by the computer program to ensure that there are not more seats allocated for the Main Event Tournament than it can support (see Table 2 in the Appendix below). Table 2 shows how caps are established for qualifying tournaments.

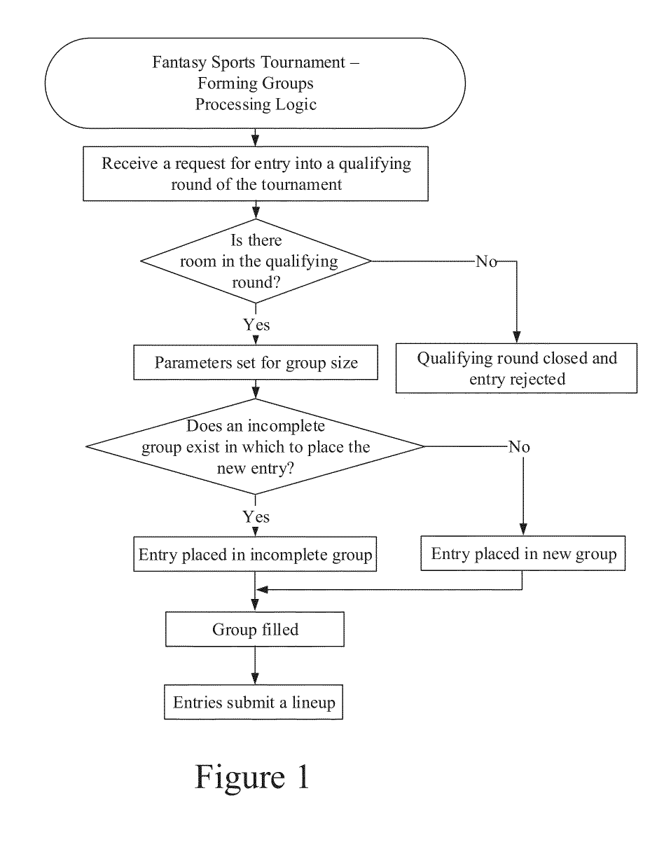

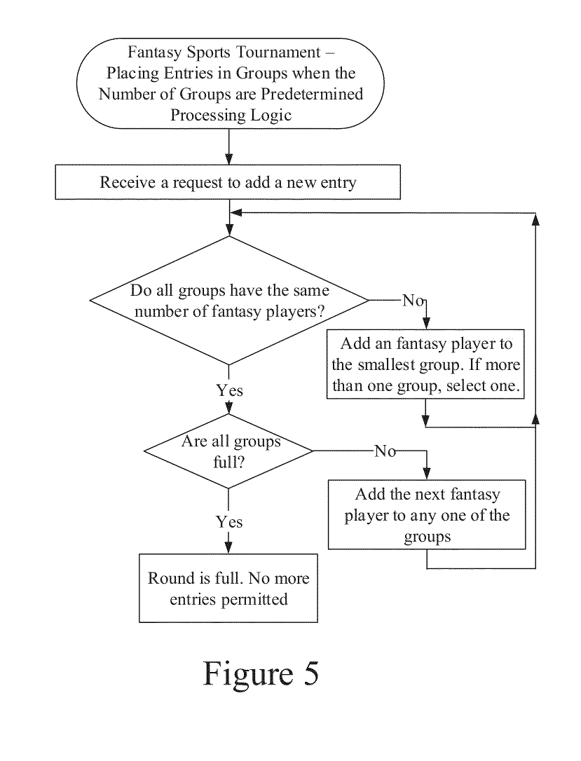

Step #3—Once a fantasy player has entered a qualifier, they will be assigned a group. Group play is a technique that helps create the proper spacing a tournament needs to accommodate millions of fantasy players (see Explanation #2 below for different group formats). There are two ways groups can be filled. They can either be filled one group at a time (see FIG. 1) to ensure that each group has the maximum number of fantasy players established by the tournament rules or, instead, a predetermined number of groups can be established and fantasy players are placed into the groups in a manner where each group receives their first fantasy player before a second is added in and so on (see FIG. 5).

Step #4—Fantasy players are required to turn in their lineups via a blind submission process. Fantasy players will have to take into consideration how athletes are weighted and also the likelihood of being duplicated (see Explanation #1 below).

Step #5—The scoring system can be a commonly used and accepted format.

Step #6—The computer program of an example embodiment calculates the fantasy point value each athlete is worth based on duplication of athletes (see Table 3 and Table 4 in the Appendix below). Table 3 shows how a given athlete loses a percentage of their fantasy points based on two or more fantasy players selecting that same athlete for their lineups. Table 4 shows the calculations of several athletes' recalibrated fantasy points based on how much duplication occurred.

Step #7—If a player fails to get their lineup in for a match, their previous lineup will be submitted as a default lineup for the match by the computer program of an example embodiment.

Step #8—Live athletic competition in the corresponding sport takes place. The computer program of an example embodiment has ongoing scoring updates and shows each fantasy player, their running score, and where they rank overall in their group.

Step #9—Once all of the real life sporting events are completed that are relevant to the group fantasy match, the computer program of an example embodiment tabulates final scores based on the given weighting and duplication systems used for the match (see Table 5 in the Appendix below). Table 5 shows a final tally of a fantasy match that incorporates both weighting bonuses and duplication penalties.

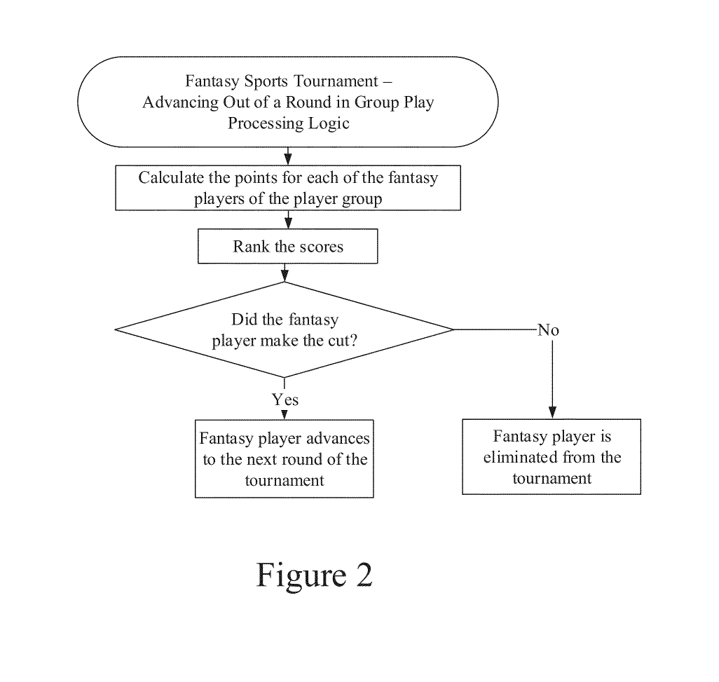

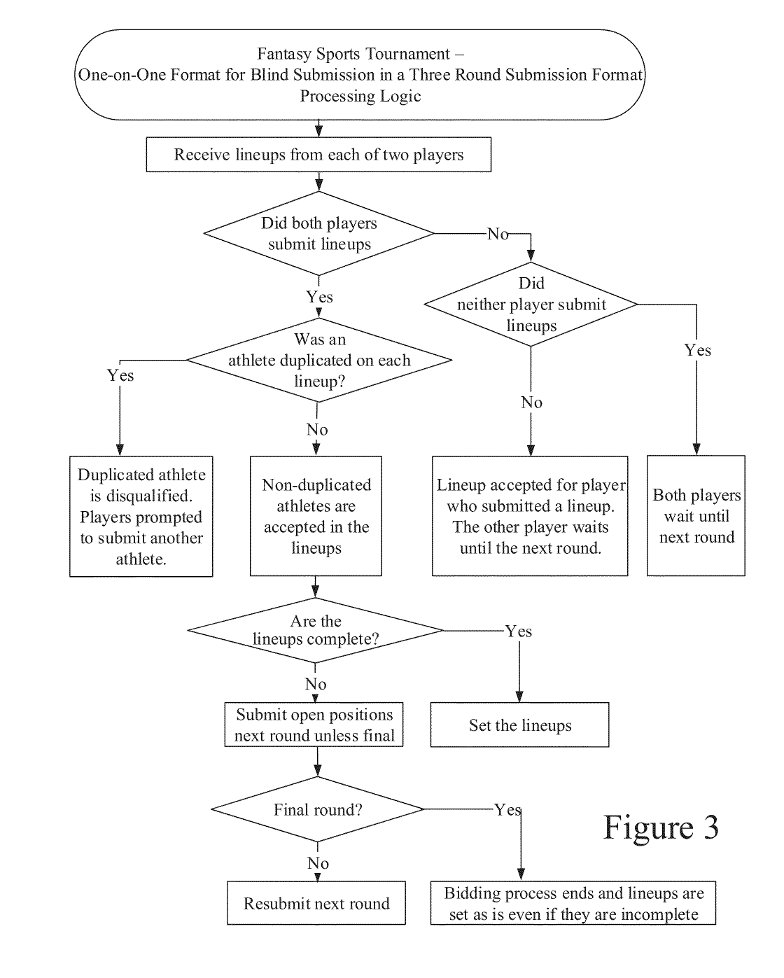

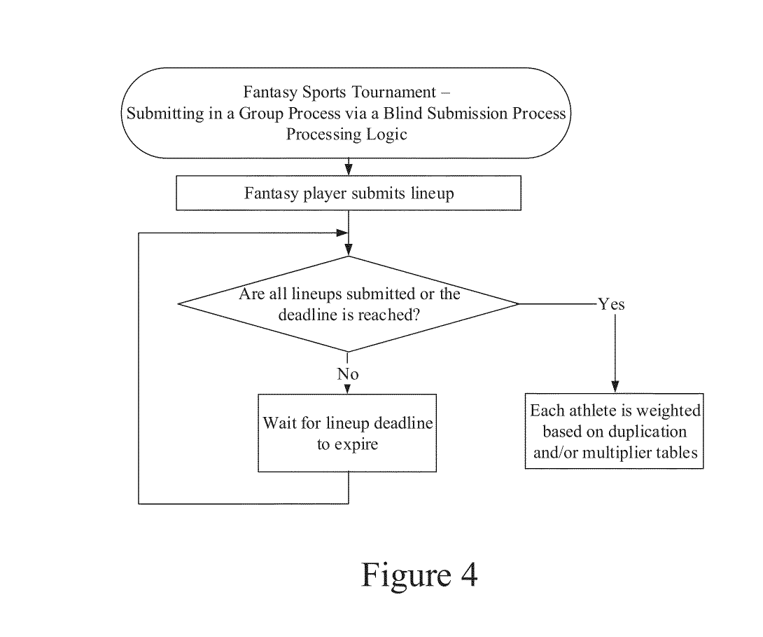

Step #10—The computer program of an example embodiment determines a cutoff for each group. The number of fantasy players that are qualified to advance for a given round of the qualifying process move onto the next qualifying round (or move onto the Main Event Tournament if they advance during the last qualifying round) and the remaining members of the group are eliminated (see FIG. 2).

Step #11—The process begins anew for qualifying rounds and the first ten steps are repeated over and over until a fantasy player is either eliminated or qualifies for the Main Event Tournament. Fantasy players can either re-enter by buying into a new qualifying tournament or they have advanced from a previous round of a qualifying tournament and are placed in a group for the new round.

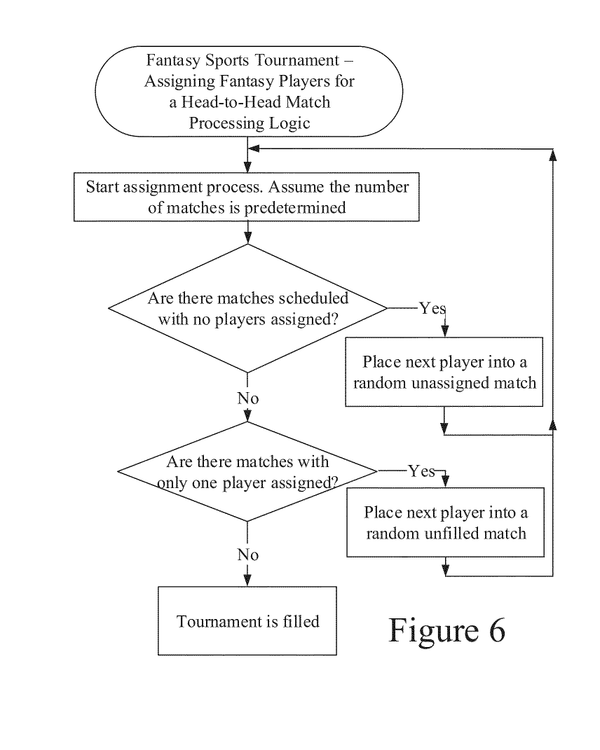

Step #12—For Main Event Tournament rounds, the same format is in place if group play is in effect. The only exception is for the last round of the tournament where fantasy players compete for final positions instead of trying to advance. If the Main Event Tournament is structured in a head-to-head format, fantasy players are randomly assigned to play in a particular match. Each single match (keep in mind that the number of matches is predetermined) must have one fantasy player assigned to it before assignments for an opponent are made (see FIG. 6).

Step #13—Any match that has only one fantasy player assigned to it results in that fantasy player receiving a bye for the round and automatically advancing to the next round (see FIG. 6).

Step #14—If for some reason there isn't a fantasy player assigned to a match, a double bye is declared and a “bye” will be entered into the mix for the next round. The fantasy player that is assigned this bye will be awarded a bye during that new round and will move on to the next round (see FIG. 6).

Step #15—The format for the match will be determined (see Explanation #2 for different match formats).

Step #16—The scoring system can be a commonly used and accepted format.

Step #17—The fantasy player with the better score moves on to the next round, the loser is eliminated from the tournament.

Step #18—The last two standing will play for the championship with the fantasy player with the higher fantasy point total earning the tournament championship and their opponent earning the runner-up position.

Explanation #1—Weighting the point values of fantasy players based on a) the slotted position in which an athlete was selected, and/or b) how many fantasy players selected them. Weighting athletes based on how they were prioritized and/or how often they were duplicated is a process that forces fantasy players to think very carefully about which athletes they submit and where they place them in their lineup hierarchy. This is especially true for formats that require fantasy players competing against each other to turn in their lineups via a blind submission process. A blind submission method is where all the fantasy players in a group competing against one another are required to turn in their lineups before they find out what the others in the group submitted.

The following are examples of some techniques used in an example embodiment to weight the players. Fantasy players are awarded multiples of the fantasy points their athletes scored depending on where their athletes were selected. For example, assume each fantasy player selects five athletes. For each fantasy player's first slotted athlete, the athlete could be worth five times the fantasy points they scored in their match. For each fantasy player's second slotted athlete, the athlete could be worth four times the fantasy points they scored in their match. For each fantasy player's third slotted athlete, the athlete could be worth three times the fantasy points they scored in their match. For each fantasy player's fourth slotted athlete, the athlete could be worth two times the fantasy points they scored in their match. For each fantasy player's fifth slotted athlete, the athlete could be worth face value of the fantasy points they scored in their match. The following is a table illustrating a hypothetical example that could be from a 12 player group competing, for example, in a fantasy cricket tournament:

| | | | | | Athlete #5 |
|---|---|---|---|---|---|
| | Athlete #1 | Athlete #2 | Athlete #3 | Athlete #4 | FACE |
| | 5X | 4X | 3X | 2X | VALUE |
| Fantasy | Tendulkar | Vettori | Sangakkara | Jadeja | Sehwag |
| Player 1 | Mumbai Indians | Bangalore | Hyderabad | Chennai | Delhi |
| Fantasy | Gilchrist | Sangakkara | Sharma | Vettori | Ganguly |
| Player 2 | Mohali | Hyderabad | Mumbai | Bangalore | Pune |
| Fantasy | Sangakkara | Dravid | Dhoni | Kohli | Jadeja |
| Player 3 | Hyderabad | Jaipur | Chennai | Bangalore | Chennai |
| Fantasy | Gilchrist | Vettori | Sangakkara | Pathan | Gambhir |
| Player 4 | Mohali | Bangalore | Hyderabad | Delhi | Calcutta |
| Fantasy | Ganguly | Sangakkara | Sehwag | Dravid | Sharma |
| Player 5 | Pune | Hyderabad | Delhi | Jaipur | Mumbai |
| Fantasy | Dhoni | Tendulkar | Sangakkara | Sehwag | Gambhir |
| Player 6 | Chennai | Mumbai Indians | Hyderabad | Delhi | Calcutta |
| Fantasy | Vettori | Sehwag | Sangakkara | Tendulkar | Gilchrist |
| Player 7 | Bangalore | Delhi | Hyderabad | Mumbai Indians | Mohali |
| Fantasy | Gambhir | Sharma | Sangakkara | Tendulkar | Kohli |
| Player 8 | Calcutta | Mumbai | Hyderabad | Mumbai Indians | Bangalore |
| Fantasy | Dravid | Sangakkara | Pathan | Gilchrist | Vettori |
| Player 9 | Jaipur | Hyderabad | Delhi | Mohali | Bangalore |
| Fantasy | Gilchrist | Sangakkara | Dravid | Ganguly | Gambhir |
| Player | Mohali | Hyderabad | Jaipur | Pune | Calcutta |
| 10 | | | | | |
| Fantasy | Vettori | Gilchrist | Gambhir | Sehwag | Tendulkar |
| Player | Bangalore | Mohali | Calcutta | Delhi | Mumbai Indians |
| 11 | | | | | |
| Fantasy | Dhoni | Tiwary | Sangakkara | Tendulkar | Ganguly |
| Player | Chennai | Bangalore | Hyderabad | Mumbai Indians | Pune |
| 12 | | | | | |

Another weighting method that can be implemented in an alternative embodiment is one where fantasy players are given a percentage of the fantasy points an athlete earned depending on where the player selected that athlete. For example, if each fantasy player is asked to select eight athletes, the selected athletes can be weighted by having the first athlete everyone selects be worth 100% of their fantasy points, the second athlete selected can be worth 87.5% of their fantasy points, the third worth 75% of their fantasy points, the fourth worth 62.5% of their fantasy points, the fifth worth 50% of their fantasy points, the sixth worth 37.5% of their fantasy points, the seventh worth 25% of their fantasy points, and the eighth worth 12.5% of their fantasy points. The following is a table illustrating a hypothetical example of this method using athletes from the Philippine Basketball League as an example (Note that duplication of athletes is permitted in this example):

| | Slotted | | | Slotted | | | Slotted | |
|---|---|---|---|---|---|---|---|---|
| | #1 | Slotted #2 | Slotted #3 | #4 | Slotted #5 | Slotted #6 | #7 | Slotted #8 |
| | 100% | 87.5% | 75% | 62.5% | 50% | 37.5% | 25% | 12.5% |
| Fantasy | Miller | David | Yap | Lutz | Santos | Lassiter | Cardoa | Chan |
| Player | Barako | Powerade | B-Meg | Petron | Petron | Powerade | Meralco | Rain or |
| #1 | | | | | | | | Shine |
| Fantasy | David | Yap | Reyes | Lassiter | Castro | Chan | Sena | Lutz |
| Player | Powerade | B-Meg | Alaska | Powerade | Talk N | Rain or | Shopinas | Petron |
| #2 | | | Aces | | Text | Shine | | |

Another format that can be implemented in an alternative embodiment penalizes fantasy players for duplication of athletes. Using this method, fantasy players are allowed to share athletes, but the more duplication that occurs reduces the percentage of fantasy points each fantasy player receives for that given athlete. For example, here is a sample duplication table for up to a 12 player fantasy match.

Percentage of Fantasy Points an Athlete is Worth
Based on Duplication of Athletes Selected

| | Athlete | | | | | | | | | | | |
|---|---|---|---|---|---|---|---|---|---|---|---|---|
| | selected | | | | | | | | | | | |
| | 1X | 2X | 3X | 4X | 5X | 6X | 7X | 8X | 9X | 10X | 11X | 12X |
| 4 player | 100% | 67% | 33% | 0% | NA | NA | NA | NA | NA | NA | NA | NA |
| fantasy | | | | | | | | | | | | |
| match | | | | | | | | | | | | |
| 5 player | 100% | 75% | 50% | 25% | 0% | NA | NA | NA | NA | NA | NA | NA |
| fantasy | | | | | | | | | | | | |
| match | | | | | | | | | | | | |
| 6 player | 100% | 80% | 60% | 40% | 20% | 0% | NA | NA | NA | NA | NA | NA |
| fantasy | 100% | | | | | | | | | | | |
| match | | | | | | | | | | | | |
| 7 player | 100% | 83% | 67% | 50% | 33% | 17% | 0% | NA | NA | NA | NA | NA |
| fantasy | | | | | | | | | | | | |
| match | | | | | | | | | | | | |
| 8 player | 100% | 86% | 72% | 58% | 43% | 28% | 14% | 0% | NA | NA | NA | NA |
| fantasy | | | | | | | | | | | | |
| match | | | | | | | | | | | | |
| 9 player | 100% | 87% | 75% | 62% | 50% | 38% | 25% | 13% | 0% | NA | NA | NA |
| fantasy | | | | | | | | | | | | |
| match | | | | | | | | | | | | |
| 10 player | 100% | 89% | 78% | 67% | 56% | 45% | 34% | 23% | 12% | 0% | NA | NA |
| fantasy | | | | | | | | | | | | |
| match | | | | | | | | | | | | |
| 11 player | 100% | 90% | 80% | 70% | 60% | 50% | 40% | 30% | 20% | 10% | 0% | NA |
| fantasy | | | | | | | | | | | | |
| match | | | | | | | | | | | | |
| 12 player | 100% | 91% | 82% | 73% | 64% | 55% | 46% | 37% | 28% | 19% | 10% | 0% |
| fantasy | | | | | | | | | | | | |
| match | | | | | | | | | | | | |

In the example above, “1×” is read as “one time” which means a given athlete was selected by exactly 1 of the 12 fantasy players. Also, note that the in the example above, the percentages are not fixed. They are completely arbitrary. For this example table, the spreads were distributed equally (to the nearest whole percentage) based on how many fantasy players selected a given athlete.

The highlighted (bolded and underlined) portion of the table represents a seven player fantasy group where five of the members submitted the same athlete. Because duplication of athletes is permitted in an example embodiment, each of the members would have that athlete in their lineups, but each of the members would receive only 33% of the fantasy points that athlete scored in their match.

Once the live sporting events have been completed, the actual fantasy points an athlete scores are converted to their adjusted fantasy points based on how many other fantasy players selected a given athlete. The following table is an example from a hypothetical group of NFL athletes that shows an example of this conversion.

| | | # of times | | *Adjusted |
|---|---|---|---|---|
| | Actual | Athlete | Percentage | Fantasy |
| Athlete | Fantasy Score | Selected | Multiplier | Score |
| Vick, Phila | 31 | 2 | .91 | 28.21 |
| Brady, NE | 25 | 6 | .55 | 13.75 |
| P. Manning, Ind | 40 | 3 | .82 | 32.80 |
| Brees, NO | 28 | 1 | 1.00 | 28.00 |
| Gore, SF | 16 | 2 | .91 | 14.56 |
| Peterson, Min | 33 | 11 | .10 | 3.30 |
| Mendenhall, Pit | 15 | 1 | 1.0 | 15.00 |
| C. Johnson, Ten | 29 | 4 | .73 | 21.17 |
| Foster, Hou | 21 | 1 | 1.0 | 21.00 |
| Jones-Drew, Jax | 9 | 1 | 1.0 | 9.00 |
| Bradshaw, NYG | 13 | 1 | 1.0 | 13.00 |
| Turner, Atl | 31 | 1 | 1.0 | 31.00 |
| Rice, Balt | 17 | 1 | 1.0 | 17.00 |
| S. Jackson, STL | 24 | 1 | 1.0 | 24.00 |
| Welker, NE | 21 | 2 | .91 | 19.11 |
| C. Johnson, Det | 18 | 6 | .55 | 9.90 |
| A. Johnson, Hou | 27 | 5 | .64 | 17.28 |
| Bowe, KC | 11 | 1 | 1.0 | 11.00 |
| Austin, Dal | 15 | 1 | 1.0 | 15.00 |
| White, Atl | 13 | 1 | 1.0 | 13.00 |
| Wallace, Pitt | 25 | 1 | 1.0 | 25.00 |
| Jennings, GB | 17 | 1 | 1.0 | 17.00 |
| Marshall, Mia | 16 | 1 | 1.0 | 16.00 |
| Fitzgerald, Az | 22 | 3 | .82 | 18.04 |
| Wayne, Ind | 10 | | 1.0 | 10.00 |
| D. Jackson, Phil | 12 | | 1.0 | 12.00 |

To calculate the Adjusted Fantasy Score in an example embodiment, the computer program can multiply the Actual Fantasy Score by the Percentage Multiplier. For instance in the example above, Michael Vick scored 31 actual fantasy points and two players selected Vick as an athlete in their player lineups. Because two players selected Vick as an athlete in their player lineups, each player will receive 91% of those actual fantasy points. Thus, Vick's Adjusted Fantasy Score, in this example, is 31×0.91=28.21.

Another technique, that is similar to the previous example, punishes fantasy players more severely for duplication of athlete selection. In this embodiment, the system splits the fantasy points that an athlete earns with every member of the group that selected the athlete. For example, if an athlete scores 32 fantasy points and five fantasy players selected the athlete, then each member of the group that selected the athlete would receive 6.4 fantasy points (32 divided by 5 equals 6.4).

The weighting systems can also be combined. For example, the following table shows an example from a 20 player fantasy cricket match where the slots are weighted according to where an athlete was selected and the percentage of fantasy points (listed under their name and country) they earn is based on how many other fantasy players selected a given athlete.

| | | | | | Athlete #5 |
|---|---|---|---|---|---|
| | Athlete #1 | Athlete #2 | Athlete #3 | Athlete #4 | FACE |
| | 5 TIMES | 4 TIMES | 3 TIMES | 2 TIMES | VALUE |
| Fantasy | Al Hasan | ul-Haq | Rahim | Afridi | Gul |
| Player 1 | Bangladesh | Pakistan | Bangladesh | Pakistan | Pakistan |
| | 32% | 64% | 6% | 48% | 22% |
| Fantasy | Hafeez | Al Hasan | Mahmudullah | Gul | Afridi |
| Player 2 | Pakistan | Bangladesh | Pakistan | Pakistan | Pakistan |
| | 53% | 32% | 85% | 22% | 48% |
| Fantasy | Gul | Rahim | Hafeez | Cheema | ul-Haq |
| Player 3 | Pakistan | Bangladesh | Pakistan | Pakistan | Pakistan |
| | 22% | 6% | 53% | 58% | 64% |
| Fantasy | ul-Haq | Afridi | Iqbal | Rahim | Al Hasan |
| Player 4 | Pakistan | Pakistan | Pakistan | Bangladesh | Bangladesh |
| | 64% | 48% | 79% | 6% | 32% |
| Fantasy | Gul | Khan | Rahim | Hafeez | Cheema |
| Player 5 | Pakistan | Pakistan | Bangladesh | Pakistan | Pakistan |
| | 22% | 90% | 6% | 53% | 58% |
| Fantasy | Rahim | Afridi | Al Hasan | Mahmudullah | ul-Haq |
| Player 6 | Bangladesh | Pakistan | Bangladesh | Pakistan | Pakistan |
| | 6% | 48% | 32% | 85% | 64% |
| Fantasy | Al Hasan | Gul | Cheema | Afridi | Rahim |
| Player 7 | Bangladesh | Pakistan | Pakistan | Pakistan | Bangladesh |
| | 32% | 22% | 58% | 48% | 6% |
| Fantasy | Rahim | Hafeez | Gul | Iqbal | Al Hasan |
| Player 8 | Bangladesh | Pakistan | Pakistan | Pakistan | Bangladesh |
| | 6% | 53% | 22% | 79% | 32% |
| Fantasy | Rahim | Cheema | Afridi | Al Hasan | Gul |
| Player 9 | Bangladesh | Pakistan | Pakistan | Bangladesh | Pakistan |
| | 6% | 58% | 48% | 32% | 22% |
| Fantasy | Hafeez | Khan | Gul | Rahim | ul-Haq |
| Player 10 | Pakistan | Pakistan | Pakistan | Bangladesh | Pakistan |
| | 53% | 90% | 22% | 6% | 64% |
| Fantasy | Rahim | Al Hasan | ul-Haq | Gul | Mahmudullah |
| Player 11 | Bangladesh | Bangladesh | Pakistan | Pakistan | Pakistan |
| | 6% | 32% | 64% | 22% | 85% |
| Fantasy | Afridi | Gul | Al Hasan | Cheema | Rahim |
| Player 12 | Pakistan | Pakistan | Bangladesh | Pakistan | Bangladesh |
| | 48% | 22% | 32% | 58% | 6% |
| Fantasy | Cheema | Afridi | Gul | Rahim | Hafeez |
| Player 13 | Pakistan | Pakistan | Pakistan | Bangladesh | Pakistan |
| | 58% | 48% | 22% | 6% | 53% |
| Fantasy | Al Hasan | Iqbal | Afridi | Hafeez | Rahim |
| Player 14 | Bangladesh | Pakistan | Pakistan | Pakistan | Bangladesh |
| | 32% | 79% | 48% | 53% | 6% |
| Fantasy | Gul | Rahim | Hafeez | ul-Haq | Khan |
| Player 15 | Pakistan | Bangladesh | Pakistan | Pakistan | Pakistan |
| | 22% | 6% | 53% | 64% | 90% |
| Fantasy | ul-Haq | Al Hasan | Mahmudullah | Gul | Rahim |
| Player 16 | Pakistan | Bangladesh | Pakistan | Pakistan | Bangladesh |
| | 64% | 32% | 85% | 22% | 6% |
| Fantasy | Gul | Jamshed | Al Hasan | Rahim | Cheema |
| Player 17 | Pakistan | Pakistan | Bangladesh | Bangladesh | Pakistan |
| | 22% | 100% | 32% | 6% | 58% |
| Fantasy | Cheema | Al Hasan | Afridi | Iqbal | Rahim |
| Player 18 | Pakistan | Bangladesh | Pakistan | Pakistan | Bangladesh |
| | 58% | 32% | 48% | 79% | 6% |
| Fantasy | Rahim | Gul | Hafeez | Afridi | Iqbal |
| Player 19 | Bangladesh | Pakistan | Pakistan | Pakistan | Pakistan |
| | 6% | 22% | 53% | 48% | 79% |
| Fantasy | Hafeez | Rahim | Gul | Cheema | Al Hasan |
| Player 20 | Pakistan | Bangladesh | Pakistan | Pakistan | Bangladesh |
| | 53% | 6% | 22% | 58% | 32% |

Explanation #2—Structuring some or all of a tournament in groups of three or more players. Because sporting events are almost universally structured where either one team competes against another team (such as in football, basketball, baseball, etc.) or one individual competes against another individual (such as in boxing, wrestling, tennis, etc.) or individuals compete against the entire field simultaneously (such as in golf, motor sports, cycling, etc.), the fantasy sports industry has been a victim of these formats when it comes to creating tournaments for fantasy sports enthusiasts. For that reason, there has never been a fantasy tournament where an unlimited number of people can play without being subjected to playing the entire field at the same time. The various embodiments described herein provide a solution to this problem with existing fantasy tournaments.

Even though real life sporting events don't usually have seven teams compete against each other at the same time, there is no reason why this can't happen for a fantasy sports match. Instead of structuring fantasy tournaments as if they were real sporting events, there is no reason why the format can't look more like a card game with several players competing against one another simultaneously. This format allows more fantasy players to compete in the tournament without subjecting them to having to face the entire field at once.

There is little doubt that having fantasy players compete in small groups runs counter to how people think fantasy tournaments should be held. But, it is the only way to allow an unlimited number of players the opportunity to enter without subjecting them to competing against the entire field at the same time.

In the various example embodiments described herein, there are several specific formats that use a group play format (some are more effective than others because of the time it takes to create a full lineup to submit). These formats in an example embodiment include the following sample formats.

Group Tournament Type #1—Using a Fantasy Draft—Leagues of 10 to 12 people have been getting together and drafting for fantasy leagues since the origins of fantasy sports. However, the purpose of a draft in traditional leagues has always been to form a league where members of the group play each other in one-on-one matches throughout the season to see which fantasy owners emerge with the best records to playoff for the championship.

In the various embodiments described herein, an important distinction is made between traditional leagues and the small player groups used in the various embodiments. Instead of drafting to compete in a league as is traditionally done, small groupings of players come together (typically online) to draft for a single match where everyone in the group is playing everyone else in the group simultaneously. This simultaneous play between all members of the group does not occur in traditional leagues. In the various embodiments described herein, a predetermined number of top scores from this fantasy player group earn the right to advance to the next round. For example, a group of 12 entries (fantasy players) playing in a fantasy cricket tournament might end up drafting athletes with the understanding that the top 3 scores are to advance to the next round. The number of scores necessary to advance can be predetermined.

To conduct a Holy Grail tournament online using this particular format in accordance with an example embodiment described herein, fantasy players would pay a fee, which would automatically put them in an online draft room that is capped at a certain number of entries for a given group. The online draft room can be implemented as an online collection of users/fantasy players in a manner similar to the way collections of online users can gather in a chat room. For example, the fantasy game might be rugby that allows ten entries (fantasy players) per group with the top two scores advancing to the next round. This doesn't necessarily mean that the group will ultimately end up with ten people; because, this is determined by when the first person of a given group enters the online draft room. Once the first person enters, a time limit is set (for example 20 minutes) for the group to fill up with ten people. Once it does, the draft starts immediately with the drafting order determined by when the players show up in the draft room. The earlier a person appears, the higher they draft. The draft can follow a serpentine format as defined above.

If not enough fantasy players fill the ten spaces, the draft begins when the allotted time has passed with however many people are in the draft room. If the number of people in the draft room is less than or equal to the number of fantasy players that are supposed to advance from a group determined by the tournament rules, the fantasy players automatically receive byes to the next round and do not compete in a match against each other for that round.

Group Tournament Type #2—Holding a Fantasy Draft with a Bidding Twist—Once again, the example embodiment provides a draft amongst a small group of fantasy players who compete against each other in a single match. Parts of the draft protocol are the same as the first tournament format described above. For instance, the mechanics of how the first person in the draft room starts the clock to determine the number of people that will be in the group is the same.

The draft rules are completely different though from a traditional draft. In this format, fantasy players don't necessarily get the athlete they draft. In this format of an example embodiment, every fantasy player is given a set amount of credits to spend in order to secure athletes. All members of the group can bid on an athlete who was drafted. For example, let's assume it is a fantasy football draft and every fantasy player is given 50 credits to secure one quarterback (QB), two running backs (RB's) and two wide receivers (WR's). The fantasy player who initially drafts a given football player automatically has a 1 credit bid for that player to kick off the bidding process. The draft bidding process then goes to the next fantasy player in the draft. The next fantasy player can either bid 2 or more credits (must bid in increments of 1—can't use fractions) or “pass” to the next fantasy player in the draft.

Only when the draft bidding process goes through the entire group of fantasy players back to the person who has the highest bid on record, does the bidding end for this football player (athlete). The fantasy player who made the winning bid has the number of credits they bid deducted from their credit account. They are the only fantasy player in the group who is allowed to start that football player for their lineup. The draft then goes back to the original order where the second fantasy player drafting introduces a new football player on whom the fantasy players in the group can bid.

An example of the process for an 8 player group is set forth below:

Fantasy Player #1—“I submit Tom Brady” (automatically means a 1 credit bid)

Fantasy Player #2—“Pass”

Fantasy Player #3—“I bid 2 credits”

Fantasy Player #4—“I bid 5 credits”

Fantasy Player #5—“I bid 6 credits”

Fantasy Player #6—“Pass”

Fantasy Player #7—“I bid 9 credits”

Fantasy Player #8—“I bid 11 credits”

Fantasy Player #1—“Pass”

Fantasy Player #2—“Pass”

Fantasy Player #3—“Pass”

Fantasy Player #4—“I bid 12 credits”

Fantasy Player #5 through Fantasy Player #3 all pass

Fantasy Player #4 gets Tom Brady and has 12 credits removed from their account

Fantasy Player #2 introduces the next player to bid on

If a fantasy player runs out of credits without filling up all of their positions, they no longer can bid and must wait for the free agent draft which comes immediately after the main draft. This free agent draft happens once everyone has either filled out an entire lineup or run out of credits. The free agent draft is then held only for the fantasy players who still have places to fill. This draft goes in reverse order from the original draft order. A fantasy player drafting can only take one football player when it is their turn. If they have more than one place to fill, they must wait until the drafting process comes back to them again. Once a fantasy player fills their entire roster, they are automatically dropped from the free agent draft.

Group Tournament Type #3—Blind Submission Format—Sharing Fantasy Points of Duplicated Athletes—In an example embodiment, a blind submission format is utilized when lineup submissions happen exactly one time. Small groups competing against one another submit lineups for all required positions using a blind submission format (e.g., where fantasy players have to turn in their lineups without knowing what other fantasy players involved in the match selected). Duplication of athletes is permitted, but when this happens there is a penalty. All fantasy players who submitted a duplicated athlete will evenly split that athlete's point total for the match. For example, if eleven fantasy players competing in a fantasy soccer group have six of the fantasy players submit athlete, Lionel Messi for their lineup (i.e., a duplicated athlete), then those six fantasy players will evenly split however many fantasy points Messi scored in his game. In the case of multiple games, the six fantasy players would either split the average or split the total points. If Messi scored 14 fantasy points for his game, each fantasy player would receive 2.33 (rounded to nearest hundredth) fantasy points, because 14 divided by 6 equals 2.33.

This type of penalty creates a tremendous amount of strategy and elevates second tier players to the forefront. Fantasy players might opt to pass on superstars because lesser players have less of a chance of being duplicated. Sometimes these types of tournaments only have three to five starting positions to fill.

Group Tournament Type #4—Blind Submission Format—Lowering the Value of Duplicated Athletes—This is a variation of the previous format. This format variation is also an effective way to hold a tournament where lineups can only be submitted one time. This format is also played where all members competing in a group submit lineups using a blind submission format. Once again, duplication of athletes is permitted, but the penalty is different from the previous format described above. The penalty for duplication is the reduction of the fantasy points an athlete scores. The more duplication that occurs, the less they are worth. For example, in fantasy baseball, if a 12 person group has only one member (fantasy player) who submits athlete, Albert Pujols, the member might get 100% of the fantasy points corresponding to the submitted athlete. If two members of that group selected athlete, Pujols, each selecting member might get only 90% of the selected athlete's fantasy points. If three people selected the same athlete, each selecting member might get only 80% of the selected athlete's fantasy points, and so on. The point reductions can range from a completely arbitrary system of penalties all the way to a very well-calibrated method.

The table set forth below is an example of an embodiment that determines what percentage of an athlete's points a given fantasy participant receives based completely on how many other competitors also selected that athlete. It is important to note that the percentages listed are arbitrary. Any percentages can be used that penalize fantasy players the more duplication of athlete selection that occurs.

Percentage of Fantasy Points an Athlete is worth
Based on Duplication of a Given Athlete Selected

| | Athlete | | | | | | | | | | | |
|---|---|---|---|---|---|---|---|---|---|---|---|---|
| | selected | | | | | | | | | | | |
| | 1X* | 2X | 3X | 4X | 5X | 6X | 7X | 8X | 9X | 10X | 11X | 12X |
| 3 player | 100% | 50% | 0% | NA | NA | NA | NA | NA | NA | NA | NA | NA |
| fantasy | | | | | | | | | | | | |
| match | | | | | | | | | | | | |
| 4 player | 100% | 67% | 33% | 0% | NA | NA | NA | NA | NA | NA | NA | NA |
| fantasy | | | | | | | | | | | | |
| match | | | | | | | | | | | | |
| 5 player | 100% | 75% | 50% | 25% | 0% | NA | NA | NA | NA | NA | NA | NA |
| fantasy | | | | | | | | | | | | |
| match | | | | | | | | | | | | |
| 6 player | 100% | 80% | 60% | 40% | 20% | 0% | NA | NA | NA | NA | NA | NA |
| fantasy | | | | | | | | | | | | |
| match | | | | | | | | | | | | |
| 7 player | 100% | 83% | 67% | 50% | 33% | 17% | 0% | NA | NA | NA | NA | NA |
| fantasy | | | | | | | | | | | | |
| match | | | | | | | | | | | | |
| 8 player | 100% | 86% | 72% | 58% | 43% | 28% | 14% | 0% | NA | NA | NA | NA |
| fantasy | | | | | | | | | | | | |
| match | | | | | | | | | | | | |
| 9 player | 100% | 87% | 75% | 62% | 50% | 38% | 25% | 13% | 0% | NA | NA | NA |
| fantasy | | | | | | | | | | | | |
| match | | | | | | | | | | | | |
| 10 player | 100% | 89% | 78% | 67% | 56% | 45% | 34% | 23% | 12% | 0% | NA | NA |
| fantasy | | | | | | | | | | | | |
| match | | | | | | | | | | | | |
| 11 player | 100% | 90% | 80% | 70% | 60% | 50% | 40% | 30% | 20% | 10% | 0% | NA |
| fantasy | | | | | | | | | | | | |
| match | | | | | | | | | | | | |
| 12 player | 100% | 91% | 82% | 73% | 64% | 55% | 46% | 37% | 28% | 19% | 10% | 0% |
| fantasy | | | | | | | | | | | | |
| match | | | | | | | | | | | | |

*Note: 1X is read as “one time” which means a given athlete was selected by exactly 1 of the 12 fantasy players.

The highlighted (bolded and underlined) percentage shown in the table above represents a seven player fantasy group where five of the fantasy players selected the same athlete. For example, let's assume five of the seven players selected Michael Vick to be their starting quarterback for an upcoming match. What this means is that each of the five fantasy players will have Vick in their starting lineup, but they will each receive only 33% of the points Vick scores that week (round).

The table below is a hypothetical example from a fantasy football tournament and shows the starting NFL athletes that a 12 person group has selected. The percentage under each athlete's name represents the percentage that the fantasy player selecting that athlete will get to keep of the actual fantasy points that their selected NFL athlete scored for a particular week. This percentage is based on the number of times an NFL athlete was duplicated and is taken directly from the table above.

Percentage Values for Fantasy Points NFL Athletes Score
Group of 12 Fantasy Players Competing

| | QB | RB #1 | RB #2 | WR #1 | WR #2 |
|---|---|---|---|---|---|
| Fantasy | Vick | Gore | Peterson | Welker | Johnson |
| Player 1 | Phila | SF | Min | NE | Det |
| | 91% | 91% | 10% | 91% | 55% |
| Fantasy | Brady | Peterson | Mendenhall | Johnson | Bowe |
| Player 2 | NE | Min | Pitt | Det | KC |
| | 55% | 10% | 100% | 55% | 100% |
| Fantasy | Manning | Johnson | Peterson | Johnson | Welker |
| Player 3 | Indy | Ten | Min | Hou | NE |
| | 82% | 73% | 10% | 64% | 91% |
| Fantasy | Brady | Johnson | Peterson | Johnson | Austin |
| Player 4 | NE | Ten | Min | Det | Dal |
| | 55% | 73% | 10% | 55% | 100% |
| Fantasy | Brees | Peterson | Foster | White | Wallace |
| Player 5 | NO | Min | Hou | Atl | Pit |
| | 100% | 10% | 100% | 100% | 100% |
| Fantasy | Manning Indy | Jones-Drew | Peterson | Johnson | Jennings |
| Player 6 | 82% | Jax | Min | Hou | GB |
| | | 100% | 10% | 64% | 100% |
| Fantasy | Brady | Johnson | Peterson | Johnson | Johnson |
| Player 7 | NE | Ten | Min | Det | Hou |
| | 55% | 73% | 10% | 55% | 64% |
| Fantasy | Vick | Bradshaw | Peterson | Marshall | Johnson |
| Player 8 | Phila | NYG | Min | Mia | Hou |
| | 91% | 100% | 10% | 100% | 64% |
| Fantasy | Brady | Peterson | Gore | Johnson | Fitzgerald |
| Player 9 | NE | Min | SF | Det | Az |
| | 55% | 10% | 91% | 55% | 82% |
| Fantasy | Brady | Peterson | Turner | Johnson | Johnson |
| Player 10 | NE | Min | Atl | Det | Hou |
| | 55% | 10% | 100% | 55% | 64% |
| Fantasy | Brady | Johnson | Rice | Fitzgerald | Wayne |
| Player 11 | NE | Ten | Balt | Az | Indy |
| | 55% | 73% | 100% | 82% | 100% |
| Fantasy | Manning Indy | Jackson | Peterson | Jackson | Fitzgerald |
| Player 12 | 82% | STL | Min | Phil | Az |
| | | 100% | 10% | 100% | 82% |

Group Tournament Type #5—Blind Submission Format—Bidding for Athletes—This type of format is used over several days of bidding. Fantasy players in a group submit lineups along with a percentage next to the name of each athlete they submit. The percentage represents how small of a portion of an athlete's fantasy points they are willing to accept in order to secure that athlete for their lineup. In other words, a fantasy player is willing to give up some of the fantasy points a given athlete scores because they covet them so much. The fantasy player with the lowest bid wins that athlete. For example, if three fantasy players select athlete, Adrian Peterson to be their running back for a football tournament and the bids are 100%, 93% and 87%, then the fantasy player who bid 87% wins Peterson for their lineup. The catch is that the fantasy player who bid 87% would only get 87% of whatever Peterson's fantasy points are for a given game. The other two fantasy players not winning the athlete would have to submit a new athlete's name for this position during the next round of bidding. If two or more fantasy players submit the same winning bid for an athlete, each of the fantasy players would get that athlete in their lineup for the bid amount they presented. Once an athlete has been placed in at least one person's lineup in the group, the athlete cannot be bid on again by anyone for the match.

After the final round, a free agent draft is conducted using a computer generated drafting order. Only the fantasy players who don't have a complete lineup are eligible for the free agent draft. Fantasy players can only select one athlete when it is their turn in the free agent draft. If a fantasy player has multiple holes to fill in their lineup, the fantasy player must wait for their turn to select an athlete in the free agent draft process. Once a fantasy player has filled out their lineup from the free agent draft, they are automatically dropped from the draft. All athletes in the free agent draft are worth 100% of their fantasy points.

The tables below illustrate an example of a three day submission process for a fantasy baseball tournament. Each fantasy player has to submit a bid for five athletes (non-pitchers). There are no restrictions as to what position the athletes play.

Day 1 Submissions and Bids

| | Athlete #1 | Athlete #2 | Athlete #3 | Athlete #4 | Athlete #5 |
|---|---|---|---|---|---|
| Fantasy | Cabrera | Holliday | Pujols | ARod | Hamilton |
| Player 1 | Det | STL | STL | NYY | Tex |
| | 91% | 91% | 94% | 91% | 93% |
| Fantasy | Fielder | Pujols | Braun | Hamilton | Teixeira |
| Player 2 | Mil | STL | Mil | Tex | NYY |
| | 97% | 100% | 100% | 89% | 100% |
| Fantasy | Cano | Gonzalez | Pujols | Kemp | ARod |
| Player 3 | NYY | Bos | STL | LA | NYY |
| | 99% | 90% | 100% | 94% | 91% |
| Fantasy | Fielder | Gonzalez | Pujols | Hamilton | Reyes |
| Player 4 | Mil | Bos | STL | Tex | NYM |
| | 97% | 83% | 100% | 85% | 100% |
| Fantasy | Howard | Pujols | Reynolds | Tulowitzki | Young |
| Player 5 | Phil | STL | Balt | Col | Tex |
| | 100% | 100% | 100% | 100% | 100% |
| Fantasy | Cano | Pence | Pujols | Kemp | Votto |
| Player 6 | NYY | Phil | STL | LA | Cin |
| | 92% | 100% | 100% | 94% | 100% |
| Fantasy | Fielder | Gonzalez | Pujols | Hamilton | Kemp |
| Player 7 | Mil | Bos | STL | Tex | LA |
| | 95% | 93% | 98% | 95% | 97% |
| Fantasy | Cabrera | Granderson | Pujols | Beltran | Kemp |
| Player 8 | Det | NYY | STL | SF | LA |
| | 93% | 100% | 89% | 100% | 100% |
| Fantasy | Fielder | Pujols | Holliday | Hamilton | Beltre |
| Player 9 | Mil | STL | STL | Tex | Tex |
| | 95% | 94% | 97% | 96% | 92% |
| Fantasy | Fielder | Pujols | Ramirez | Hamilton | Kemp |
| Player 10 | Mil | STL | CHC | Tex | LA |
| | 95% | 100% | 100% | 97% | 92% |
| Fantasy | Fielder | Gonzalez | Pedroia | Beltre | Bautista |
| Player 11 | Mil | Bos | Bos | Tex | Tor |
| | 100% | 100% | 100% | 93% | 100% |
| Fantasy | Cano | Ortiz | Pujols | Konerko | Beltre |
| Player 12 | NYY | Bos | STL | CHW | Tex |
| | 99% | 100% | 100% | 100% | 99% |

In the example above, Bold text denotes a winning bid. Note, in the example above, two fantasy players secured athlete, AROD at 91% and three fantasy players secured athlete, Fielder at 95%.

Day 2 Submissions and Bids

| | Athlete #1 | Athlete #2 | Athlete #3 | Athlete #4 | Athlete #5 |
|---|---|---|---|---|---|
| Fantasy | Cabrera | Holliday | Ellsbury | ARod | Victorino |
| Player 1 | Det | STL | Bos | NYY | Phila |
| | 91% | 91% | 91% | 91% | 99% |
| Fantasy | C. Lee | Bruce | Braun | Ellsbury | Teixeira |
| Player 2 | Hou | Cin | Mil | Bos | NYY |
| | 100% | 100% | 100% | 99% | 100% |
| Fantasy | Longoria | Mauer | Utley | Suzuki | ARod |
| Player 3 | TB | Minn | Phil | Sea | NYY |
| | 99% | 98% | 100% | 100% | 91% |
| Fantasy | Phillips | Gonzalez | Longoria | Hamilton | Reyes |
| Player 4 | Cin | Bos | TB | Tex | NYM |
| | 100% | 83% | 98% | 85% | 100% |
| Fantasy | Howard | C. Jones | Reynolds | Tulowitzki | Young |
| Player 5 | Phil | Atl | Balt | Col | Tex |
| | 100% | 100% | 100% | 100% | 100% |
| Fantasy | Cano | Pence | Hardy | McCutchen | Votto |
| Player 6 | NYY | Phil | Balt | Pitt | Cin |
| | 92% | 100% | 100% | 100% | 100% |
| Fantasy | Fielder | Mauer | Willingham | Suzuki | C. Jones |
| Player 7 | Mil | Minn | Oak | Sea | Atl |
| | 95% | 98% | 100% | 99% | 100% |
| Fantasy | Upton | Granderson | Puiols | Beltran | Utley |
| Player 8 | TB | NYY | STL | SF | Phil |
| | 100% | 100% | 89% | 100% | 100% |
| Fantasy | Fielder | Willingham | Utley | Mauer | Beltre |
| Player 9 | Mil | Oak | Phil | Minn | Tex |
| | 95% | 98% | 97% | 99% | 92% |
| Fantasy | Fielder | Longoria | Ramirez | Phillips | Kemp |
| Player 10 | Mil | TB | CHC | Cin | LA |
| | 95% | 100% | 100% | 97% | 92% |
| Fantasy | Swisher | Uggla | Pedroia | Hardy | Bautista |
| Player 11 | NYY | Atl | Bos | Balt | Tor |
| | 100% | 100% | 100% | 93% | 100% |
| Fantasy | Swisher | Ortiz | Crawford | Konerko | Stanton |
| Player 12 | NYY | Bos | Bos | CHW | Mia |
| | 99% | 100% | 100% | 100% | 100% |

In the example above, Bold text denotes a winning bid. Underlined text denotes an athlete previously secured with a value indicating the percentage the athlete is worth. Note, in the example above, two fantasy players secured athlete, C. Jones at 100% and athlete, Mauer of Minnesota at 98%.

Day 3 Submissions and Bids

| | Athlete #1 | Athlete #2 | Athlete #3 | Athlete #4 | Athlete #5 |
|---|---|---|---|---|---|
| Fantasy | Cabrera | Holliday | Ellsbury | ARod | Victorino |
| Player 1 | Det | STL | Bos | NYY | Phil |
| | 91% | 91% | 91% | 91% | 99% |
| Fantasy | C. Lee | Bruce | Braun | Sandoval | Teixeira |
| Player 2 | Hou | Cin | Mil | SF | NYY |
| | 100% | 100% | 100% | 99% | 100% |
| Fantasy | Upton | Mauer | Gordon | Quentin | ARod |
| Player 3 | Ariz | Minn | KC | CHW | NYY |
| | 100% | 98% | 100% | 100% | 91% |
| Fantasy | Trumbo | Gonzalez | Longoria | Hamilton | Reyes |
| Player 4 | LAA | Bos | TB | Tex | NYM |
| | 100% | 83% | 98% | 85% | 100% |
| Fantasy | Howard | C. Jones | Reynolds | Tulowitzki | Young |
| Player 5 | Phil | Atl | Balt | Col | Tex |
| | 100% | 100% | 100% | 100% | 100% |
| Fantasy | Cano | Pence | Upton | McCutchen | Votto |
| Player 6 | NYY | Phil | Ariz | Pitt | Cin |
| | 92% | 100% | 99% | 100% | 100% |
| Fantasy | Fielder | Mauer | Sandoval | Suzuki | C. Jones |
| Player 7 | Mil | Minn | SF | Sea | Atl |
| | 95% | 98% | 100% | 99% | 100% |
| Fantasy | Upton | Granderson | Pujols | Beltran | Trumbo |
| Player 8 | TB | NYY | STL | SF | LAA |
| | 100% | 100% | 89% | 100% | 98% |
| Fantasy | Fielder | Willingham | Utley | Morse | Beltre |
| Player 9 | Mil | Oak | Phil | Wash | Tex |
| | 95% | 98% | 97% | 99% | 92% |
| Fantasy | Fielder | Upton | Ramirez | Phillips | Kemp |
| Player | Mil | Ariz | CHC | Cin | LA |
| 10 | 95% | 100% | 100% | 97% | 92% |
| Fantasy | Sandoval | Uggla | Pedroia | Hardy | Bautista |
| Player | SF | Atl | Bos | Balt | Tor |
| 11 | 100% | 100% | 100% | 93% | 100% |
| Fantasy | Swisher | Ortiz | Crawford | Konerko | Stanton |
| Player | NYY | Bos | Bos | CHW | Mia |
| 12 | 99% | 100% | 100% | 100% | 100% |

In the example above, Bold text denotes a winning bid. Underlined text denotes an athlete previously secured with a value indicating the percentage the athlete is worth.

Final Rosters Before Free Agent Draft

| | Athlete #1 | Athlete #2 | Athlete #3 | Athlete #4 | Athlete #5 |
|---|---|---|---|---|---|
| Fantasy | Cabrera | Holliday | Ellsbury | ARod | Victorino |
| Player 1 | Det | STL | Bos | NYY | Phil |
| | 91% | 91% | 91% | 91% | 99% |
| Fantasy | C. Lee | Bruce | Braun | Sandoval | Teixeira |
| Player 2 | Hou | Cin | Mil | SF | NYY |
| | 100% | 100% | 100% | 99% | 100% |
| Fantasy | Open | Mauer | Gordon | Quentin | ARod |
| Player 3 | Spot | Minn | KC | CHW | NYY |
| | | 98% | 100% | 100% | 91% |
| Fantasy | Open | Gonzalez | Longoria | Hamilton | Reyes |
| Player 4 | Spot | Bos | TB | Tex | NYM |
| | | 83% | 98% | 85% | 100% |
| Fantasy | Howard | C. Jones | Reynolds | Tulowitzki | Young |
| Player 5 | Phil | Atl | Balt | Col | Tex |
| | 100% | 100% | 100% | 100% | 100% |
| Fantasy | Cano | Pence | Upton | McCutchen | Votto |
| Player 6 | NYY | Phil | Ariz | Pitt | Cin |
| | 92% | 100% | 99% | 100% | 100% |
| Fantasy | Fielder | Mauer | Open | Suzuki | C. Jones |
| Player 7 | Mil | Minn | Spot | Sea | Atl |
| | 95% | 98% | | 99% | 100% |
| Fantasy | Upton | Granderson | Pujols | Beltran | Trumbo |
| Player 8 | TB | NYY | STL | SF | LAA |
| | 100% | 100% | 89% | 100% | 98% |
| Fantasy | Fielder | Willingham | Utley | Morse | Beltre |
| Player 9 | Mil | Oak | Phil | Wash | Tex |
| | 95% | 98% | 97% | 99% | 92% |
| Fantasy | Fielder | Open | Ramirez | Phillips | Kemp |
| Player | Mil | Spot | CHC | Cin | LA |
| 10 | 95% | | 100% | 97% | 92% |
| Fantasy | Open | Uggla | Pedroia | Hardy | Bautista |
| Player | Spot | Atl | Bos | Balt | Tor |
| 11 | | 100% | 100% | 93% | 100% |
| Fantasy | Swisher | Ortiz | Crawford | Konerko | Stanton |
| Player | NYY | Bos | Bos | CHW | Mia |
| 12 | 99% | 100% | 100% | 100% | 100% |

In the example above, fantasy players #3, #4, #7, #10 and #11 (e.g., fantasy players with openings to fill) would then participate in a free agent fantasy draft until all their openings (in this case each has one) are filled. The fantasy players in the free agent fantasy draft can select any baseball athlete (non-pitcher) that has not been selected by someone in the group. These free agents will each be worth 100% of their fantasy points.

Group Tournament Type #6—Blind Submission Format—Using a Cap—This type of tournament can be done on a one shot basis, but is best used over multiple rounds of submissions. Fantasy players are allocated a certain number of credits for a blind submission process to fill in their lineups. The fantasy player that bids the highest for a given athlete earns the right to have the athlete in their lineup, while all the other members of the group lose the opportunity to play this athlete. Once the last round of submissions has passed, a free agent draft will be conducted for any fantasy player who still has lineup slots to fill. The free agent draft is for athletes who haven't been selected by anyone in the group.

A fantasy player may use all of their credits before the selection process has finished. If they happen to do this and they still have positions to fill, the fantasy player must wait until the free agent draft, which begins at the end of the last round of submissions. Also, if two or more fantasy players submit an identical bid and it turns out to be the highest one for a given athlete, each of them will enter this athlete into their lineups at the fantasy value they each submitted.

The tables below illustrate an example of a progression of an NBA fantasy basketball tournament. In this example, there are 12 fantasy players participating in the group. Each of them starts with 50 credits to fill 5 lineup positions. In this hypothetical tournament, the actual positions the NBA athletes play are irrelevant. A fantasy player can fill all the positions with forwards if they wish. Also, there is no requirement forcing a fantasy player to bid on all slots. If s/he chooses, a fantasy player can strategically bid high for a couple of superstars and then rely on the free agent draft to fill their remaining roster slots.

Round 1 - NBA Athletes Submitted

| | Athlete #1 | Athlete #2 | Athlete #3 | Athlete #4 | Athlete #5 |
|---|---|---|---|---|---|
| Fantasy | James | Bryant | Howard | Paul | Griffin |
| Player 1 | Miami | LAL | Orlando | LAC | LAC |
| 50 Credits Avail | 7 Credits bid | 10 Credits bid | 17 Credits bid | 6 Credits bid | 10 Credits bid |
| Fantasy | Wade | Duncan | Stoudemire | Anthony | James |
| Player 2 | Miami | S.A. | NY | NY | Miami |
| 50 Credits Avail | 13 Credits bid | 3 Credits bid | 8 Credits bid | 5 Credits bid | 21 Credits bid |
| Fantasy | Rose | James | Johnson | Ellis | Bryant |
| Player 3 | Chi | Mia | Atl | GS | LAL |
| 50 Credits Avail | 16 Credits bid | 22 Credits bid | 1 Credit bid | 2 Credits bid | 9 Credits bid |
| Fantasy | James | Bryant | No Bid | No Bid | No Bid |
| Player 4 | Mia | LAL | | | |
| 50 Credits Avail | 25 Credits bid | 25 Credits bid | | | |
| Fantasy | Griffin | Howard | Durant | Anthony | Williams |
| Player 5 | LAC | Orlando | OKC | NY | NJ |
| 50 Credits Avail | 10 Credits bid | 10 Credits bid | 10 Credits bid | 10 Credits bid | 10 Credits bid |
| Fantasy | Durant | Nowitski | Aldridge | Love | Wade |
| Player 6 | OKC | Dallas | Port | Min | Mia |
| 50 Credits Avail | 15 Credits bid | 10 Credits bid | 7 Credits bid | 8 Credits bid | 10 Credits bid |
| Fantasy | Durant | James | Nowitski | No Bid | No Bid |
| Player 7 | OKC | Mia | Dallas | | |
| 50 Credits Avail | 17 Credits bid | 17 Credits bid | 16 Credits bid | | |
| Fantasy | James | Ellis | Parker | Gasol | Randolph |
| Player 8 | Mia | GS | SA | LAL | Memphis |
| 50 Credits Avail | 40 Credits bid | 3 Credits bid | 3 Credits bid | 2 Credits bid | 2 Credits bid |
| Fantasy | Wade | Howard | Bryant | Nash | Curry |
| Player 9 | Mia | Orl | LAL | Phoenix | GS |
| 50 Credits Avail | 15 Credits bid | 15 Credits bid | 15 Credits bid | 3 Credits bid | 2 Credits bid |
| Fantasy | Bryant | Rose | Wade | No Bid | No Bid |
| Player 10 | LAL | Chi | Mia | | |
| 50 Credits Avail | 15 Credits bid | 18 Credits bid | 17 Credits bid | | |
| Fantasy | Rose | Durant | No Bid | No Bid | No Bid |
| Player 11 | Chi | OKC | | | |
| 50 Credits Avail | 23 Credits bid | 27 Credits bid | | | |
| Fantasy | Durant | James | No Bid | No Bid | No Bid |
| Player 12 | OKC | Miami | | | |
| 50 Credits Avail | 25 Credits bid | 25 Credits bid | | | |

In the example above, Bold text denotes a winning bid. Note that fantasy players can bid any or all of their credits for any given round of submissions. In the example above, athlete, Griffin was secured by players #1 and #5.

Round 2 - NBA Athletes Submitted

| | Athlete #1 | Athlete #2 | Athlete #3 | Athlete #4 | Athlete #5 |
|---|---|---|---|---|---|
| Fantasy | Howard | Paul | Griffin | Bynum | Rondo |
| Player 1 | Orlando | LAC | LAC | LAL | Bos |
| 17 Credits Avail | | | | 12 Credits bid | 5 Credits bid |
| Fantasy | Duncan | Stoudemire | Jennings | Ginobili | Bosh |
| Player 2 | S.A. | NY | Mil | SA | Miami |
| 39 Credits Avail | | | 8 Credits bid | 17 Credits bid | 14 Credits bid |
| Fantasy | Johnson | Bosh | Pierce | Rondo | Granger |
| Player 3 | Atl | Mia | Bos | Bos | Ind |
| 49 Credits Avail | | 25 Credits bid | 15 Credits bid | 6 Credits bid | 3 Credits bid |
| Fantasy | Bryant | Garnett | Evans | Martin | Pierce |
| Player 4 | LAL | Bos | Sac | Hou | Bos |
| 25 Credits Avail | | 7 Credits bid | 1 Credit bid | 2 Credits bid | 15 Credits bid |
| Fantasy | Griffin | Anthony | Williams | Westbrook | Bosh |
| Player 5 | LAC | NY | NJ | OKC | Mia |
| 20 Credits Avail | | | | 5 Credits bid | 15 Credits bid |
| Fantasy | Aldridge | Love | Jefferson | Bosh | Pierce |
| Player 6 | Port | Min | Utah | Mia | Bos |
| 35 Credits Avail | | | 2 Credits bid | 25 Credits bid | 8 Credits bid |
| Fantasy | Nowitski | Wall | Bosh | Boozer | Pierce |
| Player 7 | Dallas | Wash | Miami | Chi | Bos |
| 34 Credits Avail | | 2 Credits bid | 20 Credits bid | 5 Credits bid | 7 Credits bid |
| Fantasy | James | Ellis | Parker | Gasol | Randolph |
| Player 8 | Mia | GS | SA | LAL | Memphis |
| 0 Credits Avail | | | | | |
| Fantasy | Nash | Curry | Bosh | Rondo | No Bid |
| Player 9 | Phoenix | GS | Mia | Bos | |
| 45 Credits Avail | | | 30 Credits bid | 15 Credits bid | |
| Fantasy | Wade | Rondo | Bosh | No Bid | No Bid |
| Player 10 | Mia | Bos | Mia | | |
| 33 Credits Avail | | 17 Credits bid | 16 Credits bid | | |
| Fantasy | Rose | Durant | Not eligible to bid | Not eligible to | Not eligible to bid |
| Player 11 | Chi | OKC | | bid | |
| 0 Credits Avail | | | | | |
| Fantasy | Bosh | Rondo | Pierce | No Bid | No Bid |
| Player 12 | Mia | Bos | Bos | | |
| 50 Credits Avail | 17 Credits bid | 17 Credits bid | 16 Credits bid | | |

In the example above, Bold text denotes a winning bid. Underlined text denotes an athlete previously secured. In the example above, athlete, Rondo was secured by both fantasy player #10 and #12.

Round 3 - NBA Athletes Submitted

| | Athlete #1 | Athlete #2 | Athlete #3 | Athlete #4 | Athlete #5 |
|---|---|---|---|---|---|
| Fantasy | Howard | Paul | Griffin | Bynum | Allen |
| Player 1 | Orlando | LAC | LAC | LAL | Bos |
| 5 Credits Avail | | | | | 5 Credits bid |
| Fantasy | Duncan | Stoudemire | Jennings | Ginobili | Lawson |
| Player 2 | SA | NY | Mil | SA | Den |
| 14 Credits Avail | | | | | 14 Credits bid |
| Fantasy | Johnson | Granger | Thornton | Allen | Wallace |
| Player 3 | Atl | Ind | Sac | Bos | Port |
| 46 Credits Avail | | | 12 Credits bid | 20 Credits bid | 14 Credits bid |
| Fantasy | Bryant | Garnett | Evans | Martin | Allen |
| Player 4 | LAL | Bos | Sac | Hou | Bos |
| 15 Credits Avail | | | | | 15 Credits bid |
| Fantasy | Griffin | Anthony | Williams | Westbrook | Anderson |
| Player 5 | LAC | NY | NJ | OKC | Orl |
| 15 Credits Avail | | | | | 15 Credits bid |
| Fantasy | Aldridge | Love | Jefferson | Deng | Lee |
| Player 6 | Port | Min | Utah | Chi | GS |
| 33 Credits Avail | | | | 15 Credits bid | 18 Credits bid |
| Fantasy | Nowitski | Wall | Boozer | Gasol | Allen |
| Player 7 | Dallas | Wash | Chi | Memphis | Bos |
| 27 Credits Avail | | | | 12 Credits bid | 15 Credits bid |
| Fantasy | James | Ellis | Parker | Gasol | Randolph |
| Player 8 | Mia | GS | SA | LAL | Memphis |
| 0 Credits Avail | | | | | |
| Fantasy | Nash | Curry | Bosh | Allen | Hibbert |
| Player 9 | Phoenix | GS | Mia | Bos | Ind |
| 15 Credits Avail | | | | 14 Credits bid | 1 Credit bid |
| Fantasy | Wade | Rondo | Lowry | Wallace | Thornton |
| Player 10 | Mia | Bos | Hou | Port | Sac |
| 16 Credits Avail | | | 2 Credits bid | 13 Credits bid | 1 Credit bid |
| Fantasy | Rose | Durant | Not eligible to bid | Not eligible to | Not eligible to bid |
| Player 11 | Chi | OKC | | bid | |
| 0 Credits Avail | | | | | |
| Fantasy | Pierce | Rondo | Allen | No Bid | No Bid |
| Player 12 | Bos | Bos | Bos | | |
| 17 Credits Avail | | | 17 Credits bid | | |

In the example above, Bold text denotes a winning bid. Underlined text denotes an athlete previously secured.

Final Rosters - Free Agents to be Determined

| | Athlete #1 | Athlete #2 | Athlete #3 | Athlete #4 | Athlete #5 |
|---|---|---|---|---|---|
| Fantasy | Howard | Paul | Griffin | Bynum | Open |
| Player 1 | Orlando | LAC | LAC | LAL | |
| Fantasy | Duncan | Stoudemire | Jennings | Ginobili | Lawson |
| Player 2 | SA | NY | Mil | SA | Den |
| Fantasy | Johnson | Granger | Thornton | Allen | Wallace |
| Player 3 | Atl | Ind | Sac | Bos | Port |
| Fantasy | Bryant | Garnett | Evans | Martin | Open |
| Player 4 | LAL | Bos | Sac | Hou | |
| Fantasy | Griffin | Anthony | Williams | Westbrook | Anderson |
| Player 5 | LAC | NY | NJ | OKC | Orl |
| Fantasy | Aldridge | Love | Jefferson | Deng | Lee |
| Player 6 | Port | Min | Utah | Chi | GS |
| Fantasy | Nowitski | Wall | Boozer | Gasol | Open |
| Player 7 | Dallas | Wash | Chi | Memphis | |
| Fantasy | James | Ellis | Parker | Gasol | Randolph |
| Player 8 | Mia | GS | SA | LAL | Memphis |
| Fantasy | Nash | Curry | Bosh | Hibbert | Open |
| Player 9 | Phoenix | GS | Mia | Ind | |
| Fantasy | Wade | Rondo | Lowry | Open | Open |
| Player 10 | Mia | Bos | Hou | | |
| Fantasy | Rose | Durant | Open | Open | Open |
| Player 11 | Chi | OKC | | | |
| Fantasy | Pierce | Rondo | Open | Open | Open |
| Player 12 | Bos | Bos | | | |

In the example above, fantasy players #1, #4, #7, #9, #10, #11 and #12 would then participate in a free agent fantasy draft until each fills all of their openings. A fantasy player gets one selection per round. Once a given fantasy player has all their slots filled, they are automatically dropped from the free agent draft.

Group Tournament Type #7—Blind Submission Format—Meeting a Minimum Threshold—In an example embodiment, this format might appear to be a Lottery Effect format, but it is not. This type of group tournament acts the same way that small group Holy Grail tournaments do even though everyone competes against each other simultaneously. This is a bona fide Holy Grail tournament even though it does not have fantasy players competing in small groups. This can be accomplished by setting up a minimum threshold tournament.

A minimum threshold tournament recognizes that more than 50% of the contestants need to be eliminated at each round. This is because the one-on-one match play format eliminates half the contestants each week. But this has already proven to be ineffective for a tournament that attracts the masses. On the other hand, a minimum threshold tournament must be more forgiving than having everyone compete at the same time with one person left standing. This format is virtually a 100% certainty that a random player loses. The way to fix this problem is to hone in on a percentage somewhere between the 50% and 100% extremes that are incompatible with holding a successful Holy Grail tournament. This type of strategy generates the same small group dynamic that is so conducive to creating a dynamic Holy Grail tournament.

The format for the tournament is relatively simple. Fantasy players have to meet a minimum performance threshold between 50% and 100% each round. Let's arbitrarily pick 70%. What this means is that all fantasy players have to beat 70% of the field for a given week to advance to the next round. Fantasy players have to submit a lineup each round and there is no penalty for duplication, because millions of people can be playing each other simultaneously. Once the field narrows, duplication penalties can be utilized.

A key difference between this format and the flawed models that are currently available is that this format gives fantasy players hope. Instead of having to emerge as the top person out of a group of millions of people, one only has to finish in the top thirty or forty percent to advance. Fantasy players will gravitate towards this because it is a tournament of skill and most players believe they have what it takes to finish in the top 30% or whatever the pre-determined number is. Once this is method is used for 8 to 12 rounds, it becomes possible to whittle millions of entries down to a manageable level so that it is possible to conduct one-on-one match play events for the remaining rounds to determine an overall winner.

This type of tournament, like all the tournament formats described above, can be used for any fantasy sport. To illustrate how this type of tournament works, consider a particular sample tournament where there are 50 million entries and the pre-determined tournament rules specify the use of a 30% rule for the first 12 weeks of an NFL football season. For weeks 13 through 17 of the NFL season, the tournament concludes with one-on-one match play. An example of the numbers of fantasy players advancing at the end of each week in the sample tournament are shown below.

30% Rule Format—Weeks 1 Through 12

Week 1—50 million entries with 15 million advancing

Week 2—15 million winners with 4,500,000 advancing

Week 3—4,500,000 winners with 1,350,000 advancing

Week 4—1,350,000 winners with 405,000 advancing

Week 5—405,000 winners with 121,500 advancing

Week 6—121,500 winners with 36,450 advancing

Week 7—36,450 winners with 10,935 advancing

Week 8—10,935 winners with 3,281 advancing

Week 9—3,281 winners with 985 advancing

Week 10—985 winners with 296 advancing

Week 11—296 winners with 86 advancing

Week 12—86 winners with 27 advancing

One-on-One Match Play Format—Weeks 13 Through 17

Week 13—27 winners with 16 advancing (note: 5 players received byes)

Week 14—16 winners with 8 advancing

Week 15—8 winners with 4 advancing

Week 16—4 winners with 2 advancing

Week 17—2 winners playing for the championship

The submission process for the one-on-one match play format is different than the first 12 weeks where lineups are simply turned in and fantasy players have to finish in the top 30%. For the one-on-one match play phase, which begins week 13, there could be a three round (it could be a different number of rounds) submission process. An example of this submission process is set forth below.

Round 1—Lineups are compared. If a given position has a different athlete submitted, the two competitors (fantasy players) lock in this athlete into their starting lineups. If a given position has the same athlete submitted, this athlete is disqualified from the match and cannot be resubmitted by either fantasy player. All open slots will be resubmitted the next round.

Round 2—Same rules and processes as Round 1 as described above.

Round 3—All open slots require two submissions by each fantasy player. One submission is the intended starting athlete and the other is a backup athlete. The intended starter athlete must also have a percentage value associated with the starter athlete. This percentage represents the percentage of fantasy points a fantasy player is willing to deduct from a given athlete's fantasy score to get the athlete in their lineup. This only comes into play if both fantasy players submit the same athlete for an open position. If the submitted athletes are different, then each fantasy player will lock them in at 100%. If, however, the submitted athletes are the same, the bids will be compared. The fantasy player with the lower percentage bid gets that athlete at the percentage they bid. That fantasy player secures that athlete for their lineup, but it comes with a penalty. The fantasy player only receives the percentage of fantasy points they bid for the match while their opponent gets their backup athlete they submitted for this position at 100% of their fantasy point total. If the percentage bid is the same, both fantasy players will lock in their backup athletes in at 100%. If their backups are the same athlete, they will each get the backup athlete at 100%, which effectively cancels each other out for this position.

One-on-One Match Play Tournament Type #8—Blind Submission Format—Valuing slots at different percentages—There are some techniques that are also quite effective for matches that involve two players. The following example allows for duplication and is especially effective when there are a limited number of athletes from which to choose.

In the example presented below, assume that it is one of the Main Event rounds of a soccer fantasy tournament and fantasy players are competing head-to-head. Fantasy players have been paired off in these matches with each slot having a different value. The percentages below represent the percentage of fantasy points a fantasy player will be given of their selected athlete's fantasy points scored. It should be noted that these percentages are just an example and they can be of any value that a tournament organizer sees fit.

Hypothetical Main Event Soccer Match
Submitted Lineups and Slots

| | | Slotted | Slotted | | | | Slotted | |
|---|---|---|---|---|---|---|---|---|
| | Slotted #1 | #2 | #3 | Slotted #4 | Slotted #5 | Slotted #6 | #7 | Slotted #8 |
| | 100% | 87.5% | 75% | 62.5% | 50% | 37.5% | 25% | 12.5% |
| Fantasy | Messi | Ronaldo | Rooney | Sturridge | Milito | Huntelaar | Higuain | Lampard |
| Player | Barcelona | Real | Man U | Chelsea | Internazionale | Schalke | Real | Chelsea |
| #1 | | Madrid | | | | 04 | Madrid | |
| Fantasy | Messi | Rooney | Ronaldo | Huntelaar | Adebayor | Lampard | Raul | Sturridge |
| Player | Barcelona | Man U | Real | Schalke | Tottenham | Chelsea | Schalke | Chelsea |
| #2 | | | Madrid | 04 | | | 04 | |

The percentage indicates the portion of fantasy points a given athlete scored that will be given to the corresponding fantasy player.

Hypothetical Fantasy Points that Athletes Scored
Fantasy Player #1 vs. Fantasy Player #2 Match

| | | Fantasy | | |
|---|---|---|---|---|
| | | Points | Fantasy Player | Fantasy Player |
| Athlete | Team | Scored | #1's Score | #2's Score |
| Messi | Barcelona | 12 | 12 × 1.0 = 12.00 | 12 × 1.0 = 12.00 |
| Rooney | Manchester | 10 | 10 × .75 = 7.50 | 10 × .875 = 8.75 |
| | U. | | | |
| Ronaldo | Real Madrid | 15 | 15 × .875 = 13.13 | 15 × .75 = 11.25 |
| Sturridge | Chelsea | 7 | 7 × .625 = 4.38 | 7 × .125 = 0.88 |
| Huntelaar | Schalke 04 | 9 | 9 × .375 = 3.38 | 9 × .625 = 5.63 |
| Milito | Inter- | 10 | 10 × .50 = 5.00 | N/A |
| | nazionale | | | |
| Lampard | Chelsea | 5 | 5 × .125 = 0.63 | 5 × .375 = 1.88 |
| Adebayor | Tottenham | 4 | N/A | 4 × .50 = 2.00 |
| Higuain | Real Madrid | 7 | 7 × .25 = 1.75 | N/A |
| Raul | Schalke 04 | 8 | N/A | 8 × .25 = 2.00 |

Hypothetical Main Event Soccer Match Final Score

| | Slotted | Slotted | Slotted | Slotted | | | | Slotted | |
|---|---|---|---|---|---|---|---|---|---|
| | #1 | #2 | #3 | #4 | Slotted #5 | Slotted #6 | Slotted #7 | #8 | Final |
| | 100% | 87.5% | 75% | 62.5% | 50% | 37.5% | 25% | 12.5% | Score |
| Fantasy | Messi | Ronaldo | Rooney | Sturridge | Milito | Huntelaar | Higuain | Lampard | 47.77 |
| Player | Barcelona | Real | Man U | Chelsea | Internazionale | Schalke | Real | Chelsea | |
| #1 | 12.00 | Madrid | 7.50 | 4.38 | 5.00 | 04 | Madrid | 0.63 | |
| | | 13.13 | | | | 3.38 | 1.75 | | |
| Fantasy | Messi | Rooney | Ronaldo | Huntelaar | Adebayor | Lampard | Raul | Sturridge | 44.39 |
| Player | Barcelona | Man U | Real | Schalke | Tottenham | Chelsea | Schalke | Chelsea | |
| #2 | 12.00 | 8.75 | Madrid | 04 | 2.00 | 1.88 | 04 | 0.88 | |
| | | | 11.25 | 5.63 | | | 2.00 | | |

In the example above, underlined values are Adjusted Fantasy Point values. In the example above, fantasy Player #1 would move on in the tournament based on a 47.77 to 44.39 victory over Fantasy Player #2.

One-on-one Match Play Tournament Type #9—Blind Submission Format—Disqualifying athletes that are duplicated—This format of an example embodiment can be used over two or more rounds of fantasy players submitting athletes. An example of this type of tournament is illustrated in the hypothetical presented below. This example is from a football tournament.

In this example, fantasy players submit six starter athletes for various positions on the fantasy football team—one quarterback (QB), two running backs (RB's), two wide receivers (WR's), and 1 Flex position (e.g., a RB or WR). Fantasy players also submit four tiebreakers, which are used only to break ties. In this example, these four tiebreakers include: 1) one tight end (TE) that represents the 1^{st} tiebreaker; 2) one defensive position that represents the 2^{nd} tiebreaker; 3) one kicker that represents the 3^{rd} tiebreaker; and 4) the 4^{th} tiebreaker can be represented as one tiebreaker NFL football team playing that week. Point differentials in the score of the game played by the tiebreaker NFL football team that week determine the fantasy value for the 4^{th} tiebreaker (e.g., a 27-21 victory is a +6, conversely, a 28-3 loss is a −25). A 5^{th} tiebreaker can be represented as a computer generated coin flip produced by a random number generator.

Lineups are submitted over a three day period (e.g., Wednesday, Thursday, and Friday by 8:00 PM EST for each day—could be a greater or lesser number of days, the number is arbitrary). All NFL athletes are eligible as long as they haven't been disqualified or already played in their game for the week.

On the first day of the lineup submission period (e.g., Wednesday), both fantasy players must have their lineups submitted. If both fail to do so, a new deadline is set for the next day at, for example, 5:00 PM EST. If only one fantasy player has their lineup submitted, the one fantasy player locks in all six of their starters in their starting lineup and all four tiebreakers into their tiebreaker lineup. Their opponent has until the last day of the lineup submission period (e.g., Friday night at 5:00 PM EST) to enter a lineup of six starting athletes and four tiebreaker athletes or the opponent forfeits the match. Once a starting athlete or tiebreaker position has been filled, the opposing fantasy player cannot select the same NFL athlete or team that has already been locked in.

If both fantasy players submit their lineups within the lineup submission period, the lineups are compared athlete-by-athlete. If any athlete or team is duplicated, the athlete or team is immediately disqualified from the match and cannot be resubmitted again by either fantasy player. This disqualification includes a scenario wherein, for example, an NFL athlete is submitted by one fantasy player as a running back and their opponent submitted the same athlete as a flex player, or other different position. All other starting athletes and tiebreaker athletes who aren't duplications are locked into the starting and tiebreaker slots for the respective fantasy players. The defense category and team category are not considered a duplication if the same NFL team is submitted in these two different categories. Duplicated athletes will leave open slots that will be resubmitted the next day.

On the second day of the lineup submission period (e.g., Thursday), if there are still open positions, both fantasy players will be expected to turn in a lineup for the slots in their lineups that haven't been filled. If only one fantasy player turns in their lineup, the athletes submitted by the one fantasy player are immediately locked in and their opponent has until the next day to fill in these open slots. Once a starting athlete or tiebreaker position has been filled, the opponent cannot select the same NFL athlete or team that has already been locked in. In other respects, the same rules apply as the previous day. Duplicated athletes and tiebreakers are disqualified and can't be resubmitted again. Non-duplicated athletes/teams are locked in. If there are any remaining openings, there is one final day for submissions.

On the third day of the lineup submission period (e.g., Friday), if both fantasy players fail to submit a lineup during the entire three day period, a double forfeit is declared and both fantasy players are eliminated from the tournament. If one player never submitted a lineup during any of the days and their opponent did, then the fantasy player who turned in a lineup wins by forfeit and moves on to the next round. If one or both fantasy players submitted lineups at some point, but one or both don't have complete lineups, the fantasy players will compete against one another with “open” slots that receive zero points for every slot in their respective starting and tiebreaker lineups where this happens. If both fantasy players submit athletes for open slots on this final day of the lineup submission period, both fantasy players will submit two options for each open slot. There will be a primary and a backup option. If the primary options are different athletes for a given position, the athletes submitted as primary options will be locked into their respective lineups. If the athletes submitted as primary options are the same athlete or team, then a bidding number that was submitted ahead of time will be checked. Fantasy players can submit a bidding number or bid from 1% to 100%. A bid of 93% means that a fantasy player covets that NFL athlete enough that they are willing to receive only 93% of the fantasy points this NFL athlete scores. At the same time, their opponent will automatically get 100% of their backup options fantasy value to lose this athlete that they also coveted. Because both fantasy players are submitting a bid, the fantasy player that makes the lowest percentage bid gets that NFL athlete for the week (round). Once again, the losing bidder gets their backup athlete for 100% of their fantasy point value. If however, the bids happen to be the same, then the equality of the bids disqualifies this NFL athlete from the match. The backup athlete names are then compared. If the backup athlete names are different, they are locked in. If the backup athlete names are the same, both fantasy players will play the match with an open slot for this position that will be scored as a zero.

Explanation #3—Creating staggered qualifying tournaments of the same or different lengths that feed into a Main Tournament—A single elimination tournament can be very discouraging for people who get eliminated in the first round. The “staggered qualifying” feature allows rabid fantasy players multiple avenues to remain in and possibly win the tournament. This type of format can be used for virtually any type of sporting event that lasts at least five days. The important features of the staggered qualifying tournaments are described below.

In an example embodiment, there are two stages to the tournament structure. There are several qualifying tournaments and there is a main tournament. Fantasy players can submit multiple entries for any qualifying tournament. Fantasy players can sign up for different qualifying tournaments at the same time. The main tournament has a predetermined number of seats available that fantasy players can either try to qualify for or directly buy their way into. The qualifying tournaments may or may not have different amounts of rounds in them. New qualifying tournaments can start at any time. There is no set time period that must elapse. The more rounds a qualifying tournament has, the less expensive the rounds are to play in. Fantasy players who are eliminated can re-enter because a new qualifying tournament will be starting soon.

These qualifying tournaments have the following features in an example embodiment. The qualifying tournaments are separate and distinct tournaments from one another. The qualifying tournaments don't always have the same number of rounds (although there is no reason why they can't). Some qualifying tournaments are often running at the same time as other qualifying tournaments. The qualifying tournaments are staggered over a portion of the season in a way where the qualifying tournaments sometimes overlap each other completely, sometimes partially, and sometimes not at all.

In an example of the qualifying tournament structure used in an embodiment using the 2012 NFL season as an illustration, we can randomly set up nine qualifying tournaments that each have a different number of rounds. The nine qualifying tournaments can be set up such that they are staggered in time. Fantasy players are placed in groups of 12 for each round with the top three fantasy players advancing. In the example illustrated below, the nine qualifying tournaments are staggered in a way where the tournaments become increasingly shorter. Alternatively, the qualifying tournaments can be staggered by making them increasingly longer. The data for each of the nine qualifying tournaments in the example are set forth below.

| Qualifier #1 | Qualifier #2 | Qualifier #3 |
|---|---|---|
| Round 1 - Sept 9 | Round 1 - Sept 16 | Round 1 - Sept 23 |
| Round 2 - Sept 16 | Round 2 - Sept 23 | Round 2 - Sept 30 |
| Round 3 - Sept 23 | Round 3 - Sept 30 | Round 3 - Oct 7 |
| Round 4 - Sept 30 | Round 4 - Oct 7 | Round 4 - Oct 14 |
| Round 5 - Oct 7 | Round 5 - Oct 14 | Round 5 - Oct 21 |
| Round 6 - Oct 14 | Round 6 - Oct 21 | Round 6 - Oct 28 |
| Round 7 - Oct 21 | Round 7 - Oct 28 | Round 7 - Nov 4 |
| Round 8 - Oct 28 | Round 8 - Nov 4 | |
| Round 9 - Nov 4 | | |
| Qualifier #4 | Qualifier #5 | Qualifier #6 |
| Round 1 - Sept 30 | Round 1 - Oct 7 | Round 1 - Oct 14 |
| Round 2 - Oct 7 | Round 2 - Oct 14 | Round 2 - Oct 21 |
| Round 3 - Oct 14 | Round 3 - Oct 21 | Round 3 - Oct 28 |
| Round 4 - Oct 21 | Round 4 - Oct 28 | Round 4 - Nov 4 |
| Round 5 - Oct 28 | Round 5 - Nov 4 | |
| Round 6 - Nov 4 | | |
| Qualifier #7 | Qualifier #8 | Qualifier #9 |
| Round 1 - Oct 21 | Round 1 - Oct 28 | Round 1 - Nov 4 |
| Round 2 - Oct 28 | Round 2 - Nov 4 | |
| Round 3 - Nov 4 | | |

Qualifying Tournaments
Based on 2012 NFL Season

| | Qualifier | Qualifier | Qualifier | Qualifier | Qualifier | Qualifier | Qualifier | Qualifier | Qualifier |
|---|---|---|---|---|---|---|---|---|---|
| | #1 | #2 | #3 | #4 | #5 | #6 | #7 | #8 | #9 |
| Rounds | 9 | 8 | 7 | 6 | 5 | 4 | 3 | 2 | 1 |
| Week 1 | Round 1 | — | — | — | — | — | — | — | — |
| | Sept 9 | | | | | | | | |
| Week 2 | Round 2 | Round 1 | — | — | — | — | — | — | — |
| | Sept 16 | Sept 16 | | | | | | | |
| Week 3 | Round 3 | Round 2 | Round 1 | — | — | — | — | — | — |
| | Sept 23 | Sept 23 | Sept 23 | | | | | | |
| Week 4 | Round 4 | Round 3 | Round 2 | Round 1 | — | — | — | — | — |
| | Sept 30 | Sept 30 | Sept 30 | Sept 30 | | | | | |
| Week 5 | Round 5 | Round 4 | Round 3 | Round 2 | Round 1 | — | — | — | — |
| | Oct 7 | Oct 7 | Oct 7 | Oct 7 | Oct 7 | | | | |
| Week 6 | Round 6 | Round 5 | Round 4 | Round 3 | Round 2 | Round 1 | — | — | — |
| | Oct 14 | Oct 14 | Oct 14 | Oct 14 | Oct 14 | Oct 14 | | | |
| Week 7 | Round 7 | Round 6 | Round 5 | Round 4 | Round 3 | Round 2 | Round 1 | — | — |
| | Oct 21 | Oct 21 | Oct 21 | Oct 21 | Oct 21 | Oct 21 | Oct 21 | | |
| Week 8 | Round 8 | Round 7 | Round 6 | Round 5 | Round 4 | Round 3 | Round 2 | Round 1 | — |
| | Oct 28 | Oct 28 | Oct 28 | Oct 28 | Oct 28 | Oct 28 | Oct 28 | Oct 28 | |
| Week 9 | Round 9 | Round 8 | Round 7 | Round 6 | Round 5 | Round 4 | Round 3 | Round 2 | Round 1 |
| | Nov 4 | Nov 4 | Nov 4 | Nov 4 | Nov 4 | Nov 4 | Nov 4 | Nov 4 | Nov 4 |

This staggering concept can also go in the opposite direction where the qualifying tournaments all start at the same time, but end at different dates as shown below.

Qualifying Tournaments
Based on 2012 NFL Season

| | Qualifier | Qualifier | Qualifier | Qualifier | Qualifier | Qualifier | Qualifier | Qualifier | Qualifier |
|---|---|---|---|---|---|---|---|---|---|
| | #1 | #2 | #3 | #4 | #5 | #6 | #7 | #8 | #9 |
| Rounds | 9 | 8 | 7 | 6 | 5 | 4 | 3 | 2 | 1 |
| Week 1 | Round 1 | Round 1 | Round 1 | Round 1 | Round 1 | Round 1 | Round 1 | Round 1 | Round 1 |
| | Sept 9 | Sept 9 | Sept 9 | Sept 9 | Sept 9 | Sept 9 | Sept 9 | Sept 9 | Sept 9 |
| Week 2 | Round 2 | Round 2 | Round 2 | Round 2 | Round 2 | Round 2 | Round 2 | Round 2 | — |
| | Sept 16 | Sept 16 | Sept 16 | Sept 16 | Sept 16 | Sept 16 | Sept 16 | Sept 16 | |
| Week 3 | Round 3 | Round 3 | Round 3 | Round 3 | Round 3 | Round 3 | Round 3 | — | — |
| | Sept 23 | Sept 23 | Sept 23 | Sept 23 | Sept 23 | Sept 23 | Sept 23 | | |
| Week 4 | Round 4 | Round 4 | Round 4 | Round 4 | Round 4 | Round 4 | — | — | — |
| | Sept 30 | Sept 30 | Sept 30 | Sept 30 | Sept 30 | Sept 30 | | | |
| Week 5 | Round 5 | Round 5 | Round 5 | Round 5 | Round 5 | — | — | — | — |
| | Oct 7 | Oct 7 | Oct 7 | Oct 7 | Oct 7 | | | | |
| Week 6 | Round 6 | Round 6 | Round 6 | Round 6 | — | — | — | — | — |
| | Oct 14 | Oct 14 | Oct 14 | Oct 14 | | | | | |
| Week 7 | Round 7 | Round 7 | Round 7 | — | — | — | — | — | — |
| | Oct 21 | Oct 21 | Oct 21 | | | | | | |
| Week 8 | Round 8 | Round 8 | — | — | — | — | — | — | — |
| | Oct 28 | Oct 28 | | | | | | | |
| Week 9 | Round 9 | — | — | — | — | — | — | — | — |
| | Nov 4 | | | | | | | | |

This staggering concept can also have no pattern as shown in the example below.

Qualifying Tournaments
Based on 2012 NFL Season

| | Qualifier | Qualifier | Qualifier | Qualifier | Qualifier | Qualifier | Qualifier | Qualifier | Qualifier |
|---|---|---|---|---|---|---|---|---|---|
| | #1 | #2 | #3 | #4 | #5 | #6 | #7 | #8 | #9 |
| Rounds | 9 | 8 | 7 | 6 | 5 | 4 | 3 | 2 | 1 |
| Week 1 | Round 1 | Round 1 | — | Round 1 | — | — | — | — | Round 1 |
| | Sept 9 | Sept 9 | | Sept 9 | | | | | Sept 9 |
| Week 2 | Round 2 | Round 2 | Round 1 | Round 2 | — | — | Round 1 | — | Round 2 |
| | Sept 16 | Sept 16 | Sept 16 | Sept 16 | | | Sept 16 | | Sept 16 |
| Week 3 | Round 3 | Round 3 | Round 2 | Round 3 | — | Round 1 | Round 2 | — | — |
| | Sept 23 | Sept 23 | Sept 23 | Sept 23 | | Sept 23 | Sept 23 | | |
| Week 4 | Round 4 | Round 4 | Round 3 | Round 4 | — | Round 2 | Round 3 | — | — |
| | Sept 30 | Sept 30 | Sept 30 | Sept 30 | | Sept 30 | Sept 30 | | |
| Week 5 | Round 5 | Round 5 | Round 4 | Round 5 | Round 1 | Round 3 | — | — | — |
| | Oct 7 | Oct 7 | Oct 7 | Oct 7 | Oct 7 | Oct 7 | | | |
| Week 6 | Round 6 | Round 6 | Round 5 | Round 6 | Round 2 | Round 4 | — | Round 1 | — |
| | Oct 14 | Oct 14 | Oct 14 | Oct 14 | Oct 14 | Oct 14 | | Oct 14 | |
| Week 7 | Round 7 | Round 7 | Round 6 | — | Round 3 | Round 5 | — | — | — |
| | Oct 21 | Oct 21 | Oct 21 | | Oct 21 | Oct 21 | | | |
| Week 8 | Round 8 | Round 8 | Round 7 | — | Round 4 | — | — | — | — |
| | Oct 28 | Oct 28 | Oct 28 | | Oct 28 | | | | |
| Week 9 | Round 9 | — | — | — | — | — | — | — | — |
| | Nov 4 | | | | | | | | |

This staggering concept can also have the same number of rounds for some (or even all) of the satellites.

Qualifying Tournaments
Based on 2012 NFL Season

| | Qualifier | Qualifier | Qualifier | Qualifier | Qualifier | Qualifier | Qualifier | Qualifier | Qualifier |
|---|---|---|---|---|---|---|---|---|---|
| | #1 | #2 | #3 | #4 | #5 | #6 | #7 | #8 | #9 |
| Rounds | 9 | 8 | 7 | 6 | 5 | 4 | 3 | 2 | 1 |
| Week 1 | Round 1 | Round 1 | — | Round 1 | — | — | — | — | Round 1 |
| | Sept 9 | Sept 9 | | Sept 9 | | | | | Sept 9 |
| Week 2 | Round 2 | Round 2 | Round 1 | Round 2 | — | — | Round 1 | — | Round 2 |
| | Sept 16 | Sept 16 | Sept 16 | Sept 16 | | | Sept 16 | | Sept 16 |
| Week 3 | Round 3 | Round 3 | Round 2 | Round 3 | — | Round 1 | Round 2 | — | — |
| | Sept 23 | Sept 23 | Sept 23 | Sept 23 | | Sept 23 | Sept 23 | | |
| Week 4 | Round 4 | Round 4 | Round 3 | Round 4 | — | Round 2 | Round 3 | — | — |
| | Sept 30 | Sept 30 | Sept 30 | Sept 30 | | Sept 30 | Sept 30 | | |
| Week 5 | Round 5 | Round 5 | Round 4 | Round 5 | Round 1 | Round 3 | Round 4 | — | — |
| | Oct 7 | Oct 7 | Oct 7 | Oct 7 | Oct 7 | Oct 7 | Oct 7 | | |
| Week 6 | Round 6 | Round 6 | Round 5 | Round 6 | Round 2 | Round 4 | Round 5 | Round 1 | — |
| | Oct 14 | Oct 14 | Oct 14 | Oct 14 | Oct 14 | Oct 14 | Oct 14 | Oct 14 | |
| Week 7 | Round 7 | Round 7 | Round 6 | Round 7 | Round 3 | Round 5 | — | Round 5 | — |
| | Oct 21 | Oct 21 | Oct 21 | Oct 21 | Oct 21 | Oct 21 | | Oct 21 | |
| Week 8 | Round 8 | Round 8 | Round 7 | — | Round 4 | — | — | — | — |
| | Oct 28 | Oct 28 | Oct 28 | | Oct 28 | | | | |
| Week 9 | Round 9 | — | — | — | Round 5 | — | — | — | — |
| | Nov 4 | | | | Nov 4 | | | | |

Once these qualifying tournaments have concluded, the qualifying process is over and the main tournament begins. The format for each round of the main tournament could either be group play or fantasy players competing against each other head-to-head.

The staggering concept provided in the example embodiment can be used for sports where there is more than one game that is included in each round. For example, the Major League Baseball season could be partitioned in a way where each satellite tournament is one week in length. An example of this scenario is shown below.

Qualifying Tournament Information

| | Begins | Ends | # Rounds |
|---|---|---|---|
| Qualifier #1 | Apr 9 | June 10 | 9 |
| Qualifier #2 | Apr 16 | June 10 | 8 |
| Qualifier #3 | Apr 23 | June 10 | 7 |
| Qualifier #4 | Apr 30 | June 10 | 6 |
| Qualifier #5 | May 7 | June 10 | 5 |
| Qualifier #6 | May 14 | June 10 | 4 |
| Qualifier #7 | May 21 | June 10 | 3 |
| Qualifier #8 | May 28 | June 10 | 2 |
| Qualifier #9 | June 4 | June 10 | 1 |

Explanation 4—Creating staggered qualifying tournaments with the same number of rounds—The idea behind this format in an example embodiment (denoted herein as the Wildcard and Super Wildcard Formats) is to allow fantasy players to continue to re-enter the tournament at a same low price throughout all qualifying tournaments. In order to do this, the number of rounds must remain constant so there isn't an unfair advantage that any one group of contestants has depending on their entry point. What this means is that creative strategies must be developed to hold this set number of rounds as the tournament gets closer and closer to the Main Event. A Wildcard Format is used when more than one round is needed during an interval of the tournament where fantasy players who entered earlier might only be playing one round. This technique is used as a “catch up” mechanism so that all fantasy players end up playing the same number of rounds. Using NFL football as an example, the regular season schedule always has morning and afternoon games. The morning games could be used as one round while the afternoon games serve as an additional round. When a Wildcard Format is needed, it is necessary for fantasy players to give a Contingency Lineup for the PM games in advance, because there is not enough time to submit lineups between the AM and PM games.

Sometimes there is so little time left that a Super Wildcard Format is needed. This happens when several rounds are needed in the same game as a way to catch up. A Super Wildcard Format breaks individual games (or games happening simultaneously) into two or more rounds. For example, using an NFL fantasy football tournament again, if there are 10 weeks for qualifying that cover the first 10 weeks of the regular season, it is straightforward to hold a 10 round qualifying tournament. Each of those 10 weeks would constitute a round. There is no need for either a Wildcard or Super Wildcard Format. It gets more difficult to create 10 rounds though once there are no longer 10 weeks of NFL games to contest them. For example, if during the 17th week of the NFL season, a fantasy football tournament organizer wants to still charge the same $5 entry fee that they did in NFL week 1, they would have to create 10 rounds in order to make it fair. The only way to do so is by implementing a Super Wildcard Format where each game (or group of simultaneously running games) is broken down into two or more rounds. Below are two potential options to accomplish this result as illustrated by example.

During the 17^{th} week, fantasy players can sign up for a one week version where the AM games count as four rounds (e.g., one round for each quarter of the AM game) and the PM games count as four rounds (e.g., one round for each quarter of the PM game) and the Sunday Night Game is a round and the Monday Night Game is a round (e.g., Sunday night is Round 9 and Monday night is Round 10). Because this structure involves four sets of lineups (AM games, PM games, Sunday night game and Monday night game), fantasy players will have to submit four lineups in order to play this format before any of the games begin. An example of this tournament structure is set forth below.

### Option #1

Round 1—1^{st} quarter of AM games

Round 2—2^{nd} quarter of AM games

Round 3—3rd quarter of AM games

Round 4—4^{th} quarter of AM games

Round 5—1^{st} quarter of PM games

Round 6—2^{nd} quarter of PM games

Round 7—3rd quarter of PM games

Round 8—4^{th} quarter of PM games

Round 9—Sunday Night Game

Round 10—Monday Night Game

### Option #2

AM games begin at 10 AM PST for Rounds 1 through 4. Player statistics accumulate from 10:00 AM to 10:50 AM. Round 1 begins at 10:50 AM. Adjusted fantasy percentages are calibrated for groups.

10:54 AM—12^{th} ranked player in each group is eliminated

10:58 AM—11^{th} ranked player in each group is eliminated

11:02 AM—10^{th} ranked player from each group is eliminated

11:06 AM—9^{th} ranked player from each group is eliminated

11:10 AM—8^{th} ranked player from each group is eliminated

11:14 AM—7^{th} ranked player in each group is eliminated

11:18 AM—6^{th} ranked player in each group is eliminated

11:22 AM—5^{th} ranked player from each group is eliminated

11:26 AM—4^{th} ranked player from each group is eliminated

Remaining top 3 fantasy players of each group advance to the 2nd round. New adjusted fantasy percentages calibrated for new groups

11:30 AM—12^{th} ranked player from each group is eliminated

11:34 AM—11^{th} ranked player in each group is eliminated

11:38 AM—10^{th} ranked player from each group is eliminated

11:42 AM—9^{th} ranked player from each group is eliminated

11:46 AM—8^{th} ranked player from each group is eliminated

11:50 AM—7^{th} ranked player in each group is eliminated

11:54 AM—6^{th} ranked player in each group is eliminated

11:58 AM—5^{th} ranked player from each group is eliminated

12:02 PM—4^{th} ranked player from each group is eliminated

Remaining top 3 fantasy players of each group advance to the 3rd round. New adjusted fantasy percentages calibrated for new groups

12:06 PM—12^{th} ranked player from each group is eliminated

12:10 PM—11^{th} ranked player in each group is eliminated

12:14 PM—10^{th} ranked player from each group is eliminated

12:18 PM—9^{th} ranked player from each group is eliminated

12:22 PM—8^{th} ranked player from each group is eliminated

12:26 PM—7^{th} ranked player in each group is eliminated

12:30 PM—6^{th} ranked player in each group is eliminated

12:34 PM—5^{th} ranked player from each group is eliminated

12:38 PM—4^{th} ranked player from each group is eliminated

Remaining top 3 fantasy players of each group advance to the 4th round. New adjusted fantasy percentages calibrated for new groups

12:42 PM—12^{th} ranked player from each group is eliminated

12:46 PM—11^{th} ranked player in each group is eliminated

12:50 PM—10^{th} ranked player from each group is eliminated

12:54 PM—9^{th} ranked player from each group is eliminated

12:58 PM—8^{th} ranked player from each group is eliminated

1:02 PM—7^{th} ranked player in each group is eliminated

1:06 PM—6^{th} ranked player in each group is eliminated

1:10 PM—5^{th} ranked player from each group is eliminated

1:14 PM—4^{th} ranked player from each group is eliminated

Survivors are regrouped in a new super group to begin round 5 during PM games.

PM games begin at 1:25 PM PST for Rounds 5 through 8. Player statistics accumulate from 1:25 to 2:15 PM. Round 5 begins at 2:15 PM. Adjusted fantasy percentages are calibrated for groups.

2:19 PM—12^{th} ranked player in each group is eliminated

2:23 PM—11^{th} ranked player in each group is eliminated

2:27 PM—10^{th} ranked player from each group is eliminated

2:31 PM—9^{th} ranked player from each group is eliminated

2:35 PM—8^{th} ranked player from each group is eliminated

2:39 PM—7^{th} ranked player in each group is eliminated

2:43 PM—6^{th} ranked player in each group is eliminated

2:47 PM—5^{th} ranked player from each group is eliminated

2:51 PM—4^{th} ranked player from each group is eliminated

Remaining top 3 fantasy players of each group advance to the 6th round. New adjusted fantasy percentages calibrated for new groups.

2:55 PM—12^{th} ranked player from each group is eliminated

2:59 PM—11^{th} ranked player in each group is eliminated

3:03 PM—10^{th} ranked player from each group is eliminated

3:07 PM—9^{th} ranked player from each group is eliminated

3:11 PM—8^{th} ranked player from each group is eliminated

3:15 PM—7^{th} ranked player in each group is eliminated

3:19 PM—6^{th} ranked player in each group is eliminated

3:23 PM—5^{th} ranked player from each group is eliminated

3:27 PM—4^{th} ranked player from each group is eliminated

Remaining top 3 fantasy players of each group advance to the 7th round. New adjusted fantasy percentages calibrated for new groups.

3:31 PM—12^{th} ranked player from each group is eliminated

3:35 PM—11^{th} ranked player in each group is eliminated

3:39 PM—10^{th} ranked player from each group is eliminated

3:43 PM—9^{th} ranked player from each group is eliminated

3:47 PM—8^{th} ranked player from each group is eliminated

3:51 PM—7^{th} ranked player in each group is eliminated

3:55 PM—6^{th} ranked player in each group is eliminated

3:59 PM—5^{th} ranked player from each group is eliminated

4:03 PM—4^{th} ranked player from each group is eliminated

Remaining top 3 fantasy players of each group advance to the 8th round. New adjusted fantasy percentages calibrated for new groups.

4:07 PM—12^{th} ranked player from each group is eliminated

4:11 PM—11^{th} ranked player in each group is eliminated

4:15 PM—10^{th} ranked player from each group is eliminated

4:19 PM—9^{th} ranked player from each group is eliminated

4:23 PM—8^{th} ranked player from each group is eliminated

4:27 PM—7^{th} ranked player in each group is eliminated

4:31 PM—6^{th} ranked player in each group is eliminated

4:35 PM—5^{th} ranked player from each group is eliminated

4:39 PM—4^{th} ranked player from each group is eliminated

The top 3 survivors from each group after round 8 are regrouped in a new group to begin round 9, which is played during Sunday night game. The top 3 survivors from each group of the Sunday night game then compete during the Monday night game for the 10th and final round. The top 3 survivors automatically qualify for the Main Event.

The process described above is one of the most important features developed as part of the various embodiments. The process includes the following important characteristic—the process defines a set number of qualifying rounds that are needed to qualify for a Main Event and then offers these qualifying options during any point of the qualifying process. Additionally, the described embodiments offer a variety of others features and benefits. An example embodiment described herein allows a qualifying process for a fantasy tournament Main Event to be compressed in terms of time. For some competitors the qualifying process might be two months or more. For other competitors, the qualifying process might be a few weeks. For some competitors, the qualifying process might be a week and for some the process might even be a day. Even though the time duration of the qualifying process can fluctuate dramatically, the number of rounds a fantasy contestant must play during this qualifying process remains constant. If it is predetermined that a qualifying process is for 10 rounds, then all qualifying tournaments must be 10 rounds regardless of whether the qualifying tournament is ten weeks or one day. This format allows people to re-enter the qualifying process at the same low price point at any stage of the qualifying process without being subjected to a Lottery Effect type of parameters. Fantasy players are still able to compete in small groups. As seen from the above two examples, this means that various embodiments as described herein can generate 10 (or an arbitrary number of) rounds for qualifying tournaments that have a very limited time period.

Explanation #5—Using Contingency Lineups to create exciting tournaments that have a limited number of days—This is an extremely powerful embodiment that makes fantasy tournaments possible for situations where there are a very small number of days that the real life tournament is being conducted. Without using the Contingency Lineup technique, there would be no possible way to hold these types of fantasy tournaments.

The Contingency Lineup Format of an example embodiment requires fantasy players to submit multiple lineups (two or more) before any of the games take place for a given day. If a given fantasy player advances to the next round, then their next contingency lineup becomes their actual lineup. The reason that this format becomes necessary is because there may not be enough time to select new lineups for the next round. This is because a new set of games starts immediately after the games that just finished. An example demonstrating the power of this embodiment is set forth below.

During the NFL playoffs, there are always 11 games. These 11 games are distributed over six unique days. Five days have two games each and then the Super Bowl is a stand alone game during the sixth day. If there was no Contingency Lineup Format, we could only have six rounds of play (each day is one round); because, the way the games are scheduled is not conducive to submitting a new lineup once a fantasy player advances (e.g., there is not enough time in between games to submit a new lineup). If a fantasy tournament organizer wanted to play the tournament in groups of 12 for each round with the top two scorers in each group advancing, this creates a 6 to 1 ratio (one person advancing for every six players). A 6:1 ratio over six rounds creates 93,312 potential openings. Let's assume that a tournament organizer wanted to offer a fantasy tournament for just the NFL playoffs and used the above technique without employing contingency lineups. This tournament organizer might set the asking price at $5 per entry and the grand prize at five million dollars. The tournament organizer might believe they have created an ideal high stakes fantasy sports tournament with a low entry fee, a multi-million dollar grand prize, and small group play during individual rounds.

However, the problem with this tournament organizer's tournament is that because only 93,312 people can play, the tournament can only generate $466,560 if all of the seats are filled. Clearly, it isn't financially possible to offer a five million dollar grand prize for a tournament that only has the capacity to generate less than half a million dollars in revenue.

The Contingency Lineups of the example embodiment described herein can change this result. If each of the 11 games became an individual round by using Contingency Lineups for games where one comes immediately after another, a whole new landscape can be created. This new arrangement allows for over 750,000,000 (three quarters of a billion) entries. This type of format would easily support a five million dollar grand prize for $5 entry fees.

In an alternative embodiment, a tournament can be implemented that uses RINGS. RINGS or rings, as denoted herein, is an acronym for Rounds Involving Narrow Group Size. In an example embodiment, a tournament using rings provides a more robust and fair way to handle group play. In an example embodiment, a tournament supporting rings includes the following novel characteristics not seen before in any prior fantasy sports tournaments that have a large number of entries (e.g., entries of 100,000 or more people). The characteristics of a tournament with rings can include the following:

Avoiding Trap Rounds—All previous attempts of large scale fantasy sports tournaments of 100,000 or more entries have at LEAST one “trap” round in the tournament. A trap round is a given round (or multiple rounds) of a tournament where participants are placed together in such large numbers that a random participant has less than a 1% mathematical chance to advance. In essence a lottery is created which negates the skill level of the players competing. This is because a portion of the tournament is based on pure luck; which makes the tournament less than desirable to play in for players. A tournament with RINGS NEVER has a trap round.

Small Group Play—In an example embodiment, a tournament supporting rings provides an opportunity for small skill-based group play.

Skill Based—The 10% Rule—In a tournament supporting rings, fantasy players always, mathematically, have at least a 10% chance to advance to the next round. This is true for every contested part of the tournament. This defines a skill based tournament.

RINGS—RINGS (Rounds Involving Narrow Group Size) are the combination of small group play contested over multiple rounds (two rounds or more). RINGS are the answer to the problem with which current high stakes fantasy sports models are struggling. There has never been a version of a tournament created that offers the two money-maker components of an effective tournament (e.g., low entry fees and a multi-million dollar grand prize) that also is skill based (at least a 10% chance to advance in every round). Moreover, every high stakes fantasy sports tournament example ever attempted in the conventional art has had a least one portion where there is a trap round with a less than 1% chance to advance.

Combining Regular and Post Seasons—Prior examples of fantasy tournaments have included only the regular season of a given sport while others have included only the post-season. An example embodiment of the tournament described herein provides both the regular season and the post-season together in a single tournament. Conventional implementations do not provide a fantasy sports tournament that includes both the regular season and the post-season together. The example embodiment of the tournament described herein works in conjunction with RINGS to provide both the regular season and the post-season together. The importance of this dynamic should not be underestimated. There are many gaming barriers that had to be addressed to offer this format, which is why nobody has ever thought of putting both together in the same tournament.

Scrambles—An example embodiment of the tournament described herein provides a scrambles process where players enter RINGS competitions and compete in group play for an increasingly higher prize every time they advance in consecutive rounds. For example, if a fantasy player is competing in a Scramble, they might receive $5 for finishing in the top 3 of a group of 12 and an automatic berth in a second round Scramble. If they finish in the top 3 of 12 for this second Scramble, they might win $10 and an automatic bid to a third round Scramble. This process continues on until a pre-determined number of rounds is reached for a chance to win a grand prize.

An example embodiment of the tournament structure described herein that supports rings can enable various related methods, such as the method described below.

A method comprising: prompting, by execution of a data processor, a large number (defined as 100,000 or more) of users at a corresponding large number of user platforms to each submit a nominal buy-in for entry into a fantasy sports tournament, the users submitting the nominal buy-in becoming fantasy players of the fantasy sports tournament; partitioning, by execution of the data processor, the fantasy players of the fantasy sports tournament into player groups called “rings” that compete to advance through a pre-determined number of rounds to a main tournament (RINGS is an acronym for Rounds Involving Narrow Group Size), at least one player ring having at least three fantasy players as ring members, the fantasy players in each player ring only playing against other members of the same player ring during a given round; receiving from each member of each player ring a selection of athletes corresponding to each member and scoring each member of each player ring based on the performance of selected athletes, members of each player ring who do not score within a predetermined number of advancing players for their given ring relative to the other members of the same player ring are disqualified from the fantasy sports tournament; enabling a disqualified fantasy player to re-enter the fantasy sports tournament after submittal of an additional fee by either a) paying the same fee again which requires playing one or more additional rounds to catch up to the number of rounds other players have played or b) paying an additional fee to bypass rounds that have already been played; enabling an advancing player to move on to the next round of the tournament, without having to pay an additional charge, as the advancing player is placed in a new ring of players who also have successfully advanced to the same stage of the tournament; and configuring the fantasy sports tournament to include rings.

An example embodiment of the tournament structure described herein that supports rings can be part of a larger high stakes fantasy sports tournament format. In the example embodiment, there are seven essential features that distinguish this new tournament format from existing tournament formats. These seven essential features are described in more detail below.

### Seven Essential Gaming Features for a High Stakes Fantasy Sports Tournament

In the example embodiment described herein, there are seven key features or characteristics that a high stakes fantasy sports tournament requires to be successful. These seven key features can be broken into two categories. These categories include:
A. The Money Category (which includes two of the seven key features)
   1. Low entry fee—$5 or less per entry
   2. A multi-million dollar grand prize
B. The Gaming Structure Category (which includes the other five of the seven key features)
   1. Two-tiered format using the regular season of a given sport as tier one and the playoffs as tier two.
   2. Allows unlimited entries—or pretty close to it
   3. Skill must be a factor—each time someone plays, the player must have at least a 10% mathematical chance of advancing to a next round of play.
   4. Allows simultaneous entries from the same fantasy player to compete at the same time.
   5. Allows re-entry at any point in tier one.

The best any conventional fantasy sports company in the industry has done in the past is to offer a few of these seven features in the same tournament. However, no conventional tournament format has included all seven features or key combinations of these seven features. RINGS (Rounds Involving Narrow Group Size), as described above, are a key component that has been left out of all conventional high stakes fantasy tournaments. Even more importantly, no conventional fantasy sports tournament has ever offered both of the “Money Category” features described above, which include a “low entry fee” and a “multi-million dollar grand prize”, in combination with the “Gaming Structure Category” feature of “skill as a factor”.

In the example embodiment described herein, the seven key features or characteristics listed above are important for a high stakes fantasy sports tournament to be successful. The reasons why each of these seven ingredients are so important are described next.

### The Money Category

### Low Entry Fee (Ideally $5 or Less Per Entry)—

People like to play when the risk level is minimal. Tournaments that offer a low entry fee are always going to have the potential to draw many more people than ones with pricey entry fees.

### A Multi-Million Dollar Grand Prize—

When tournaments have a low entry fee paired with a multi-million dollar grand prize, the potential is extraordinary—especially if there is skill involved in the tournament format. No conventional multi-million dollar tournament in the fantasy sports genre has ever had a skill component; because, every single one of them has always had at least one trap component in the tournament (e.g., at least one occasion in the tournament when fantasy players face less than a 1% chance to advance to a next round in the tournament).

### The Gaming Structure Category

### Two Tiered Format—

The example embodiment described herein uses both the regular season and the playoffs of a given sport in the same tournament. No conventional fantasy sports tournament provider has ever implemented a combination of the regular season and the playoffs of a given sport in the same tournament. This combination allows for much greater flexibility in the number of entries the tournament can accommodate.

Allows Unlimited Entries—or Pretty Close to it—

This is where conventional fantasy sports companies have gotten it consistently wrong. Conventional fantasy tournaments weed out fantasy participants by placing them simultaneously in large quantities of players. Conventional fantasy tournament providers have consistently struggled with the quantity of players that should simultaneously compete against one another. The traditional solution has always been to allow players to compete against fewer players at once if they are willing to pay a higher entry fee. For example, it might cost $100 to be able to compete in a pool of as little as 500 players simultaneously as opposed to going against 5,000 people all at once for $5. These pools of people in traditional fantasy tournaments create two competing realities that make these tournaments problematic; because, these tournaments involve gaming features that are diametrically opposed to one another. The first reality is that to offer a huge prize, the traditional tournament must have lots of people entering the tournament or the tournament cannot generate the necessary revenue to offer a large cash prize. Thus, the first reality of traditional fantasy tournaments is to entice lots of people to enter the tournament. On the other hand, the second reality of traditional fantasy tournaments creates a different dynamic. Because the strategy to weed players out has always been to place them in large pools of participants, the players themselves are concerned about playing too many people at one time. To address this reality, tournament organizers have taken the path of capping pools of players by offering guaranteed player pools of fewer people if players are willing to pay more money, which also happens to violate the low entry fee requirement that makes the ideal format flourish. In other words, the second reality of traditional fantasy tournaments is to put limits on the numbers of people who can enter the tournament as a strategy to appease the players. These conflicting realities have created significant problems in conventional tournament formats. The reality is that these traditional tournaments are always capped and usually no more than 300,000 to 400,000 people can enter. This is a disaster if the goal is to have an entry fee of $5 or less, because the most a tournament can collect in entry fees is $2 million dollars. In contrast, the fantasy tournament format as disclosed herein allows for over 2.1 billion entries.

### Skill is a Major Factor—

Player skill has never been a factor in any past or current examples of low entry fee and high dollar reward fantasy sports tournaments. The reason is that every single example ever offered has had at least one “trap” round where the chance of a player advancing to a next round is less than 1%. A trap round is where participants are placed together in such large numbers that a random participant has less than a 1% mathematical chance to advance. In essence, a trap round creates a lottery, which negates the skill level of the players competing. A tournament based on pure luck is less desirable for players who are seeking a skill based tournament. The tournament format as disclosed herein avoids this problem by using the RINGS feature as described herein. The RINGS feature as disclosed herein combines small group play over multiple rounds. No traditional fantasy sports tournament has ever used this process.

The various example embodiments described herein are skill based tournament formats. The tournament formats described herein avoid “trap” rounds where the chance of a player advancing to a next round is less than 1%. The tournament formats described herein provide a high stakes tournament that provides players a reasonable chance to advance (at least 10% at any given time) so that skill actually is a factor in the competition. All previous attempts of large scale fantasy sports tournaments of 100,000 or more entries had at least one trap round in the tournament where a player had less than a 1% chance to advance.

The various embodiments described herein allow simultaneous entries from the same fantasy player in Tier 1 (i.e., the qualifying portion of the tournament). The only way a tournament can generate the kind of revenue necessary to offer a high dollar prize for a low entry fee is to allow multiple entries by the same person to be played simultaneously. The only way that this can be done effectively is to create a submission process that doesn't take a lot of time like drafting players or studying salary caps. In an example embodiment, a process is used that penalizes competitors for duplication through a blind submission process. This is the most effective way to avoid a draft and salary caps.

The various embodiments described herein also allow re-entry at any point in Tier 1. This feature is an important part of a particular embodiment. In order for a low entry fee tournament to flourish, there must be processes provided that allow contestants to enter the tournament at any time in Tier 1 for the same low entry fee. This is a necessary component to continue generating the revenue required to support a low entry fee and a high dollar grand prize tournament. The difficulty lies in providing ways for contestants entering late in Tier 1 to still have a chance to get in, but also cover the same amount of ground that contestants in earlier stages of Tier 1 had to cover. The only way to accomplish this is to employ the RINGS feature as described herein. In particular, a tournament can offer multiple RINGS within the same day. An example embodiment of the tournament structure that supports rings to enable various related methods is described herein.

Daily fantasy sports games are extremely popular. In a particular embodiment, the Scrambles and RINGS concepts as disclosed herein can be integrated into a daily fantasy sports game format. For example, a particular embodiment can offer a pre-determined 10 round Scramble where each new round occurs the next day of a given sports season. Winning players could either cash out after a given round or let their winnings ride until the next round. Fantasy players who finish in the top predetermined positions would be considered “winners” and then could either cash out or decide to go to the next round where their money could be doubled (as an example) for finishing in a top position again.

In another example embodiment, a National Fantasy Sports Certification System can be implemented. Conventional fantasy sports tournaments have never provided a system for fantasy sports certification where people who play fantasy sports are ranked and certified like they can be in other activities, such as martial arts. A detailed description of an example embodiment of a fantasy sports certification system is provided next.

### An Example Embodiment for Creating a National Fantasy Certification System

What is a GOAT and What does this have to do with Fantasy Sports Certification?

GOAT is an acronym for the “Greatest of All Time”. Every sport has its own version of who the GOAT is. Baseball has Babe Ruth. Hockey has Wayne Gretzky. Basketball has Michael Jordan. Soccer has Pele. Sometimes there is fierce debate. Is it Tiger Woods or Jack Nicklaus in golf? Is it Jim Brown, Joe Montana, Jerry Rice or someone else in football? In any event, the GOAT for any sport is the pinnacle of what anyone could ever hope to be. It is what men and women in sports dream about. They idolize these great athletes because they would like to be them. This fantasy to be the GOAT can be used as a powerful trigger for players with respect to fantasy sports. Just like with GOAT athletes, the ultimate goal for fantasy sports participants is to be recognized as great competitors maybe even the GOAT. Creating a structure in this manner allows participants to take on all kinds of roles that will fuel this concept to dizzying heights. Some players will be embarrassingly bad, most will be mediocre, some will be good, even less will be great and just a handful will become elite. This is the type of system that can generate huge money if a fantasy sports implementation can be created around it. Such a fantasy sports implementation in an example embodiment is described herein.

In conventional fantasy sports formats, there is no standardized way to evaluate whether someone who plays fantasy sports is really any good or not. When some player brags that s/he has won his/her fantasy league three straight years, is this really an accomplishment that should be respected or did the bragging player merely beat a bunch of low-performing league players. Conventional fantasy sports formats create a culture where nobody really knows how good anybody else is. In an example embodiment described herein, a fantasy sports system levels the playing field and provides a way to properly evaluate everyone who plays against a true standardized measuring system. Because fantasy football is the biggest fantasy sport on the market today, the following example embodiment describes the levels of a fantasy football GOAT measuring system.

### GOAT Fantasy Football—

In the example embodiment disclosed herein, GOAT Fantasy Football is a national certification process where fantasy football enthusiasts can accurately assess their skill level by comparing themselves to a uniform national standard. The GOAT system requires players to compete in national competitions so that they can be properly evaluated. For a low certification fee, fantasy enthusiasts can have their GOAT level calculated. In a particular embodiment, the process can be similar to the way martial artists use a progression of belts to distinguish the skill level of a given individual. However, unlike the martial art belt method, the GOAT system of a particular embodiment does not guarantee that players will advance if they just put in the time. In the GOAT system of a particular embodiment, if players do not perform well, they will not progress. If they perform well, they will be rewarded with advancement. If they are great, they might one day be recognized as the GOAT of fantasy football. Fantasy football players in the example embodiment who don't like their GOAT level can always re-apply as often as they like.

The Importance of the GOAT Certification Process—

The fantasy football GOAT measuring system of an example embodiment can generate a GOAT Certification for anyone who plays fantasy football (or any other fantasy sport). At every fantasy football draft in the country, it will become a requirement for any serious player to publicly reveal their GOAT Certification level to their group. Poorly rated players will be unlikely to receive priority in the draft. Excellent players will be revered as they should be and will be likely to receive priority in the draft. An individual player's GOAT level will always be present on their certification profile over the Internet for anyone to quickly access at any time. People who aren't enrolled and don't have a profile because they have never attempted to be certified with a ranking will be unlikely to receive the opportunities in a fantasy sports event that GOAT certified players will receive.

The fantasy football GOAT measuring system of an example embodiment is the first process ever created that allows tens of millions of people to be evaluated at one time that can also accurately gauge skill level. That is because the ranking process is done in small groups or head-to-head. Small group competitions can involve, for example, 12 people competing against one another with only the top 3 advancing to a new GOAT level.

### The GOAT Levels—

In an example embodiment, there are 9 different GOAT levels with the 9th level being the highest or “GOAT” level, which is comparable to a black belt in martial arts. Once a player makes a level, the player retains the level for life. It is possible that a player might try to re-certify for a higher level and do worse than the player's current level. However, in the example embodiment, the player will not be penalized and will retain the highest level achieved. The various GOAT measuring levels in an example embodiment are described in more detail below.

The various GOAT measuring levels in an example embodiment are as follows:
Parasite (AKA a Zero)—This isn't even a true level, so it is given a zero numeric to represent a player who has not been officially ranked. A player who is unranked and uncertified is unlikely to receive the opportunities in a fantasy sports event that GOAT certified players will receive.
Junior Varsity (JV)—Basically, you are a beginner or a poor performer if you are at this level. This is comparable to someone being cut from their varsity team in high school and fantasy football is not your deal either. Players need to do is finish in the top 3 of a 12 person national competition one time to go to the Varsity level.
Varsity—This is the “Al Bundy” ranking. This is comparable to someone making the varsity in high school, but never went any further. Players need to finish in the top 3 of a 12 person national competition two times consecutively to go to the JUCO level.
JUCO—This level is comparable to the high school stud who simply wasn't good enough for Division 1 ball, so they have to play JUCO (JUCO is a common abbreviation used for “junior college”). Players need to finish in the top 3 of a 12 person national competition three times consecutively to go to the next level (Division 1).
Division 1—At this level, players are pretty good, but nowhere close to a professional. They need to finish in the top 3 of a 12 person national competition four times consecutively to go to the Professional level.
Professional—At this level, players can go into any fantasy draft and be respected. These players are considered an elite fantasy football player. Players need to finish in the top 3 of a 12 person national competition five times consecutively to go to the All Pro level.
All Pro—This is comparable to all star professional athletes. These are fantasy experts who usually dominate other professional level fantasy players. Players need to finish in the top 3 of a 12 person national competition six times consecutively to go to the MVP level.
MVP—These are people who are the best players in the city in which they live. They need to finish in the top 3 of a 12 person national competition seven times consecutively to go to the Hall of Fame level.
Hall of Fame—These are national caliber fantasy football players. Players need to finish in the top 3 of a 12 person national competition eight times consecutively to go to the GOAT level.
GOAT—These are fantasy legends. They are the black belts of the fantasy football participant pool. These folks are the best of the national caliber players who will be invited to compete against other fantasy football GOATS to determine the GOAT of GOATS.

### Odds for Each Level—

In the fantasy football GOAT measuring system of an example embodiment, the goal is to create an extremely difficult challenge to become a GOAT, but at the same time, make it achievable in a way that many people will become GOATS. This will fuel the masses to do whatever it takes to make it; because, they will see many who have done it. The truth is, though, that over 99% of the people who play fantasy football will never achieve the level of GOAT; because, it is a 65,536 to 1 shot—assuming we don't account for the talent level of individual players. Nevertheless, the fantasy football GOAT measuring system of an example embodiment creates a plurality of levels based on the skill of the players and not merely on random luck. As such, the players are more motivated to try to move up the GOAT levels and willing to pay fees to take the chance. The odds of a typical player achieving a ranking at each of the GOAT levels described above are set forth below.
JV level player:
Level players are placed at when they signup.—Just pay a certification fee and get in the system
Varsity level player: 4 to 1
JUCO level player: 16 to 1
Division 1 level player: 64 to 1
Professional level player: 256 to 1
All Pro level player: 1,024 to 1
MVP level player: 4,096 to 1
Hall of Fame level player: 16,384 to 1
GOAT level player: 65,536 to 1

### GOAT Only Competitions—

In an example embodiment, national tournaments are held for only GOAT certified players. The national tournaments occur after the NFL regular season is over and are held during the NFL playoffs. GOAT certified players can compete against one another using a one-on-one single elimination format (like the NCAA basketball tournament). GOAT players can compete to achieve any of a plurality of degrees of GOAT. In the example embodiment, there are ten degrees of GOAT. The higher the GOAT degree, the more revered the GOAT player will be in the pantheon of fantasy football players.

Once a person earns the title of GOAT as described above, the GOAT player will continually be invited back to GOAT only tournaments to improve on their GOAT degree. Also, winners of GOAT tournaments will not only be recognized as a 10th degree GOAT, but they will also be recognized with a goat horn. This goat horn will be treasured the same way bracelets get treasured for wins on the World Poker Tour or rings get valued for winning championships in team sports or belts for boxing and MMA. The elite GOAT players will battle it out to see who can accumulate the most GOAT horns so that they can be recognized as the true GOAT in the history of fantasy football. This whole special GOAT “club” that only plays each other will motivate the non-GOAT players to attempt to join this exclusive club.

In an example embodiment, the ten degrees of GOAT are as follows:
1st Degree GOAT—Any player who has ever finished in the top 3 of a group of 12 in a nationally GOAT certified tournament for 8 consecutive times.
2nd Degree GOAT—Any player who has ever finished in the top 256 of a “GOAT only” nationally certified GOAT tournament.
3rd Degree GOAT—Any player who has ever finished in the top 128 of a “GOAT only” nationally certified GOAT tournament.
4th Degree GOAT—Any player who has ever finished in the top 64 of a “GOAT only” nationally certified GOAT tournament.
5th Degree GOAT—Any player who has ever finished in the top 32 of a “GOAT only” nationally certified GOAT tournament.
6th Degree GOAT—Any player who has ever finished in the top 16 of a “GOAT only” nationally certified GOAT tournament.
7th Degree GOAT—Any player who has ever finished in the top 8 of a “GOAT only” nationally certified GOAT tournament.
8th Degree GOAT—Any player who has ever finished in the top 4 of a “GOAT only” nationally certified GOAT tournament.
9th Degree GOAT—Any player who has ever finished as a Runner-up in a “GOAT only” nationally certified GOAT tournament.
10th Degree GOAT—Any player who has ever won a “GOAT only” nationally certified GOAT tournament.

Example embodiments of the tournament structure described herein can also support additional features and formats including: 1) Multiple rounds in one day, and 2) a Let It Ride format. These features of an example embodiment are described below.

Multiple Rounds in One Day—The following process is a way to allow fantasy contestants to play several rounds in one day without breaking games up into separate rounds. This example is for a situation where 10 rounds are needed to be played in a single day for a tournament that is played in groups of 12 with the top 3 advancing. The format can be modified to accommodate a set number of rounds, group size and advancing contestants needed for a given day of play.
A contestant can still enter for a single entry fee.
The contestant only submits one lineup for that single entry (or they might be required to change the lineup—i.e., the same lineup might only be allowable for 3 rounds so it has to be altered if more than 3 rounds are needed).
This lineup will be randomly placed in 10 unique groups of 12.
The 10 unique groups are numbered from 1 to 10 so that the contestant knows that they are sequenced.
These sequenced numbers are to be considered individual rounds of play in the tournament.
The contestant can view the scoring for all 10 groups in this 10 round format up until all of the games go final.
A computer program will seek out the lowest numbered group in that sequence that the contestant doesn't finish in the top 3 of 12 in.
The earliest or lowest numbered round becomes the cutoff point and the other groups with rounds that are numbered higher drop off the screen once all the games go final.
Contestants now have a record of how many rounds they successfully advanced and also the round that they were eliminated in by not finishing in the top 3 out of 12.
This cutoff then tells the contestant how many rounds they successfully advanced in the tournament before they were eliminated.

Let it Ride—This is a daily fantasy sports concept where contestants can play in a group format structure for as many rounds that they desire (unless the tournament organizer establishes a maximum number of rounds). At the end of each round, the contestant can decide whether they want to collect their money or let it carry over to another round where they will get an even bigger prize if they finish in “winning” positions (for example finishing in the top 3 out of their group of 12 for a structure that declares the first three positions as winning spots).

Bid well or take a Scrub—Athletes are split into two groups for each position. Each position group contains half of all available athletes. The top 50% of athletes (based on weekly fantasy pt avg.) will be in a pool to be bid on. Contestants will select an athlete for each position and submit a percentage bid (1% to 100%) of fantasy points they are willing to settle for each athlete they select. If they have the lowest bid, they receive that athlete in their starting lineup (if ties happen, all tied people get that athlete for what they bid). Contestants who did not win a bid for a given position will be assigned a random “field” athlete at 100% of their fantasy value. This athlete can only come from the lower ranked athletes in bottom 50% who are not allowed to be bid on.

Example embodiments of the tournament structure described herein can be further illustrated by various particular examples of the various formats described herein. These examples of various embodiments are described below.

I. Tournament #1—Bidding Gauntlet

This fantasy football tournament is specifically designed for all four weeks of the NFL playoffs. The intent is to have a large chain of casinos host a tournament on several of their sites during the first weekend of the NFL playoffs and then shift to one location for the remainder of the postseason. This chain of casinos can invite up to 6,250 of their highest rollers to partake in this six round tournament that spans four weeks. The number of contestants involved at any given time is as follows:
Weekend #1 is wildcard weekend of the NFL playoffs. Up to 6,250 high rollers can be invited to play the first and second rounds at several sites. They would be invited to come to a casino site on a Friday night and participate in a selection process that lasts no more than 30 minutes (since the primary objective is for these high rollers to gamble on the casino premises for the weekend). All 6,250 high roller fantasy contestants then compete during Saturday in the first round of their tournament using the two scheduled NFL playoff games. By the end of Saturday night, 6,250 players are whittled down to 1,250. The remaining 1,250 are then invited to a new 30 minute selection process for the two Sunday NFL playoff games. Ideally they would draft Sunday morning, before the games, to keep them another night at the casino. By the end of Sunday's games, there will be 250 people left in the tournament.
Weekend #2 follows the exact same pattern as weekend #1. The NFL playoff games would shift to the divisional playoff round, but the high rollers fantasy football tournament still follows the same format—only with less people. At this juncture of the tournament, the 250 players remaining are invited to one casino to compete. After the 3^{rd} and 4^{th} rounds are completed during the divisional round, only 10 high rollers are left by Sunday night.
Weekend #3 is the conference championships for the NFL. The ten remaining high rollers are invited to one casino. Each one of them is guaranteed prize money for finishing in the top 10. To keep them in the casino all weekend, they will select athletes on Friday night and pick up their prize money on Sunday night. They must be at the casino Sunday night to receive their prize money. The rationale for keeping them so long is that their images are needed for marketing purposes and they need to be present to receive their checks so that they can be photographed.
Weekend #4—The top 2 remaining players compete head-to-head, at the casino, on Super Bowl Sunday. Their selection of athletes will be different than how athletes were selected in the first 3 rounds.

II. Style of Play for the First 5 Rounds
Players compete in groups of 10
The top 2 players in each group advance to the next round
The bottom 8 players in each group are eliminated and out of the tournament
Rd 1 includes the 2 Saturday Wildcard Games, Round 2 includes the 2 Sunday Wildcard Games, Round 3 includes the 2 Saturday Divisional Playoff Games, Round 4 includes the 2 Sunday Divisional Playoff Games and Round 5 includes the 2 conference championship games played on Sunday
Since each round has two NFL games, this means that there are four NFL teams competing per round. From each NFL team, contestants will have 1 QB, 1 RB, 2 WR's, 1 TE, 1K and 1 DEF in the pool of athletes available. This means there are 7 “athletes” from each NFL team—or 28 total from all four teams (since 4×7=28).
The best two available athletes from the four teams who are not part of the 28 will be added to the mix to give a grand total of 30 athletes to select from.
The 30 cards should be shown ahead of time to all contestants so that there is no doubt who all of the athletes are. This can be accomplished by giving them a list. The list should be removed from them once the blocs of 3 are introduced.
The fantasy football scoring system can be any popular format.
The key piece of this tournament is how contestants partake in a selection process.
Athletes are introduced three at a time which is called a “bloc”.
Athletes can only be secured in blocs of three. This is accomplished through a bidding process.
There are multiple factors to consider as athletes are revealed in blocs of 3 for bidding purposes. These factors are:
   1. Bids are made for the entire bloc of 3 athletes. The winning bidder gets all 3 athletes which will constitute their entire lineup.
   2. Athletes are weighted according to the order in which they are revealed to the bidders. The first revealed athlete from a given bloc of 3 is worth 3× the fantasy points of the winning bid. The second revealed athlete from a given bloc of 3 is worth 2× the fantasy points of the winning bid and the third revealed athlete is worth 1× the fantasy points of the winning bid
   3. Fantasy contestants must consider several factors when deciding whether to make a bid for a bloc. They must consider such things as a) the value of the positions (e.g., kickers aren't as valuable as quarterbacks), b) the weighted positions they fall into (a great player with a multiplier of 3× is much more desirable than if their multiplier is 1×) c) the potential bids their opponents might submit (this would be determined by the relative strength of the bloc of 3 athletes) and d) a key gaming aspect that automatically lowers the highest bid contestants can make for the next round by 5%. In other words, the highest possible bid for the next round will always be less than the possible highest bid for the current round (by 5% to be exact).

III. Selection Rules for First 5 Rounds
The process should take no more than 30 minutes per group
Ten fantasy contestants are seated at a table.
There is one deck of 30 cards with the pictures of the key 30 athletes competing in the 2 NFL playoff games for that round.
There are 9 rounds of bidding.
Since there are 10 contestants and only 9 rounds, the last remaining contestant gets what is left.
The cards are shuffled and the first 3 athletes are revealed for the first round of bidding. The first athlete revealed goes into the 3× multiplier slot, the second athlete revealed goes in the 2× multiplier slot and the third athlete revealed goes in the 1× multiplier slot.
For each round, the winning bid receives the entire bloc of 3 weighted athletes and this will constitute their entire lineup for their match. For this reason, contestants have to be certain that a given bloc is something that they actually want to bid on.
There are several factors that high roller contestants must consider when a) deciding whether to bid and b) how much to bid on a particular bloc of 3. They must simultaneously consider the following
   1. They must gauge the overall value of this bloc of three athletes as a unit.
   2. They must factor in the favorability/unfavorability of the multiplier slots individual athletes fell into.
   3. They must keep in mind that with each successive round, the highest allowable bid keeps going down 5% which potentially diminishes the value of these later blocs of athletes.
Again, contestants can choose to bid on the entire lot of three athletes or choose not to bid.
If nobody bids on a given lot of athletes, the bloc is placed on the side and will not be available again until the end of the selection process. A new lot of athletes is then placed down for bid. Since nobody bid on the prior lot, the same round is still in effect (for purposes of what the highest maximum bid can be).
Bids are made as a percentage bid for the entire bloc of athletes. This percentage bid accomplishes two things. First it determines if a contestant wins the bloc or not. The person with the lowest bid receives the bloc of 3 athletes. Secondly, this percentage bid also reflects the portion of fantasy points a contestant will receive for each athlete in their bloc during the actual fantasy football competition. For example, if the bloc of athletes included Tom Brady, Frank Gore and Steve Decker and the lowest bid (i.e., winning bid) was 79%, then the contestant who made that bid would get all three athletes in their lineup for the upcoming match at 79% of their fantasy points they scored in the match. These means that each of the three athletes are individually worth 79% of their fantasy points they score in their upcoming game.
To clarify this point further. When a contestant wins a bloc of athletes during the bidding process, the percentage they won the bloc with also becomes the percentage of fantasy points each athlete in their bloc receives. This percentage translates to the portion of an athlete's actual fantasy points scored during their NFL playoff game that a contestant is eligible to receive. This creates a balancing act of opposing goals as contestants want to bid a low enough percentage to win a bloc they are interested in securing while at the same time coveting the highest percentage bid possible. Once again, this is because the winning bid will also equal the percentage of fantasy points each athlete in the bloc will be eligible to receive from their actual fantasy points scored in the game.
Bids must always be made as a whole percent—no fractions/decimals.
Once a fantasy player wins a bid, their lineup is set and they cannot bid again.
If two or more fantasy contestants tie in their percentage bid—and it is the lowest bid of the group—the moderator will go from right to left and point to each fantasy player and ask for a lower bid. They can either give one or pass. If they pass, they are out of the bidding. The last one remaining gets the bloc of athletes at the percent they bid. If all pass on bidding, the bloc cannot be bid on again until all other blocs have been introduced.
Fantasy players must be very careful about being overly selective on what bloc they bid on because each new round automatically lowers the highest possible bid (by 5%) that can be made from the previous round.

The following are the highest possible bids allowed for each round in the bidding process in an example embodiment:

Round 1-100%

Round 2-95%

Round 3-90%

Round 4-85%

Round 5-80%

Round 6-75%

Round 7-70%

Round 8-65%

Round 9-60%

The last fantasy player without a bloc of three gets this group automatically at a highest possible bid of 55%.
If two or more blocs of 3 athletes have been passed on by the entire group, they will be reintroduced after all blocs have been revealed (i.e., the entire deck of cards has been revealed). The order that they are reintroduced is in the same order that they originally were introduced in the process.
At all times during this process, contestants have to make a snap decision based on four crucial factors. They are:
   1. The value of the positions that come up—a potential bid will have to consider different scenarios such as 2 quarterbacks (a more valued position) turning over in a bloc vs. 2 kickers(a less valued position).
   2. The value of the individual athletes—a potential bid will possibly change if the best quarterback (Peyton Manning) and the best running back (Marshawn Lynch) show up in a bloc vs. the worst quarterback (Alex Smith) and the worst running back (Danny Woodhead) show up together in a bloc.
   3. The value of where the athletes are slotted—A star athlete like Calvin Johnson will be much more desirable if he falls in the 3× multiplier slot than the 1× multiplier slot.
   4. The ongoing pressure of the maximum possible bid lowering with each successive round—A sense of urgency starts developing when a contestant is in the 4^{th} round and the highest bid they can now make has fallen from 100% in round 1 to currently 85% while keeping in mind that for the next round the highest allowable bid will fall further to 80%.

IV. Selection Rules for Round 6—Super Bowl Sunday

The final match is played between the last two standing during the Super Bowl. It is the only round not contested using group play. The match should implement the same fantasy scoring format that was used during the first five rounds. The number of athletes each contestant has in their lineup and the manner in which they are selected will change though. The Super Bowl selection format is as follows:
Fantasy players will select players on the night before the Super Bowl.
Fantasy players will select 1 QB, 2 RB, 2 WR, 1 TE, 1 DEF and 1 K
Submission rounds happen every 10 minutes.
There will be as many rounds as are needed so that both players have every lineup spot filled.
Fantasy players will submit an NFL athlete and a percentage for each open position of the 8 slots they have (they can submit any percentage from 1% to 100%). The percentage represents the percentage of fantasy points an NFL athlete earns that a contestant is willing to settle for in order to secure that athlete for their lineup. For example, if a fantasy player selects Tom Brady at 93% and they successfully win Brady for their lineup, they will only receive 93% of the fantasy points Brady scores for their game.
Football players submitted are compared. If a given athlete is submitted by only one of the contestants, this athlete is secured as one of the 8 for that contestant's lineup at the percentage of fantasy points they submitted them for.
If contestants select the same NFL athlete for a given position, then the person who submits the lower percentage for a given athlete will acquire that athlete for their lineup and their opponent loses out on them.
IF fantasy players select the same athlete and submit the same percentage for that athlete, then neither contestant gets that athlete. Both contestants can either bid on another athlete or the same athlete during the next round for that position.
If a contestant has a position completely filled and their opponent still has an opening (or two) for that position, then the contestant with openings can select any available athlete, who plays that position, for 100% of their fantasy points.
It is possible that one contestant has their entire lineup filled and their opponent does not. When this happens, the contestant with a lineup position(s) to fill can submit an NFL athlete(s) that is currently not in any lineup to fill this opening(s). They automatically secure this athlete(s) for 100% of their fantasy value.
If a contestant does not submit their lineup for a roster position(s) within the time constraints for a given round of bidding (during this 10 minute decision interval), their opponent automatically receives, by default, all of their athlete(s) at 100% of their fantasy value—even if they submitted a lower percentage for them.
Once all lineup positions are filled by both contestants, the selection process is completed.
Contestants can make lineup changes up to 1 hour before kickoff of the Super Bowl. They may select any NFL athlete that is not already in either contestant's lineup. If a contestant decides to make a lineup change, the percentage of fantasy points that the new athlete that they are substituting in will remain the same as the old athlete they are substituting out. The athlete that is pulled out of their lineup can be picked up by their opponent following the same guidelines of this rule.
Multi-level tiebreakers will be created to determine which contestants advance in the event of ties for all six rounds of this tournament.

II. Tournament #2—Fantasy Eliminator

The third weekend of the NFL playoffs consists of the two conference championship games. By this point, the “Bidding Gauntlet” tournament has only ten contestants remaining Since so few contestants remain, it creates the perfect opportunity to invite eliminated high rollers (as well as new invitees) back to play some more fantasy football. This new offering will occur at six different locations and will consist of a fast paced “Fantasy Eliminator” competition. This tournament can accommodate up to 7,776 contestants.

The tournament is broken into five rounds. For each of the five rounds, contestants are placed in groups of 6. The object is for contestants to win their group of 6 to advance to the next round. During the final round, which is played on Super Bowl Sunday, the six remaining players compete for cash prizes during the Big Game.

The five rounds can be scheduled in the following manner:

Round 1—1^{st} half of the first conference championship game (7,776 contestants)

Round 2—2^{nd} half of the first conf. championship game (1,296 remaining contestants)

Round 3—1^{st} half of the second conf. championship game (216 remaining contestants)

Round 4—2^{nd} half of the second conf. championship game (36 remaining contestants)

Round 5—Super Bowl Sunday (6 remaining contestants)

I. Game Rules—Creating Lineups—All 5 Rounds
Contestants are placed in groups of 6.
Contestants can select from the following positions: QB, RB, WR, TE, DEF and Kicker.
Contestants submit two lineups of 3 athletes—the second lineup is in case they advance far enough so that the second lineup is needed.
Contestants submit exactly three athletes (can include defenses) for the NFC Championship game and they will also submit three athletes (can include defenses) for the AFC championship game.
This submission process occurs on Friday night.
Duplication is permitted, but the more duplication that occurs for a given athlete, the less they will be worth.
There is a 20% penalty each time an athlete is duplicated. For example, if Tom Brady is selected by only one member of a group of 6, that contestant will receive Brady at 100% of his fantasy value. If two people in a group of 6 select Brady, both contestants will receive Brady in their respective lineups, but he will only be worth 80% of his fantasy points. If three people in a group of 6 select Brady, all three contestants will receive Brady in their respective lineups, but he will only be worth 60% of his fantasy points. This formula continues all to way to the possible scenario where everyone in the group potentially selects Brady. In that particular case, he would appear in every lineup, but he would be worth nothing.
Contestants can pick any combination of three athletes from either roster of NFL teams competing in a given conference title game. Contestants can have all of their athletes from the same NFL team or two from one team and one from the other.
Contestants can have athletes who play the same position.
Contestants can (and will) completely leave some positions vacant since there are more eligible football positions than athletes that they can start in their lineups.
Contestants can strategically select key backup athletes (instead of known starters) so that they can potentially be obtained for 100% of their fantasy points.
Each contestant will rank or slot their three selections. The top slotted athlete will be worth 3× the fantasy points they are eligible for (after duplication penalties are assessed). The second slotted athlete will be worth 2× the fantasy points they are eligible for (after duplication penalties are assessed). The third slotted athlete will be worth 1× the fantasy points they are eligible for (after duplication penalties are assessed).

II. Game Rules—Playing Out Rounds 1-4
Contestants are brought into the casino ballroom and seated at a table with their group of 6.
There is a running scoreboard of each high roller's group of 6 which also tells where they rank amongst the group.
Televisions will be showing the conference championship games throughout the ballroom.
A host will be walking around and monitoring the action at each table interviewing people—this is done in case the casino wants the event taped for a reality television opportunity. The reality television portion of this tournament can be given upon request to interested casinos.
Every 10 minutes (there will be clocks counting down so everyone can see), a horn will go off. When the horn goes off, the lowest scoring high roller at each table is eliminated and told to leave the ballroom—this gets them back out and gambling.
After 40 minutes, the top two remaining high rollers at each table are left and compete against one another without a clock until halftime.
The top player of each group advances to the next round which begins during the second half.
The other 5 members of each group are eliminated.
At halftime, advancing contestants are regrouped and placed in new groups of six. These new groups are not random and are instead predetermined via a bracket before the tournament started.
For the new groups contestants keep their same athletes in their same slotted positions that they had for the first half. However, the duplication penalties are recalibrated. This recalibration follows the same guidelines for duplication penalties—20% loss of fantasy points for each time an athlete is duplicated.
Statistics accumulated to score fantasy points do not start over again for the second half. The statistics and fantasy points corresponding to them are still in effect with the only difference being the recalibration for duplication potentially affecting them.
The same format used for the first half is used again for the second half. The final two contestants of each group continue competing until the conference title game is finished (this could include an overtime).
Advancing contestants move on to the 3^{rd} round—which happens to be the first half of the next conference championship game. Contestants are reconfigured in groups of six based on a predetermined bracket.
The athletes for the second game, whom contestants already selected on Friday night, are then revealed and duplication penalties are assessed.
The process remains the same for the 3^{rd} and 4^{th} rounds in the same manner that occurred during the first and second rounds.
By the end of the 4^{th} round, there will be exactly one winner in each of the six casinos. These six winners are invited back to compete against each other on Super Bowl Sunday.
During Super Bowl weekend, the six remaining contestants select three athletes playing in the Super Bowl. The selection process, duplication penalties, weighted slots and fantasy scoring methodology is the exactly the same as the first four rounds.
Fantasy Eliminator is not used for the final round. The six contestants compete for the entire Super Bowl game against one another without anyone getting kicked out.
At the end of the Super Bowl, the fantasy points determine the final positions and each contestant receives some type of pre-determined payout.
Multi-level tiebreakers will be created to determine which contestants advance in the event of ties for all five rounds of this tournament.

III. Tournament #3—Super Bowl Scramble
For this example, let's assume 3,000 high roller contestants are invited to a casino for the Super Bowl.
Selection process for athletes happens on the Friday before the Super Bowl.
Contestants select 4 athletes that are slotted. The first slotted athlete is worth 4× their fantasy point value. The second slotted athlete is worth 3× their fantasy point value. The third slotted athlete is worth 2× their fantasy point value. The fourth slotted athlete is worth 1× their fantasy point value.
An athlete's fantasy point value is a percentage of the fantasy points they score for the Super Bowl. This is determined by subtracting the percentage of the 3,000 contestants that selected a given athlete from 100%. For example, if Russell Wilson is selected by 2,237 of the contestants, this means Wilson was selected by 74.6% of the contestants. All 2,237 contestants will have Wilson in their lineups in the exact slotted position they each selected him for, but Wilson is only worth 100%−74.6%=25.4% of his fantasy points he scores in the Super Bowl.
All 3,000 contestants are placed in groups of 10. There are 300 groups of 10 seated at tables throughout the casino.
Fantasy eliminator rules are in effect.
A clock is set using 2 minute intervals to eliminate contestants.
The clock does not run during commercials.
A horn blows when the clock hits zero and the lowest scoring contestant is told to leave their table (A scoreboard at each table ranks where the contestants are in relationship to their group).
The last two contestants sitting at each table compete against one another until the first quarter ends.
For the second quarter, the remaining 300 contestants are placed in new groups of 10 that are predetermined by table placement throughout the casino.
The same process occurs for the 2^{nd} quarter of the Super Bowl.
By halftime, there are 30 contestants remaining
These 30 contestants are placed in 10 groups of three for the third quarter.
There is no “eliminator” piece that removes contestants during the third quarter. Contestants battle it out until the quarter has been completed.
The top finisher of each group of three moves on to the 4^{th} quarter.
By the 4^{th} quarter, there are 10 contestants remaining
Fantasy eliminator is back in place for the 4^{th} quarter using the exact same rules for the first two quarters.
Last one standing is declared the winner. Cash prizes paid out to the 10 who made it to the 4^{th} quarter.
Multi-level tiebreakers will be created to determine which contestants advance in the event of ties at any juncture of this tournament.

As described herein for various example embodiments, an embodiment can support the concept of playing multiple rounds in one day by submitting one lineup that will be used for two or more groups. Each group this lineup is submitted for will be considered a separate and distinct round. The rounds will be numerically sequenced and the lowest numbered round for which the contestant does not meet the criteria to advance will be considered the round in which they were eliminated.

As described herein for various example embodiments, an embodiment can support the concept of bidding on fantasy athletes in blocs of two or more by bidding for a percentage of their fantasy points that they score. For example, if three athletes are bid on at 94%, this means that if the bid is a winning bid, these three athletes are all secured for the contestant and the contestant will receive 94% of the fantasy points that each athlete scores for the round.

As described herein for various example embodiments, an embodiment can support the concept of decreasing (or increasing) the maximum allowable bid for an athlete's fantasy points for a given round of bidding. For example, for a seven round bidding format, the highest allowable bid might decrease in increments of 7% for each passing round.

As described herein for various example embodiments, an embodiment can support the concept of eliminating one or more contestants during a round for not having met a certain point threshold or for being ranked at or near the bottom of a grouping of contestants when the time period is up. This is called “Fantasy Eliminator”.

As described herein for various example embodiments, an embodiment can support the concept where contestants can play in a daily fantasy sports group format structure for as many rounds as they desire (unless the tournament organizer establishes a maximum number of rounds). At the end of each round, the contestant can decide whether they want to collect their money or let it carry over to another round where they will get an even bigger prize if they finish in “winning” positions (for example finishing in the top 3 out of their group of 12 for a structure that declares the first three positions as winning spots).

As described herein for various example embodiments, an embodiment can support the concept of “Minimum Threshold” for a group of contestants. This means that contestants must meet a minimum threshold to advance to the next round and that the remaining contestants in the group or field are eliminated. The eliminated contestants must always exceed the number of advancing contestants. In other words, the eliminated participants must always represent more than 50% of the field of contestants at any given time. This implies that a group of contestants must finish in a predetermined position compared to the rest of the field to advance. For example, it could be determined that the top 30% of the scores advance (meaning that the bottom 70% do not advance). This method can involve a small group of less than 10 contestants all the way up to a large group totaling in the thousands or millions.

As described herein for various example embodiments, an embodiment can support the concept of “Slotting Positions with a Percentage Value”. This is where a contestant submits a lineup and ranks the athletes in order of preference; because, the order in which they are ranked determines the fantasy point value for a given athlete. For example, the top slated athlete a contestant submits might be worth 100% of the fantasy points that they score, the second slotted athlete might receive 95% of their fantasy points that they score, the third slotted athlete 90% etc.

It will be apparent to one of ordinary skill in the art in view of the disclosure herein that other concepts described herein can also be implemented in particular embodiments. It will also be apparent to one of ordinary skill in the art in view of the disclosure herein that the various concepts and features described herein can be combined in various permutations in particular embodiments.

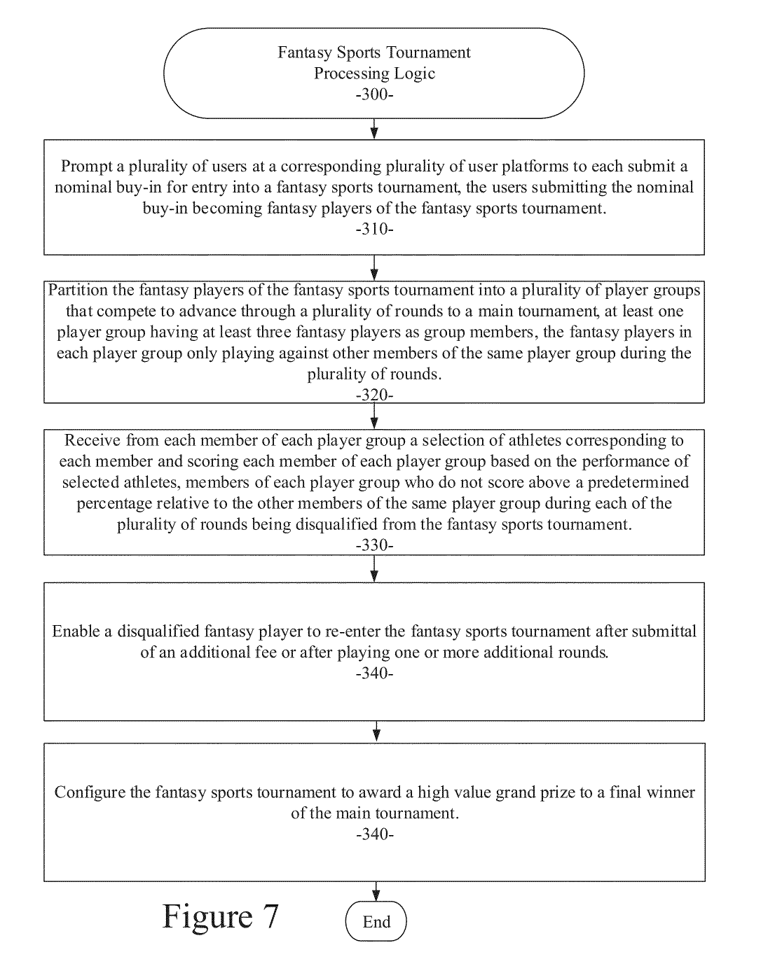

FIG. 7 is a processing flow diagram illustrating an example embodiment of systems and methods for conducting fantasy sports tournaments as described herein. The method of an example embodiment includes: prompting a plurality of users at a corresponding plurality of user platforms to each submit a nominal buy-in for entry into a fantasy sports tournament, the users submitting the nominal buy-in becoming fantasy players of the fantasy sports tournament (processing block 310); partitioning, by execution of the data processor, the fantasy players of the fantasy sports tournament into a plurality of player groups that compete to advance through a plurality of rounds to a main tournament, at least one player group having at least three fantasy players as group members, the fantasy players in each player group only playing against other members of the same player group during the plurality of rounds (processing block 320); receiving from each member of each player group a selection of athletes corresponding to each member and scoring each member of each player group based on the performance of selected athletes, members of each player group who do not score above a predetermined percentage relative to the other members of the same player group during each of the plurality of rounds being disqualified from the fantasy sports tournament (processing block 330); enabling a disqualified fantasy player to re-enter the fantasy sports tournament after submittal of an additional fee or after playing one or more additional rounds (processing block 340); and configuring the fantasy sports tournament to award a high value grand prize to a final winner of the main tournament (processing block 350).

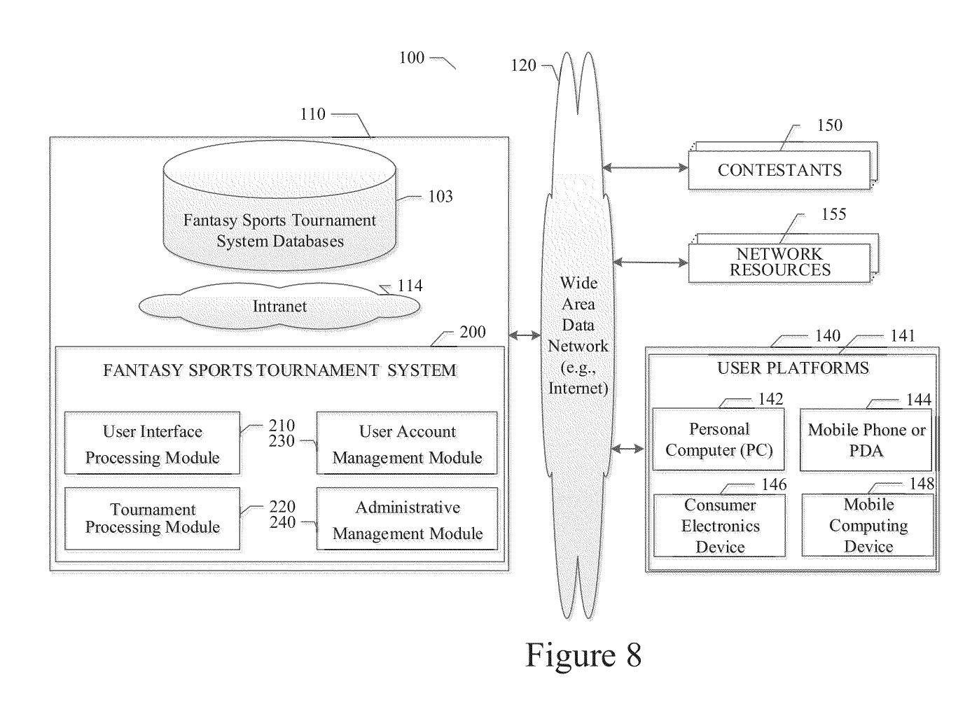

FIG. 8 illustrates an example embodiment 100 of a fantasy sports tournament system 200 in a network-enabled environment. Referring now to FIG. 8, in an example embodiment, the network-enabled fantasy sports tournament system environment 100 is disclosed. In various example embodiments, an application or service, typically provided by or operating on a host site (e.g., a website) 110, is provided to simplify and facilitate the downloading or hosted use of the fantasy sports tournament system 200 of an example embodiment. In a particular embodiment, the fantasy sports tournament system 200, or a portion thereof, can be downloaded from the host site 110 by a user at a user platform 140. Alternatively, the fantasy sports tournament system 200 can be hosted by the host site 110 for a networked user at a user platform 140. The details of the fantasy sports tournament system 200 of an example embodiment are provided herein.

Referring again to FIG. 8, the fantasy sports tournament system 200 can be in network communication with a plurality of user platforms 140. The host site 110 and user platforms 140 may communicate and transfer data and information in the data network environment 100 shown in FIG. 8 via a wide area data network (e.g., the Internet) 120. Various components of the host site 110 can also communicate internally via a conventional intranet or local area network (LAN) 114.

In an example embodiment, the fantasy sports tournament system 200 can also be in network communication with a plurality of contestants 150 and a plurality of network resources 155. Contestants 150 can represent the network locations of clients or client computing systems being managed by contestants, teams, tournament players, or other client users operating an embodiment described herein. For example, in a particular embodiment of the fantasy sports tournament platform as shown in FIG. 8, contestants 150 can represent the network locations of clients or client computing systems of tournament participants, contestants, teams, tournament players, brokers, dealers, agents, or the like. Contestants 150 can interact with the user interface provided by the fantasy sports tournament system 200 to participate in the fantasy sports tournament. Network resources 155 can represent the network locations of sources of information related to the fantasy sports tournament, such as team or athlete information, document sources, photos, maps, reviews, statistics, venue information, publications, articles, or other related information associated with the fantasy sports tournament of the example embodiment.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through an Ethernet port or a universal serial bus (USB) port, other forms of computer-readable media, or any combination thereof. On an interconnected set of LANs, including those based on differing architectures and protocols, a router and/or gateway device can act as a link between LANs, enabling messages to be sent between computing devices. Also, communication links within LANs may include optical fiber data lines, twisted wire pairs or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), optical fiber, wireless links including satellite links, or other communication links known to those of ordinary skill in the art. Furthermore, remote computers and other related electronic devices can be remotely connected to either LANs or WANs via a wireless link, WiFi, BLUETOOTH, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to be moved freely and randomly and to organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The fantasy sports tournament system in various example embodiments can be implemented using any form of network transportable digital data. The network transportable digital data can be transported in any of a group of data packet or file formats, protocols, and associated mechanisms usable to enable a host site 110 and a user platform 140 to transfer data over a network 120. In one embodiment, the data format for the user interface can be HyperText Markup Language (HTML). HTML is a common markup language for creating web pages and other information that can be displayed in a web browser. In another embodiment, the data format for the user interface can be Extensible Markup Language (XML). XML is a markup language that defines a set of rules for encoding interfaces or documents in a format that is both human-readable and machine-readable. In another embodiment, a JSON (JAVASCRIPT Object Notation) format can be used to stream the interface content to the various user platform 140 devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML. The Hypertext Transfer Protocol (HTTP) or secure HTTP (HTTPS) can be used as a network data communication protocol.

In a particular embodiment, a user platform 140 with one or more client devices 141 enables a user to access data and provide data and/or instructions for the fantasy sports tournament system 200 via the host 110 and network 120. Client devices 141 may include virtually any computing device that is configured to send and receive information over a data network, such as network 120. Such client devices 141 may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and many lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JAVASCRIPT, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive content data or/or control data from another computing device via a wired or wireless network transmission. The client application may include a capability to provide and receive textual data, graphical data, video data, audio data, and the like. Moreover, client devices 141 may be further configured to communicate and/or receive a message, such as through an email application, a Short Message Service (SMS), direct messaging (e.g., TWITTER), Multimedia Message Service (MMS), instant messaging (IM), internet relay chat (IRC), mIRC, JABBER, Enhanced Messaging Service (EMS), text messaging, Smart Messaging, Over the Air (OTA) messaging, or the like, between another computing device, and the like.

As one option, the fantasy sports tournament system 200, or a portion thereof, can be downloaded to a user device 141 of user platform 140 and executed locally on a user device 141. The downloading of the fantasy sports tournament system 200 application (or a portion thereof) can be accomplished using conventional software downloading functionality. As a second option, the fantasy sports tournament system 200 can be hosted by the host site 110 and executed remotely, from the user's perspective, on host system 110. In one embodiment, the fantasy sports tournament system 200 can be implemented as a service in a service-oriented architecture (SOA) or in a Software-as-a-Service (SAAS) architecture. In any case, the functionality performed by the fantasy sports tournament system 200 is as described herein, whether the application is executed locally or remotely, relative to the user.

Referring again to FIG. 8, the host site 110 of an example embodiment is shown to include a fantasy sports tournament system database 103. The network-accessible central database 103 is used in an example embodiment for data storage of tournament data, player or contestant data, group data, award or prize data, configuration data, scheduling data, reporting data, and the like. Database 103 can be in data communication with the fantasy sports tournament system 200 directly or via intranet 114. It will be apparent to those of ordinary skill in the art that the database 103 can represent multiple datasets and can be used for the storage of a variety of data in support of the fantasy sports tournament system 200 of an example embodiment.

Referring again to FIG. 8, host site 110 of an example embodiment is shown to include the fantasy sports tournament system 200. The fantasy sports tournament system 200 can include a User Interface Processing Module 210, a Tournament Processing Module 220, a User Account Management module 230, and an Administrative Management module 240. Each of these modules can be implemented as software components executing within an executable environment of the fantasy sports tournament system 200 operating wholly or in part on host site 110 or user platform 140. Each of these modules of an example embodiment is described in more detail herein in connection with the figures provided herein.

Referring again to FIG. 8, the fantasy sports tournament system 200 of an example embodiment is shown to include a User Interface Processing Module 210. The User Interface Processing Module 210 is responsible for receiving input from a user, tournament player, contestant, team, or a network-connectable device, the input corresponding to the selections, parameters, commands, or other tournament inputs received from a contestant 150, and for displaying tournament data to a user, tournament player, contestant, team, or other client user via any of the user interface platforms 141 described above. From the contestants 150, the User Interface Processing Module 210 can receive their contestant-specific information, athlete or fantasy player selections, and other contestant information associated with the tournament and particular rounds in which the contestant is playing. The details of the interactions between the contestants in the tournament are described in more detail above. This contestant-related information can be used to create contestant status records for each contestant of a plurality of contestants 150. The contestant status records can be retained in the network-accessible central data repository 103 and shared with the Tournament Processing Module 220.

Referring again to FIG. 8, the fantasy sports tournament system 200 of an example embodiment is shown to include a Tournament Processing Module 220. The Tournament Processing Module 220 is responsible for managing the operation of the fantasy sports tournament and the plurality of rounds played therein. The Tournament Processing Module 220 manages the groups of contestants in the tournament, calculates contestant standings, records contestant statistics, promotes winning contestants to advanced rounds, and determines the overall winner of the tournament. The Tournament Processing Module 220 can also provide notifications to contestants of the tournament. The details of the tournament operation, the provisioning of contestant groups, the management of multi-contestant rounds, and the management of contestants in the tournament are described in more detail above.

Referring again to FIG. 8 and as described above, a user platform 141 can include a mobile device on which a mobile application (app) can be executed. An example embodiment, implemented as a mobile device app, can be used to support a mobile device user interface for the fantasy sports tournament system 200 of an example embodiment. It will be apparent to those of ordinary skill in the art that other embodiments can also be implemented as a web application (app) with one or more webpages or other types of user interfaces. A mobile version of an example embodiment provides a user-friendly interface from which the user can easily view the relevant contestant/client information from a mobile device. As described in more detail herein, a mobile software application (app) embodying a mobile version of an example embodiment as described herein can be installed and executed on a mobile device, such as a smart phone, laptop computer, tablet device, or the like. In an example embodiment, a splash screen appears whenever the user opens or launches the mobile application on the mobile device. This splash screen can display a host logo and wallpaper image while opening the login screen or a live feed of processed client information.

User log-in functionality in the web application or the mobile app provides a user-friendly user interface in which the user can provide identifying information (e.g., an email address and password) associated with the user account. If the user does not have an account, the user can create an account from this user interface. The process of creating a user account in an example embodiment only requires the user to provide the identifying information (e.g., name, surname, e-mail address, and password). By completing this information, the user can create an account and get access to tournament and contestant information.

Referring again to FIG. 8, the fantasy sports tournament system 200 of an example embodiment is also shown to include a user account management module 230. The user account management module 230 can be used to create and maintain a user account on the host site 110. The user account management module 230 can also be used to configure user settings, create and maintain a client/user profile on host site 110, and otherwise manage user data and operational parameters on host site 110. In the example embodiment described herein, a user can register as an identified contestant in order to share tournament information, receive tournament information and communications, or interact with other tournament-related content or other contestants. The registered user can enter their identifying information during a log-in phase and thereafter can share tournament-related content and interact with other tournament contestants.

Referring again to FIG. 8, the fantasy sports tournament system 200 of an example embodiment is shown to include an administrative management module 240. The administrative management module 240 can be used by an agent or administrator of the fantasy sports tournament system 200 to manage user accounts, configure system features, and to manage the operation and configuration of the fantasy sports tournament system 200. The administrative management module 240 can also be used to enforce privacy protections and tournament controls for contestants. Moreover, the administrative management module 240 can also be used to generate and/or process a variety of analytics associated with the operation of the fantasy sports tournament system 200. For example, the administrative management module 240 can generate various statistical models that represent the activity of the community of contestants throughout the fantasy tournament. These analytics can be shared, licensed, or sold to others.

Although the various user interface displays provided by the example embodiments described herein are nearly infinitely varied, the descriptions of the user interface displays and sequences are provided herein to describe various features of the disclosed embodiments. These user interface displays and sequences are described herein with reference to example embodiments. It will be apparent to those of ordinary skill in the art in view of the disclosure herein that equivalent user interface displays and sequences can be implemented within the scope of the inventive subject matter disclosed and claimed herein.

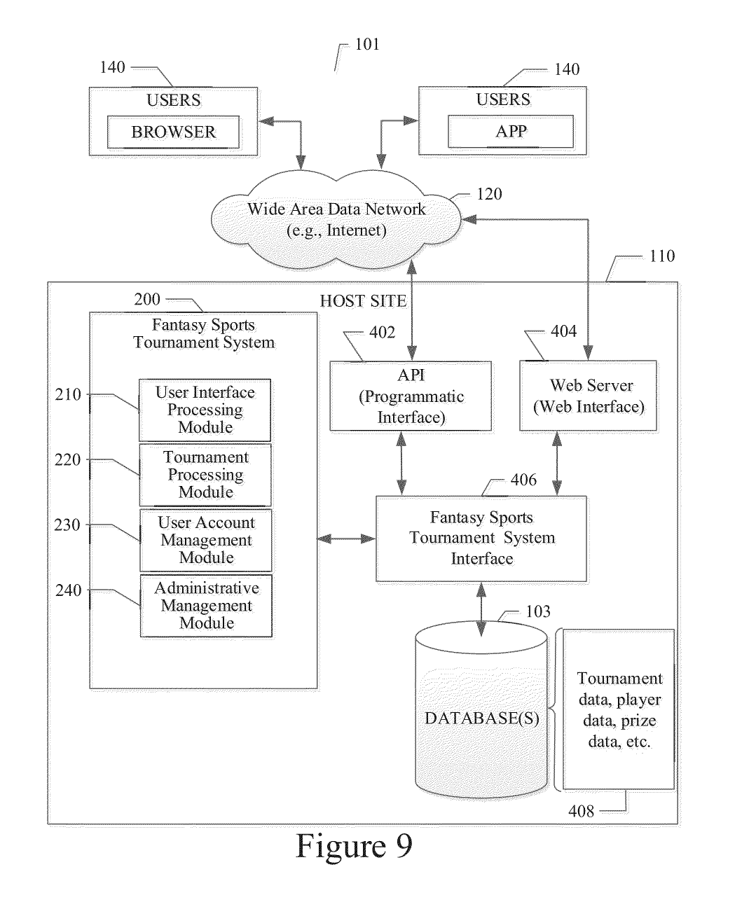

Referring now to FIG. 9, another example embodiment 101 of a networked system in which various embodiments may operate is illustrated. In the embodiment illustrated, the host site 110 is shown to include the fantasy sports tournament system 200. The fantasy sports tournament system 200 is shown to include the functional components 210 through 240, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The API 402 and web interface 404 may be configured to interact with the fantasy sports tournament system 200 either directly or via an interface 406. The fantasy sports tournament system 200 may be configured to access a data storage device 103 and data 408 therein either directly or via the interface 406.

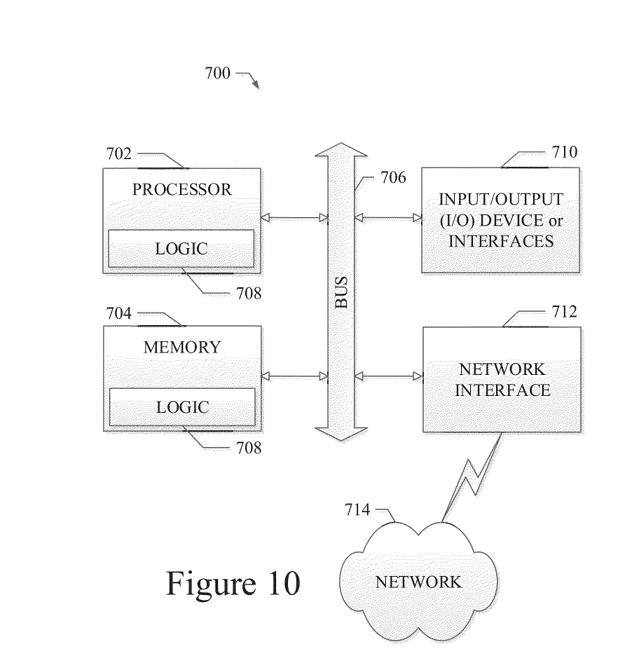

FIG. 10 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, BLUETOOTH, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

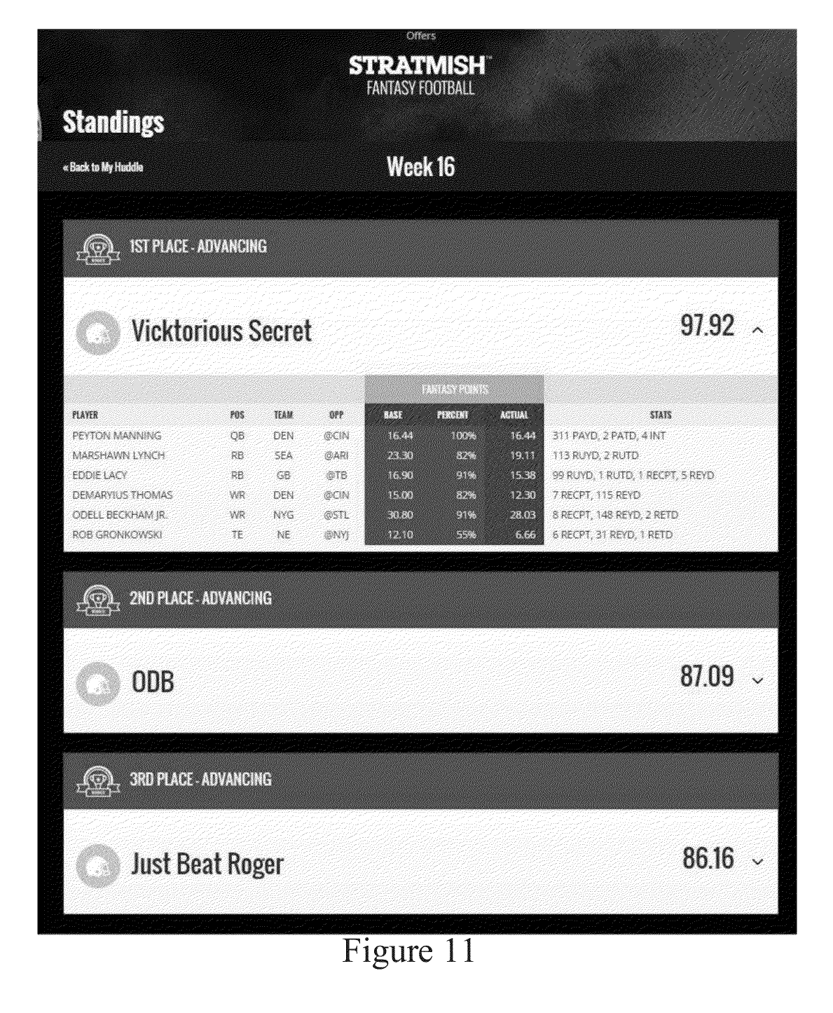

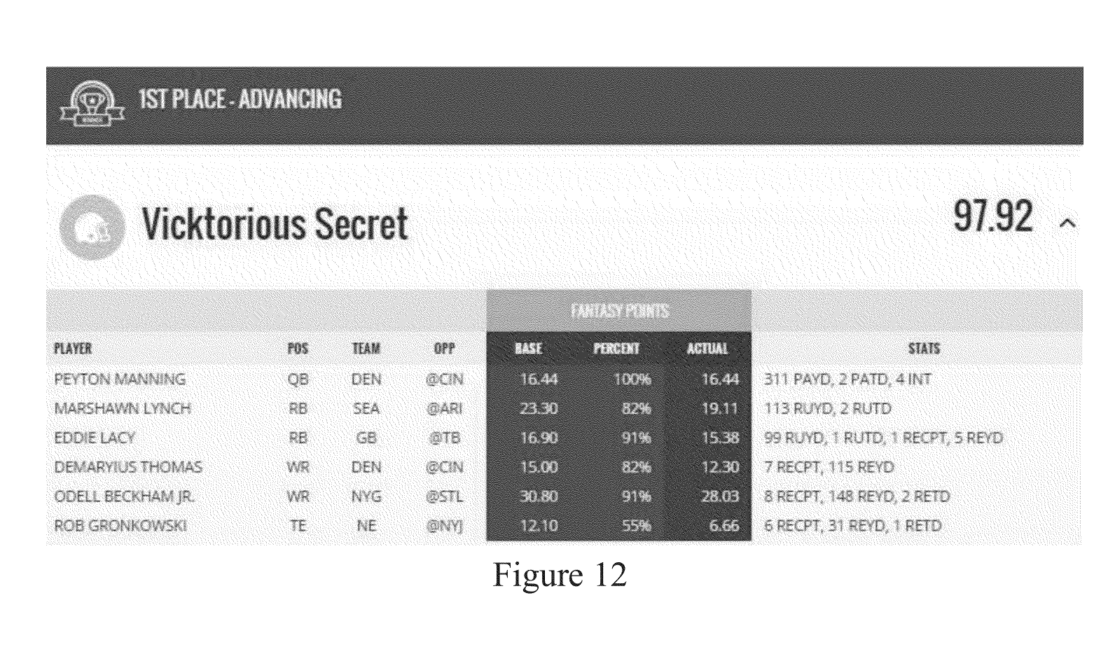

FIGS. 11 through 14 illustrate an example embodiment, implemented as a web application (app), which shows the basic elements of the user interface as screenshots for implementing a fantasy sports tournament with multi-contestant small group rounds. Referring now to FIGS. 11 and 12, screenshots of the user interface for an example embodiment show how a fantasy player's value decreases the more duplication that occurs for a given fantasy player selected by a plurality of contestants.

FIG. 11 in the illustrated example shows the standings for the top three contestants in a particular round of the sample fantasy football tournament. In this example, the top contestant is identified as “Vicktorious Secret.” The second place contestant is identified as “ODB.” The third place contestant is identified as “Just Beat Roger.” It will be apparent to those of ordinary skill in the art that contestants can be identified by any unique name.

Referring now to FIG. 12, in the example embodiment, the fantasy player selections for contestant “Vicktorious Secret” are shown. In this example, each fantasy player's value is denoted by a percentage score shown in the “Percent” column illustrated in FIG. 12. The lower the percentage, the more duplication has occurred for the corresponding fantasy player and the less their fantasy points are worth. This is because the percentage shown literally represents the percentage of the fantasy points a contestant receives based on the actual fantasy points their athlete scores. For example, this percentage of points that the owner of the “Vicktorious Secret” team gets to keep for each one of their athletes in this example is denoted in the “Fantasy Points” display area under the heading of “Percent” as shown in FIG. 12. In that same “Fantasy Points” display area, the number of fantasy points allocated before an adjustment is made is denoted under the “Base” column. This column represents the number of points that a given athlete scored in their real life fantasy sports contest. The adjusted fantasy point total is denoted under the “Actual” column. These values are determined by multiplying the points a given athlete scored by the percentage that the fantasy player is worth for a given contestant.

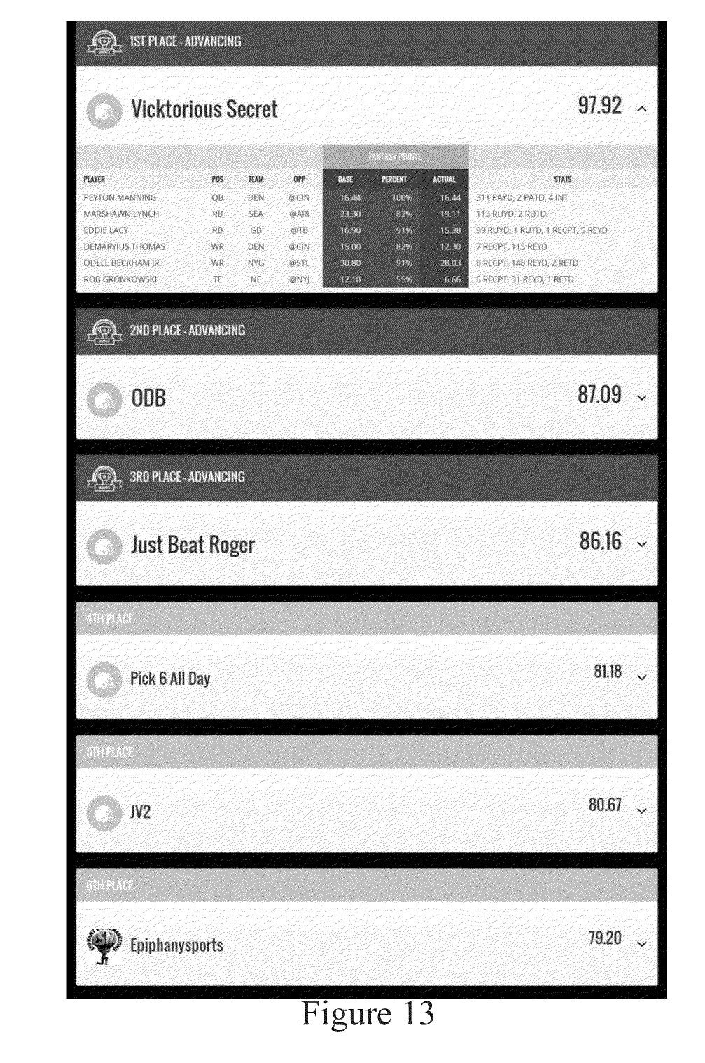

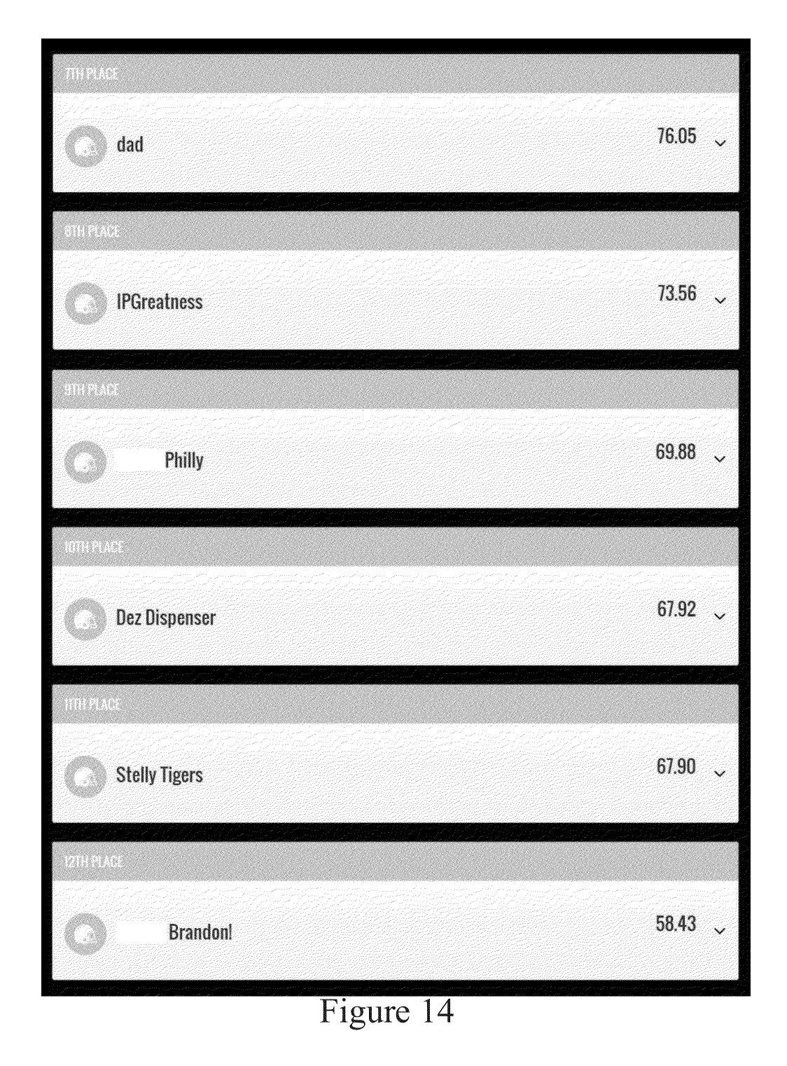

Referring now to FIGS. 13 and 14, sample user interface screenshots depict how an example embodiment of the fantasy sports tournament as described herein can enable a plurality of contestants to compete in the same contest at the same time. In particular, the example embodiment can enable two or more contestants, three or more contestants, or many contestants to compete among each other in the same contest or round at the same time. The fantasy sports tournament contestants in an example embodiment can be placed together in a small group and allowed to compete in the same group among all members of the group at the same time. The fantasy sports tournament system of the example embodiment can run a plurality of small groups at the same time. Thus, the tournament can be partitioned into a plurality of small groups, wherein each small group can comprise a plurality (e.g., two or more or three or more, etc.) of contestants in each group where the contestants in each group play among all members of the same group at the same time. Conventional tournament systems do not provide this capability. As shown in FIGS. 13 and 14, the sample screenshots illustrate an example round in the fantasy sports tournament of an example embodiment where more than two teams/contestants can compete among each other in the same contest at the same time. FIGS. 13 and 14 illustrate an example where there are twelve contestants competing against one another in the current round of the tournament at the same time. The final scores for each contestant are tabulated to the nearest hundredth and shown to the right of the name of the corresponding contestant. In this sample case, the top three contestants advance to the next round of the tournament while the bottom nine contestants are eliminated. This sample competition shows that the top three finishers in this example contest were: “Vicktorious Secret”, “ODB” and “Just Beat Roger.” Thus, the fantasy sports tournament system of an example embodiment enables small group competitions among multiple contestants at the same time. These examples illustrate how the various embodiments disclosed herein run counter to the traditional thinking that contestants must be paired in one-on-one matches like they are in real life sports where one team plays against another team as they do in baseball, basketball, hockey, football, soccer, etc. This novel approach provided by the example embodiments disclosed herein enables multiple contestants to compete against each other in the same round at the same time and enables the top finishers in the round to advance to the next round. As such, the various embodiments described herein provide a fantasy sports tournament structure that has not existed before.

In various embodiments as described herein, example embodiments include at least the following examples.

A non-transitory machine-useable storage medium embodying instructions which, when executed by a machine, cause the machine to: prompt a large number of users at a corresponding large number of user platforms to each submit a nominal buy-in for entry into a fantasy sports tournament, the users submitting the nominal buy-in becoming fantasy players of the fantasy sports tournament; partition the fantasy players of the fantasy sports tournament into player groups denoted rings, wherein players compete to advance through a pre-determined number of rounds to a main tournament, at least one player ring having at least three fantasy players as ring members, the fantasy players in each player ring only playing against other members of the same player ring during a given round; receive from each member of each player ring a selection of athletes corresponding to each member and scoring each member of each player ring based on the performance of selected athletes, members of each player ring who do not score within a predetermined number of advancing players for their given ring relative to the other members of the same player ring are disqualified from the fantasy sports tournament; enable a disqualified fantasy player to re-enter the fantasy sports tournament after submittal of an additional fee by either: a) paying the same fee again which requires playing one or more additional rounds to catch up to the number of rounds other players have played, or b) paying an additional fee to bypass rounds that have already been played; and configure the fantasy sports tournament to include rings.

The non-transitory machine-useable storage medium as claimed above wherein the fantasy sports tournament is a player skill based tournament. A player skill based tournament requires that no more than 10 people can compete for one advancing position at any given time.

The non-transitory machine-useable storage medium as claimed above wherein the fantasy sports tournament does not include a trap round. A trap round based tournament format always has stages in the tournament where at least 100 people compete in the same round against one another for only one advancing position.

The non-transitory machine-useable storage medium as claimed above wherein the fantasy sports tournament being further configured to include both regular season and post season play. Prior examples have featured regular season only tournaments or post season only tournaments. There has never been an example that has used both the regular season and post season in the same tournament.

The non-transitory machine-useable storage medium as claimed above wherein the fantasy sports tournament being further configured to include a scramble rounds format. This format requires a player to advance a certain number of predetermined consecutive rounds. The criteria for advancement is also predetermined and doesn't necessarily require a player to win the round to advance.

The non-transitory machine-useable storage medium as claimed above wherein the fantasy sports tournament being further configured to include a player certification system.

The non-transitory machine-useable storage medium as claimed above wherein the fantasy sports tournament being further configured to support the playing of multiple rounds in one day by submitting one lineup used for two or more groups, each group for which the lineup is submitted being considered a separate and distinct round, each round being numerically sequenced and the lowest numbered round for which a contestant does not meet pre-determined criteria to advance being considered the round in which the contestant is eliminated.

The non-transitory machine-useable storage medium as claimed above wherein the fantasy sports tournament being further configured to support bidding on fantasy athletes in blocs of two or more by bidding for a percentage of the fantasy points that the fantasy athletes score.

The non-transitory machine-useable storage medium as claimed above wherein the fantasy sports tournament being further configured to support decreasing or increasing the maximum allowable bid for an athlete's fantasy points for a given round of bidding.

The non-transitory machine-useable storage medium as claimed above wherein the fantasy sports tournament being further configured to support eliminating one or more contestants during a round for not having met a certain point threshold or for being ranked at or near the bottom of a grouping of contestants when a pre-determined time period expires.

The non-transitory machine-useable storage medium as claimed above wherein the fantasy sports tournament being further configured to support contestants playing in a daily fantasy sports group format structure for as many rounds as they desire. If they have a score that meets the criteria for advancement (as opposed to one where they are eliminated), the have two options. They can either withdraw and claim their prize or they can advance to another round with a better prize at stake.

The non-transitory machine-useable storage medium as claimed above wherein the fantasy sports tournament being further configured to support a minimum threshold for a group of contestants (it can be a very large group of thousands or even millions), wherein contestants must meet the minimum threshold to advance to the next round and the remaining contestants in the group are eliminated. This minimum threshold has pre-determined benchmarks that competing players must meet in order to advance. This format requires that players must perform better than average for some or all of the rounds. Performing better than average is defined by requiring that more than half of the competitors are eliminated at one time. At the same time, it also requires that the skill based requirement is observed. This means that anytime players are grouped together in competition, there will be at least one advancing position available for every ten competitors. For example, a tournament might require players to finish in the top 30% of some rounds to advance to the next.

The non-transitory machine-useable storage medium as claimed above wherein the fantasy sports tournament being further configured to support slotting positions with a percentage value.

The non-transitory machine-useable storage medium as claimed above wherein the fantasy sports tournament being further configured to support additional rounds in a condensed period of time by either splitting different live action sports games into multiple rounds during the same day (wildcard format) or splitting the same live action sports game into multiple rounds (super wildcard format).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

### APPENDIX

TABLE 1
Qualifying Tournaments
Example Based on the 2012 NFL Football Season

| | Qualifier | Qualifier | Qualifier | Qualifier | Qualifier | Qualifier | Qualifier | Qualifier | Qualifier |
|---|---|---|---|---|---|---|---|---|---|
| | #1 | #2 | #3 | #4 | #5 | #6 | #7 | #8 | #9 |
| Rounds | 9 | 8 | 7 | 6 | 5 | 4 | 3 | 2 | 1 |
| Week 1 | Round 1 | — | — | — | — | — | — | — | — |
| | Sept 9 | | | | | | | | |
| Week 2 | Round 2 | Round 1 | — | — | — | — | — | — | — |
| | Sept 16 | Sept 16 | | | | | | | |
| Week 3 | Round 3 | Round 2 | Round 1 | — | — | — | — | — | — |
| | Sept 23 | Sept 23 | Sept 23 | | | | | | |
| Week 4 | Round 4 | Round 3 | Round 2 | Round 1 | — | — | — | — | — |
| | Sept 30 | Sept 30 | Sept 30 | Sept 30 | | | | | |
| Week 5 | Round 5 | Round 4 | Round 3 | Round 2 | Round 1 | — | — | — | — |
| | Oct 7 | Oct 7 | Oct 7 | Oct 7 | Oct 7 | | | | |
| Week 6 | Round 6 | Round 5 | Round 4 | Round 3 | Round 2 | Round 1 | — | — | — |
| | Oct 14 | Oct 14 | Oct 14 | Oct 14 | Oct 14 | Oct 14 | | | |
| Week 7 | Round 7 | Round 6 | Round 5 | Round 4 | Round 3 | Round 2 | Round 1 | — | — |
| | Oct 21 | Oct 21 | Oct 21 | Oct 21 | Oct 21 | Oct 21 | Oct 21 | | |
| Week 8 | Round 8 | Round 7 | Round 6 | Round 5 | Round 4 | Round 3 | Round 2 | Round 1 | — |
| | Oct 28 | Oct 28 | Oct 28 | Oct 28 | Oct 28 | Oct 28 | Oct 28 | Oct 28 | |
| Week 9 | Round 9 | Round 8 | Round 7 | Round 6 | Round 5 | Round 4 | Round 3 | Round 2 | Round 1 |
| | Nov 4 | Nov 4 | Nov 4 | Nov 4 | Nov 4 | Nov 4 | Nov 4 | Nov 4 | Nov 4 |

TABLE 2
Qualifying Tournament Caps for Groups of 12
Top 3 in Each Group Advance per Round
Playing for 4,096 Available Main Event Seats

| | | Cap (# of entries | # of Main Event |
|---|---|---|---|
| | # of Rounds | allowed) | Seats |
| Qualifier #1 | 9 | 272,105,472** | 1,038 |
| Qualifier #2 | 8 | 53,477,376 | 816 |
| Qualifier #3 | 7 | 11,698,176 | 714 |
| Qualifier #4 | 6 | 2,088,960 | 510 |
| Qualifier #5 | 5 | 313,344 | 306 |
| Qualifier #6 | 4 | 52,224 | 204 |
| Qualifier #7 | 3 | 13,056 | 204 |
| Qualifier #8 | 2 | 1,632 | 102 |
| Qualifier #9 | 1 | 408 | 102 |
| Direct Entry to | — | 100 | 100 |
| Main Event* | | | |
| Totals | | 339,750,748 | 4,096 |

*Fantasy player does not have to qualify via a satellite tournament and goes directly into the Main Event.
**To calculate the cap for Qualifier #1, a decision must be made on how many of the 4,096

Main Event seats will be assigned to this particular qualifier. The number 1,038 has arbitrarily been selected. Because three of the twelve fantasy players advance from each group, this is a 4 to 1 ratio, which can be written as 4/1, which equals 4. Now raise this number 4 to the power of how many rounds the round has. In this case, satellite #1 has 9 rounds. The number 4 raised to the power of 9 equals 262,144. This means that 262,144 fantasy players compete over 9 rounds for one Main Event seat. Because there are 1,038 Main Event seats that we arbitrarily assigned to Qualifier #1, this means 262,144 times 1,038 is the number of fantasy players that can play in Qualifier #1. This number comes out to 272,105,472, which is why the cap was set on this number.

TABLE 3
Percentage of Fantasy Points an Athlete Keeps based on Duplication

| Number of | | | | | | | | | | |
|---|---|---|---|---|---|---|---|---|---|---|
| players | | | | | | | | | | |
| in the fantasy | | | | | | | | | | |
| match | 1X* | 2X | 3X | 4X | 5X | 6X | 7X | 8X | 9X | 10X |
| 4 | 100% | 67% | 33% | 0% | NA | NA | NA | NA | NA | NA |
| 5 | 100% | 75% | 50% | 25% | 0% | NA | NA | NA | NA | NA |
| 6 | 100% | 80% | 60% | 40% | 20% | 0% | NA | NA | NA | NA |
| 7 | 100% | 83% | 67% | 50% | 33% | 17% | 0% | NA | NA | NA |
| 8 | 100% | 86% | 72% | 58% | 43% | 28% | 14% | 0% | NA | NA |
| 9 | 100% | 87% | 75% | 62% | 50% | 38% | 25% | 13% | 0% | NA |
| 10 | 100% | 89% | 78% | 67% | 56% | 45% | 34% | 23% | 12% | 0% |
| 11 | 100% | 90% | 80% | 70% | 60% | 50% | 40% | 30% | 20% | 10% |
| 12 | 100% | 91% | 82% | 73% | 64% | 55% | 46% | 37% | 28% | 19% |
| 13 | 100% | 92% | 84% | 75% | 67% | 59% | 50% | 42% | 34% | 25% |
| 14 | 100% | 92% | 84% | 77% | 69% | 61% | 54% | 46% | 38% | 31% |
| 15 | 100% | 93% | 86% | 79% | 72% | 65% | 58% | 51% | 44% | 36% |
| 16 | 100% | 93% | 86% | 80% | 73% | 66% | 60% | 53% | 46% | 40% |
| 17 | 100% | 94% | 88% | 82% | 75% | 69% | 63% | 57% | 50% | 44% |
| 18 | 100% | 94% | 88% | 82% | 76% | 70% | 64% | 58% | 53% | 47% |
| 19 | 100% | 94% | 89% | 83% | 78% | 72% | 67% | 61% | 56% | 50% |
| 20 | 100% | 95% | 90% | 85% | 79% | 74% | 69% | 64% | 58% | 53% |
| Number of | | | | | | | | | | |
| players | | | | | | | | | | |
| in the fantasy | | | | | | | | | | |
| match | 11X | 12X | 13X | 14X | 15X | 16X | 17X | 18X | 19X | 20X |
| 4 | NA | NA | NA | NA | NA | NA | NA | NA | NA | NA |
| 5 | NA | NA | NA | NA | NA | NA | NA | NA | NA | NA |
| 6 | NA | NA | NA | NA | NA | NA | NA | NA | NA | NA |
| 7 | NA | NA | NA | NA | NA | NA | NA | NA | NA | NA |
| 8 | NA | NA | NA | NA | NA | NA | NA | NA | NA | NA |
| 9 | NA | NA | NA | NA | NA | NA | NA | NA | NA | NA |
| 10 | NA | NA | NA | NA | NA | NA | NA | NA | NA | NA |
| 11 | 0% | NA | NA | NA | NA | NA | NA | NA | NA | NA |
| 12 | 10% | 0% | NA | NA | NA | NA | NA | NA | NA | NA |
| 13 | 17% | 9% | 0% | NA | NA | NA | NA | NA | NA | NA |
| 14 | 23% | 15% | 8% | 0% | NA | NA | NA | NA | NA | NA |
| 15 | 29% | 22% | 15% | 8% | 0% | NA | NA | NA | NA | NA |
| 16 | 33% | 26% | 20% | 13% | 6% | 0% | NA | NA | NA | NA |
| 17 | 38% | 32% | 25% | 19% | 13% | 7% | 0% | NA | NA | NA |
| 18 | 41% | 35% | 29% | 23% | 17% | 11% | 6% | 0% | NA | NA |
| 19 | 45% | 39% | 34% | 28% | 23% | 17% | 12% | 6% | 0% | NA |
| 20 | 48% | 43% | 37% | 32% | 27% | 22% | 16% | 11% | 6% | 0% |

*Note: 1X is read as “one time” which means a given athlete was selected by exactly one of the 20 fantasy players. Percentages selected are arbitrary.

TABLE 4
Adjusted Fantasy Points
Based on How Many Fantasy Players Selected a Given Athlete
Example from NFL Football

| | | | Percentage | |
|---|---|---|---|---|
| | Actual | Number of | of Fantasy | |
| | Fantasy | Times | Points Kept - | |
| | Points an | Selected by | Based on | *Adjusted |
| | Athlete | a Fantasy | Duplication of | Fantasy |
| Athlete | Scored | Player | Athletes | Points |
| Vick, Phila | 31 | 2 | 91% | 28.21 |
| Brady, NE | 25 | 6 | 55% | 13.75 |
| P. Manning, Ind | 40 | 3 | 82% | 32.80 |
| Brees, NO | 28 | 1 | 100% | 28.00 |
| Gore, SF | 16 | 2 | 91% | 14.56 |
| Peterson, Min | 33 | 11 | 10% | 3.30 |
| Mendenhall, Pit | 15 | 1 | 100% | 15.00 |
| C. Johnson, Ten | 29 | 4 | 73% | 21.17 |
| Foster, Hou | 21 | 1 | 100% | 21.00 |
| Jones-Drew, Jax | 9 | 1 | 100% | 9.00 |
| Bradshaw, NYG | 13 | 1 | 100% | 13.00 |
| Turner, Atl | 31 | 1 | 100% | 31.00 |
| Rice, Balt | 17 | 1 | 100% | 17.00 |
| S. Jackson, STL | 24 | 1 | 100% | 24.00 |
| Welker, NE | 21 | 2 | 91% | 19.11 |
| C. Johnson, Det | 18 | 6 | 55% | 9.90 |
| A. Johnson, Hou | 27 | 5 | 64% | 17.28 |
| Bowe, KC | 11 | 1 | 100% | 11.00 |
| Austin, Dal | 15 | 1 | 100% | 15.00 |
| White, Atl | 13 | 1 | 100% | 13.00 |
| Wallace, Pitt | 25 | 1 | 100% | 25.00 |
| Jennings, GB | 17 | 1 | 100% | 17.00 |
| Marshall, Mia | 16 | 1 | 100% | 16.00 |
| Fitzgerald, Az | 22 | 3 | 82% | 18.04 |
| Wayne, Ind | 10 | 1 | 100% | 10.00 |
| D. Jackson, Phila | 12 | 1 | 100% | 12.00 |

TABLE 5
Final Scores for Hypothetical 12
Fantasy Player Football Group
(Top 2 Fantasy Players Advancing)

| | NFL Player #1 | NFL Player #2 | NFL Player #3 | |
|---|---|---|---|---|
| | TRIPLE PTS | DOUBLE PTS | FACE VALUE | Totals |
| Fantasy | Rodgers QB | Roethlisberger QB | Nelson WR | 78.46* |
| Player 1 | Green Bay | Pittsburgh | Green Bay | 2^{nd} Place |
| | 3.90 × 3 = 11.70** | 23.78 × 2 = 47.56 | 19.20 | |
| Fantasy | Rodgers QB | Green Bay | Mendenhall | 61.54 |
| Player 2 | Green Bay | Defense | Pitt | 8^{th} Place |
| | 3.90 × 3 = 11.70 | 20.00 × 2 = 40.00 | 9.84 | |
| Fantasy | Randle E1 WR | Rodgers QB | Driver WR | 36.80 |
| Player 3 | Pittsburgh | Green Bay | Green Bay | 12^{th} Place |
| | 9.00 × 3 = 27.00 | 3.90 × 2 = 7.80 | 2.00 | |
| Fantasy | Wallace WR | Rodgers QB | Pittsburgh | 65.13 |
| Player 4 | Pittsburgh | Green Bay | Defense | 6^{th} Place |
| | 15.47 × 3 = 46.41 | 3.90 × 2 = 7.80 | 10.92 | |
| Fantasy | Crosby K | Pittsburgh | Rodgers QB | 46.74 |
| Player 5 | GB | Defense | Green Bay | 11^{th} Place |
| | 7.00 × 3 = 21.00 | 10.92 × 2 = 21.84 | 3.90 | |
| Fantasy | Roethlisberger QB | Jennings WR | Rodgers QB | 109.68 |
| Player 6 | Pittsburgh | Green Bay | Green Bay | 1^{st} Place |
| | 23.78 × 3 = 71.34 | 17.22 × 2 = 34.44 | 3.90 | |
| Fantasy | Ward WR | Mendenhall RB | Rodgers QB | 62.58 |
| Player 7 | Pittsburgh | Pittsburgh | Green Bay | 7^{th} Place |
| | 13.00 × 3 = 39.00 | 9.84 × 2 = 19.68 | 3.90 | |
| Fantasy | Jones WR | Wallace WR | Starks RB | 50.94 |
| Player 8 | Green Bay | Pittsburgh | Green Bay | 10^{th} Place |
| | 5.00 × 3 = 15.00 | 15.47 × 2 = 30.94 | 5.00 | |
| Fantasy | Rodgers QB | Roethlisberger QB | Nelson WR | 78.46* |
| Player 9 | Green Bay | Pittsburgh | Green Bay | 3^{rd} Place |
| | 3.90 × 3 = 11.70 | 23.78 × 2 = 47.56 | 19.20 | |
| Fantasy | Rodgers QB | Nelson WR | Jennings WR | 67.32 |
| Player 10 | Green Bay | Green Bay | Green Bay | 4^{th} place |
| | 3.90 × 3 = 11.70 | 19.20 × 2 = 38.40 | 17.22 | |
| Fantasy | Rodgers QB | Jennings WR | Nelson WR | 65.34 |
| Player 11 | Green Bay | Green Bay | Green Bay | 5^{th} Place |
| | 3.90 × 3 = 11.70 | 17.22 × 2 = 34.44 | 19.20 | |
| Fantasy | Rodgers QB | Nelson WR | Mendenhall RB | 59.94 |
| Player 12 | Green Bay | Green Bay | Pittsburgh | 9^{th} Place |
| | 3.90 × 3 = 11.70 | 19.20 × 2 = 38.40 | 9.84 | |

*Advances to next round or qualifies for Main Event.
**In the example above, athlete Rodgers adjusted fantasy score is 3.90. This score is tripled because he is slotted first.

I claim:

1. A method comprising:
prompting, by execution of a data processor, a large number of users at a corresponding large number of user platforms to each submit a nominal buy-in for entry into a fantasy sports tournament, the users submitting the nominal buy-in becoming fantasy players of the fantasy sports tournament;
partitioning, by execution of the data processor, the fantasy players of the fantasy sports tournament into player groups denoted rings, wherein players compete to advance through a pre-determined number of rounds to a main tournament, at least one player ring having at least three fantasy players as ring members, the fantasy players in each player ring only playing against other members of the same player ring during a given round;
receiving from each member of each player ring a selection of athletes corresponding to each member and scoring each member of each player ring based on the performance of selected athletes, members of each player ring who do not score within a predetermined number of advancing players for their given ring relative to the other members of the same player ring are disqualified from the fantasy sports tournament;
enabling a disqualified fantasy player to re-enter the fantasy sports tournament after submittal of an additional fee by either: a) paying the same fee again which requires playing one or more additional rounds to catch up to the number of rounds other players have played, or b) paying an additional fee to bypass rounds that have already been played;
enabling an advancing player to move on to the next round of the tournament, without having to pay an additional charge, as the advancing player is placed in a new ring of players who also have successfully advanced to the same stage of the tournament; and
configuring the fantasy sports tournament to include rings.

2. The method as claimed in claim 1 wherein the nominal buy-in (in terms of U.S. dollars) for entry into the fantasy sports tournament is less than two orders of magnitude per fantasy player or per entry.

3. The method as claimed in claim 1 wherein a player can win a high value grand prize (in terms of U.S. dollars) valued at the monetary value of the nominal buy-in plus an amount greater than or equal to five orders of magnitude more than the order of magnitude of the highest possible nominal buy-in.

4. The method as claimed in claim 1 further including prompting the members of each player ring to submit one or more lineups that identify athletes selected by the members of each player ring.

5. The method as claimed in claim 4 including applying a multiplier to adjust a member's score based on a positioning of an athlete on the member's lineup.

6. The method as claimed in claim 4 further including prompting the members of each player ring to submit one or more contingency lineups that identify athletes selected by the members of each player ring, the one or more contingency lineups being used if the corresponding member has advanced to a round where the contingency lineup becomes relevant.

7. The method as claimed in claim 1 including penalizing a member of a player group if the member selects the same athlete selected by another member of the same player group.

8. The method as claimed in claim 1 including disqualifying an athlete if a plurality of members of the same player group select the same athlete.

9. The method as claimed in claim 1 including receiving a bid from each member of a player ring in combination with receiving a selection of a particular athlete, the bid corresponding to a percentage reduction in score the member is willing to accept to obtain the particular athlete.

10. The method as claimed in claim 1 wherein enabling a disqualified fantasy player to re-enter the fantasy sports tournament includes receiving an additional fee from the fantasy player and not requiring the fantasy player to play additional rounds, or not receiving an additional fee from the fantasy player and requiring the fantasy player to play additional rounds.

11. The method as claimed in claim 1 including condensing a time period in which the plurality of rounds are played to shorten a total length of time needed to play all of the plurality of rounds.

12. The method as claimed in claim 1 wherein fantasy players compete against a single opponent in the main tournament.

13. A system comprising:
a data processor;
a network interface, in data communication with the data processor, for communication on a data network; and
a fantasy sports tournament system, executable by the data processor, to:
prompt a large number of users at a corresponding large number of user platforms to each submit a nominal buy-in for entry into a fantasy sports tournament, the users submitting the nominal buy-in becoming fantasy players of the fantasy sports tournament;
partition the fantasy players of the fantasy sports tournament into player groups denoted rings, wherein players compete to advance through a pre-determined number of rounds to a main tournament, at least one player ring having at least three fantasy players as ring members, the fantasy players in each player ring only playing against other members of the same player ring during a given round;
receive from each member of each player ring a selection of athletes corresponding to each member and scoring each member of each player ring based on the performance of selected athletes, members of each player ring who do not score within a predetermined number of advancing players for their given ring relative to the other members of the same player ring are disqualified from the fantasy sports tournament;
enable a disqualified fantasy player to re-enter the fantasy sports tournament after submittal of an additional fee by either: a) paying the same fee again which requires playing one or more additional rounds to catch up to the number of rounds other players have played, or b) paying an additional fee to bypass rounds that have already been played; and
configure the fantasy sports tournament to include rings.

14. The system as claimed in claim 13 wherein the nominal buy-in (in terms of U.S. dollars), for entry into the fantasy sports tournament is less than two orders of magnitude per fantasy player or per entry.

15. The system as claimed in claim 13 wherein a player can win a high value grand prize (in terms of U.S. dollars) valued at the monetary value of the nominal buy-in plus an amount greater than or equal to five orders of magnitude more than the order of magnitude of the highest possible nominal buy-in.

16. The system as claimed in claim 13 being further configured to prompt the members of each player group to submit one or more lineups that identify athletes selected by the members of each player ring.

17. The system as claimed in claim 16 being further configured to apply a multiplier to adjust a member's score based on a positioning of an athlete on the member's lineup.

18. The system as claimed in claim 13 being further configured to penalize a member of a player group if the member selects the same athlete selected by another member of the same player group.

19. A non-transitory machine-useable storage medium embodying instructions which, when executed by a machine, cause the machine to:
prompt a large number of users at a corresponding large number of user platforms to each submit a nominal buy-in for entry into a fantasy sports tournament, the users submitting the nominal buy-in becoming fantasy players of the fantasy sports tournament;
partition the fantasy players of the fantasy sports tournament into player groups denoted rings, wherein players compete to advance through a pre-determined number of rounds to a main tournament, at least one player ring having at least three fantasy players as ring members, the fantasy players in each player ring only playing against other members of the same player ring during a given round;
receive from each member of each player ring a selection of athletes corresponding to each member and scoring each member of each player ring based on the performance of selected athletes, members of each player ring who do not score within a predetermined number of advancing players for their given ring relative to the other members of the same player ring are disqualified from the fantasy sports tournament;
enable a disqualified fantasy player to re-enter the fantasy sports tournament after submittal of an additional fee by either: a) paying the same fee again which requires playing one or more additional rounds to catch up to the number of rounds other players have played, or b) paying an additional fee to bypass rounds that have already been played; and
configure the fantasy sports tournament to include rings.

20. The non-transitory machine-useable storage medium as claimed in claim 19 wherein the fantasy sports tournament is a player skill based tournament, wherein the skill based tournament requires that no more than ten people can compete for one advancing position at any given time.
